(19) United States
(12) Patent Application Publication
(10) Pub. No.: US 2014/0248950 A1
(43) Pub. Date: Sep. 4, 2014

(54) System and method of interaction for mobile devices

(71) Applicant: Martin Tosas Bautista, Manchester (GB)

(72) Inventor: Martin Tosas Bautista, Manchester (GB)

(21) Appl. No.: 14/191,549

(22) Filed: Feb. 27, 2014

(30) Foreign Application Priority Data
Mar. 1, 2013 (GB) 1303707.2
Apr. 8, 2013 (GB) 1306305.2
May 13, 2013 (GB) 1308477.7
Oct. 7, 2013 (GB) 1317723.3
Dec. 5, 2013 (GB) 1321534.8
Dec. 11, 2013 (GB) 1321900.1
Feb. 27, 2014 (GB) 1403428.4

(51) Int. Cl. G06F 3/01; A63F 13/40; G06T 19/00

(52) U.S. Cl. CPC G06F 3/01; G06T 19/006; A63F 13/10
USPC 463/31; 345/156

(57) ABSTRACT

A system and method of interaction with one or more applications running on a mobile device. The system maps the visual output of one or more applications running on the mobile device onto one or more virtual surfaces located within a user defined coordinate system, the mobile device being within this coordinate system, the coordinate system being attach to an arbitrary scene. The system estimates the pose of the mobile device within the coordinate system and according to this pose displays an interactive view of the virtual surfaces. The displayed view enables interaction with the one or more applications running on the mobile device.

### FIELD OF THE INVENTION

This invention relates to systems and methods of human computer interaction with mobile devices by using computer vision, sensor fusion and mixed reality.

### BACKGROUND

Touchscreens on mobile devices have become very popular in recent years. They allow users to easily interact with the information presented on them by just touching the displayed information as it appears on the screen. This allows users to operate touchscreen enabled mobile devices with minimal training and instruction.

As more and more information is presented on the touchscreens, the limited size of the screens becomes a problem, limiting their efficiency and user experience. Navigation gestures allow the user of a touchscreen enabled mobile device to operate a logical screen size that is larger than the actual screen size of the device. These navigation gestures include: single finger gestures, such as sliding and flicking; and two finger gestures, such as pinching and rotating. The latter gestures usually require the involvement of both the users hands, one to hold the mobile device and another to perform the gesture.

Even with the use of navigation gestures, it is difficult to operate large logical screen sizes on the limited screen sizes of mobile devices. One common example of this is the use of mobile devices to browse webpages that are not formatted for mobile screens. Statistics show that 90% of the world wide web is not formatted for mobile users. Users can navigate these webpages by zooming in, zooming out and panning, with the corresponding pinching (requiring the use of two fingers) and sliding (requiring the use of one finger) navigation gestures. However, there is a constant trade off between having an overview of the page and seeing the details on the page that forces the user to constantly employ said navigation gestures. This results in regularly clicking the wrong link or button, either because the zoom level is not suitable or a navigation gesture accidentally triggers a click. This behaviour has been observed in mobile advertising where statistics show that about half of the clicks on adverts are accidental. Larger screens provide some improvement but they are less portable.

Another recent technology known as Augmented Reality (AR) has the potential to change this situation. AR enables users to see information overlaid on their fields of view, potentially solving the problem of limited screen sizes on mobile devices. However, this technology is not mature yet. AR Head Mounted Displays or AR goggles are expensive; display resolutions are limited; and interaction with the AR contents may still require a mobile device touchscreen, special gloves, depth sensors such as kinect, or other purpose made hardware. Considerable effort, both from industry and academia, have been directed into pursuing a “direct interaction” interface with the AR contents. These, also known as “natural interfaces”, may involve tracking of the users hands and body allowing them to directly “touch” the information or objects overlaid on their fields of view. Still, this hand tracking is often coarse, having a spacial resolution about the size of the hand, which is not enough to interact efficiently with dense detailed displays of information, such as large webpages full of links.

### SUMMARY

The invention is directed to systems and methods of interaction with one or more applications running on a mobile device. The systems and methods of interaction are especially useful when the visual output of the applications involve large and dense displays of information. According to various embodiments, the interaction system maps the visual output of the applications running on the mobile device onto one or more larger floating virtual surfaces located within a user defined world coordinate system, the mobile device being within this coordinate system. The interaction system estimates the pose of the mobile device within the defined world coordinate system and according to this pose renders onto the mobile device's display a perspective view of the visual output mapped on the virtual surfaces. The interaction system enables its user to: (a) visualise on the mobile device's display the visual output of the applications mapped on the virtual surfaces by aiming and moving the mobile device towards the desired area of a virtual surface; (b) operate the applications by using standard actions, such as clicking or dragging, on the elements of the rendered perspective view of the virtual surface, as shown on the mobile device's display.

Advantageously, the invention is directed to systems and methods for dynamically creating and playing platform based AR games on arbitrary scenes. Embodiments of the system estimate the pose of a mobile device within a user defined world coordinate system by tracking the video input of the mobile device's forward facing camera and simultaneously creating a map of the captured scene, that will later be used as a playground for an AR platform game. The estimation of the pose of the mobile device allows embodiments of the system to render on the mobile device's display, game objects, including platforms, that are aligned with real features on the scene being captured by the mobile device's forward facing camera. Embodiments of the system can dynamically identify potential platforms in an arbitrary scene and select them according to one or more game rules. Some embodiments of the system allow: mapping of an arbitrary scene; then identification and selection of platforms on that scene according to one or more game rules; finally, it is possible to begin an AR game on that scene. Alternatively, other embodiments of the system allow a continuous mode of operation where platforms are dynamically identified and selected simultaneously with scene mapping and game playing. Platforms in this continuous mode are dynamically identified and selected both according to one or more game rules and a consistency constraint with previously identified platforms on the same scene. In other embodiments of the system, the mapped scene, together with selected platforms, can be stored and shared online for other users to play, on that scene, in a Virtual Reality (VR) mode. These embodiments of the system can estimate the pose of the mobile device within a local scene while displaying a different scene that has been shared online. These embodiments can allow multiple remote players to simultaneously play on the same scene in VR mode, enabling cooperative or adversarial game dynamics.

Further features and advantages of the disclosed invention, as well as the structure and operation of various embodiments, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate embodiments of the present invention and, together with the description, further serve to explain the principles involved and to enable a person skilled in the relevant art(s) to make and use the disclosed invention.

FIG. 1 depicts a mobile device with a display showing a webpage that is very crowded with contents and it is difficult to read.

FIG. 2A depicts a typical usage of the an embodiment of the system showing the relative positions of a representation of the virtual surface, mobile device and user.

FIG. 2B depicts typical relative positions of a representation of the virtual surface and mobile device showing a user defined world coordinate system and the pose of the mobile device within that coordinate system.

FIG. 2C depicts typical relative positions of an expanding plane defining a world coordinate system and the pose of a mobile device within that coordinate system.

FIG. 3A depicts what the user of an embodiment of the system can see on the mobile device's display as he moves the mobile device towards the left or right with respect to the shown representation of the virtual surface.

FIG. 3B depicts what the user of an embodiment of the system can see on the mobile device's display as he moves the mobile device towards the shown representation of the virtual surface or away from it.

FIG. 4A depicts the drag and drop procedure of an image, from within a bounded region on the virtual surface, to another region on the virtual surface outside the bounded region.

FIG. 4B depicts the personalisation of the areas of the virtual surface outside the bounded regions, including the placement various images, text and widgets.

FIG. 4C depicts a container region with multiple content items in it.

FIG. 4D depicts an example situation in which a user operating an embodiment of the system while comfortably sitting on a sofa can move the virtual surface, and container region on it, to a new location by using the hold and continue mode.

FIG. 4E depicts the steps involved in a piece-wise zoom in operation using the hold and continue mode.

FIG. 4F depicts the use of a region of attention on a virtual surface for extra image processing tasks.

FIG. 4G depicts the result of performing an image processing task on a region of attention on the virtual surface.

FIG. 4H depicts typical relative positions of a representation of the virtual surface, showing a user defined world coordinate system, a Head Mounted Display (HMD), and its pose within the world coordinate system.

FIG. 4I depicts a typical configuration of an embodiment of the system showing the relative positions of a representation of the virtual surface, and a user wearing a HMD while using a mobile device as input device.

FIG. 5 shows a block diagram of an exemplary mobile device architecture in which embodiments of the system can be implemented.

FIG. 6 is a block diagram for a preferred embodiment of the system, showing the interrelation between the various parts of the system, the operating system and running applications, the user interface, and the sensor hardware.

FIG. 7 shows a flowchart for the general operation of a preferred implementation of the pose tracker block.

FIG. 8 shows a flowchart for a preferred implementation of the pose tracker initialisation.

FIG. 9 shows a flowchart for a preferred implementation of a confidence measure for an estimate of the pose of the mobile device.

FIG. 10 shows a flowchart for a preferred implementation of the pose estimation subsystem.

FIG. 11 shows a flowchart for a preferred implementation of the computation of a vision based estimate of the pose of the mobile device following a local search strategy.

FIG. 12 shows a flowchart for a preferred implementation of the computation of a final estimate of the pose of the mobile device following a global search strategy.

FIG. 13 shows a flowchart for a preferred implementation of the update of the Photomap data structure.

FIG. 13B shows a flowchart for an alternative implementation of the update of the Photomap data structure.

FIG. 13C shows a flowchart for an alternative implementation of the computation of a final estimate of the pose of the mobile device following a global search strategy.

FIG. 13D shows a flowchart of an implementation of the saving of the virtual surface.

FIG. 13E shows a flowchart of an implementation of the search mode.

FIG. 13F shows a flowchart of an implementation of the search for saved virtual surfaces on the current video frame.

FIG. 14 shows a flowchart for a preferred implementation of the rendering engine block.

FIG. 14B shows a block diagram of an architecture where embodiments of the system can share content items inside a container region.

FIG. 15A shows a flowchart depicting a method for estimating the pose of a mobile device within a user defined world coordinate system.

FIG. 15B shows a flowchart depicting a method for displaying and operating the visual output of one or more applications running in a mobile device.

FIG. 15C shows a flowchart depicting a method for a user visualising and operating one or more applications running in a mobile device.

FIG. 15D shows a flowchart depicting a method for redefining the location of a virtual surface by using the hold and continue mode.

FIG. 15E shows a flowchart depicting a method for saving the location, orientation and contents of the virtual surface.

FIG. 15F shows a flowchart depicting a method for using the search mode.

FIG. 15G shows a flowchart depicting a method for two users operating a shared container region.

FIG. 16A shows a flowchart depicting a method for estimating the pose of a mobile device within a user defined world coordinate system and translating this pose into navigation control signals for an application running on a mobile device.

FIG. 16B shows a flowchart depicting a method for a user using the pose of the mobile device within a user defined world coordinate system to control the navigation controls of an application running on the mobile device.

FIG. 17 shows a block diagram for a family of less preferred embodiments of the system.

FIG. 18 depicts a typical usage of an embodiment of the system showing the relative positions of a user playing an AR game, while holding and aiming a mobile device implementing an embodiment of the system. Also depicted here the scene (bookshelf) where the game is being played, and a magnification of the mobile device's display showing an augmented view of the scene including various platforms and a game character walking on such platforms.

FIG. 19 is a block diagram for a preferred embodiment of the system, showing the interrelation between the various parts of the system, the user interface, and the sensor hardware.

FIG. 20A depicts how a horizontal scene for playing an AR game can be mapped using a horizontal translating motion of a mobile device implementing an embodiment of the system.

FIG. 20B depicts how a horizontal scene for playing an AR game can be mapped using a horizontal rotating motion of a mobile device implementing an embodiment of the system.

FIG. 20C depicts how a vertical scene for playing an AR game can be mapped using a vertical translating motion of a mobile device implementing an embodiment of the system.

FIG. 20D depicts how a vertical scene for playing an AR game can be mapped using a vertical rotating motion of a mobile device implementing an embodiment of the system.

FIG. 21 shows a flowchart for the general operation of a preferred implementation of the Game Pose Tracker block.

FIG. 22A depicts a map of a scene where an AR platform game can be played.

FIG. 22B depicts a map of a scene where an AR platform game can be played showing all the candidate platforms identified on that map.

FIG. 22C depicts a map of a scene where an AR platform game can be played showing the platforms identified on that map filtered by an example game rule based on selecting the largest platform within a distance window of 20 pixels.

FIG. 22D depicts a map of a scene where an AR platform game can be played showing the platforms identified on that map filtered by an example game rule based on selecting the largest platform within a distance window of 40 pixels.

FIG. 23 shows a flowchart for a preferred implementation of the platform identification and selection based on a mapped scene for the game.

FIG. 24 shows a flowchart for a preferred implementation of the continuous mode of platform identification and selection.

FIG. 25 shows a flowchart for a preferred implementation of the calculation of visible platforms for the current view.

FIG. 26 depicts an example usage of an embodiment of the system where one user is playing an AR game on a local scene, while another two remote users are playing in VR mode on the same scene as the AR user.

FIG. 27 is a block diagram for a preferred embodiment of the system operating in VR mode, showing the interrelation between the various parts of the system, the user interface, and the sensor hardware.

FIG. 28 shows a flowchart for a preferred implementation of the presentation of a downloaded scene including the calculation of visible platforms for the current view.

FIG. 29A shows a flowchart depicting a method for a user using an embodiment of the system to play an AR game.

FIG. 29B shows a flowchart depicting a method for a user using an embodiment of the system to play an AR game in continuous mode.

FIG. 29C shows a flowchart depicting a method for a user using an embodiment of the system to play a VR game.

FIG. 30A shows a flowchart depicting a method for a user using an embodiment of the system to map a local scene, share the scene in a server, and play an AR game, possibly interacting with VR players that joined the game.

FIG. 30B shows a flowchart depicting a method for a user using an embodiment of the system to connect to a server, join a game, and play a VR game, possibly interacting with other VR players that joined that game, or the AR player that shared the game.

FIG. 31 shows a block diagram of a multi-player architecture where embodiments of the system can share scenes and real-time game information.

The features and advantages of the disclosed invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DRAWINGS

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

### 1. Overview of the System

A mobile device can run applications whose visual output may excessively fill the mobile device's display. This may be due to accessing content that is not originally designed for mobile devices, for example, when browsing webpages that are not mobile ready. Other causes may include needing to display a large amount of information for a relatively small display size, or simply using applications that were originally designed for larger displays.

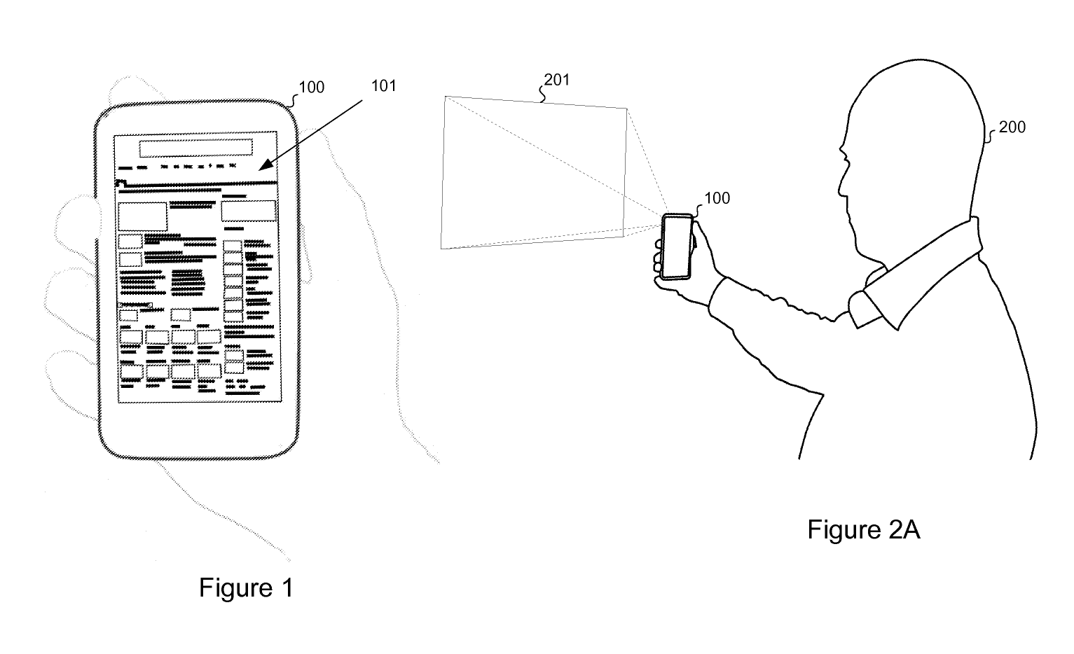

FIG. 1 depicts a mobile device 100 with a display 101 showing a webpage that is very crowded with contents and difficult to read. This will force the user of the mobile device to perform multiple navigation actions to be able to properly browse the contents displayed. These navigation actions can slow down the interaction with the webpage. Furthermore, some of these navigation actions will force the user of the mobile device to employ both hands. For example, if the mobile device has a touchscreen, the user can perform navigation gestures such as sliding (for scrolling), pinching (for zooming) and rotating in order to visualise the information more clearly. Pinching and rotating are examples of navigation gestures that require the use of two fingers in order to be performed. Two finger navigation gestures usually require the involvement of both hands, one to hold the mobile device and another to perform the gesture. This is a disadvantage of this navigation method as it requires the user to employ both hands.

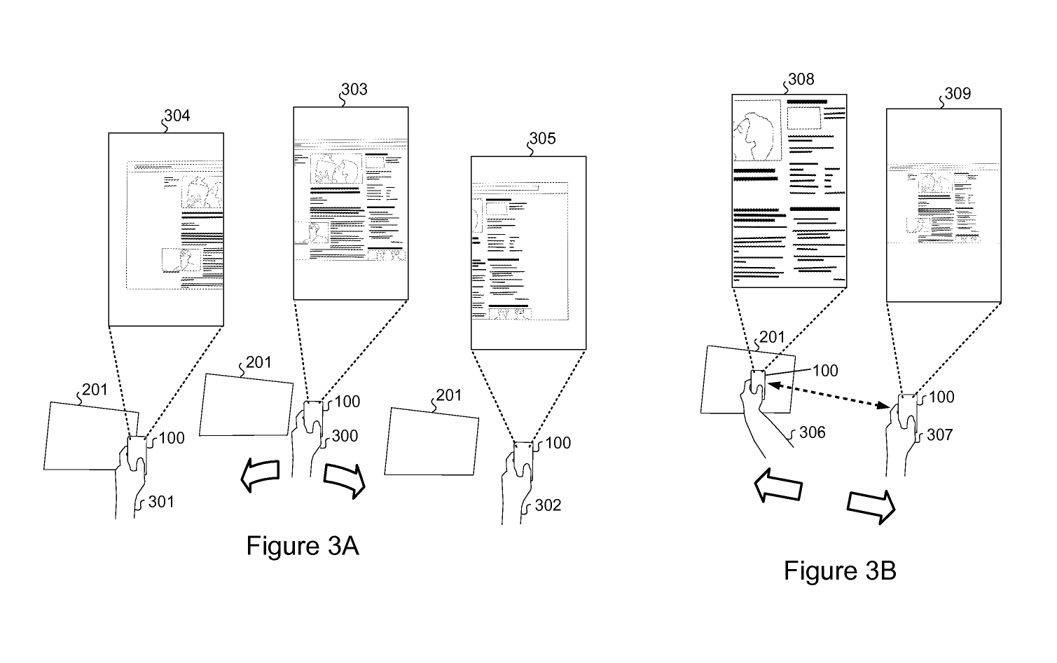

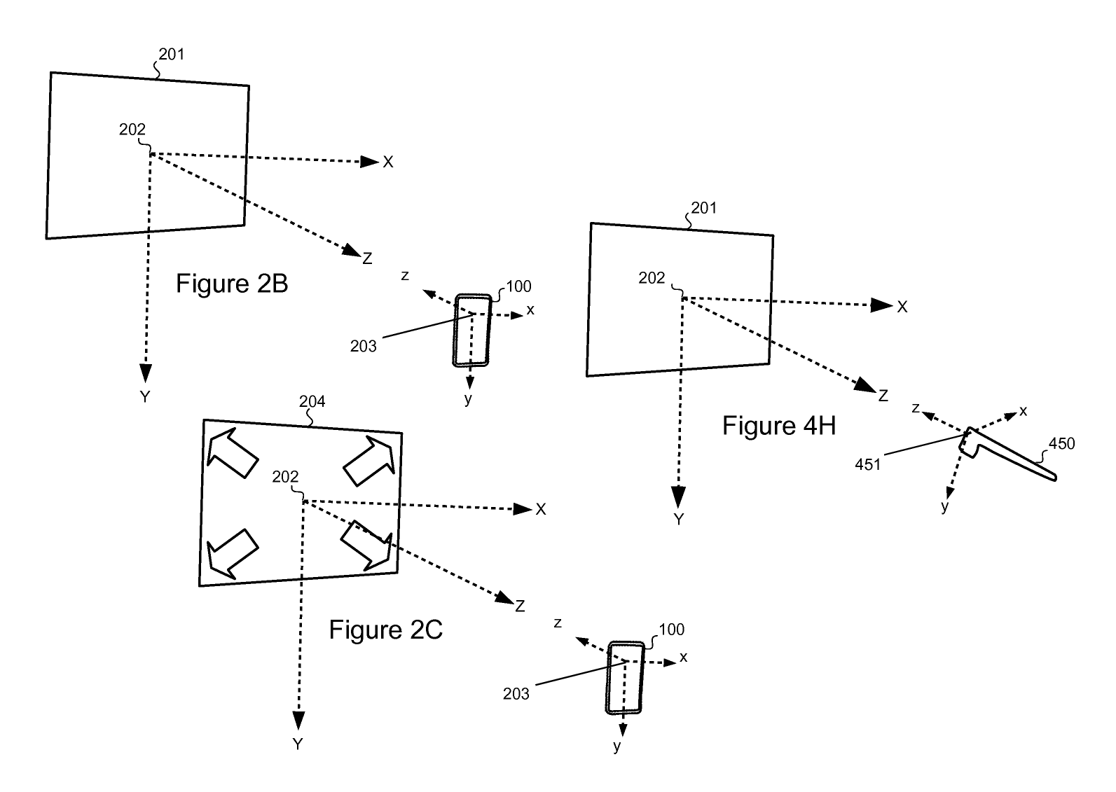

Embodiments of the system offer the user 200 of a mobile device 100 with an alternative mode of interaction with the applications running on the mobile device. Embodiments of the system can capture the visual output of the applications running on the mobile device and map it to a larger floating virtual surface 201. A virtual surface can be thought of as a sort of virtual projection screen to which visual contents can be mapped. FIG. 2A depicts a typical arrangement of an embodiment of the system, showing the relative positions of a representation of the virtual surface 201, mobile device 100 and user 200. The virtual surface and the mobile device are located within a world coordinate system 202, the virtual surface being generally at a fixed location, and the mobile device being able to freely move within the world coordinate system 202. The user can define the origin and direction of the world coordinate system during an initialisation stage that involves the user aiming the mobile device towards the desired direction, then indicating to the system to use this direction.

Embodiments of the system can estimate the pose 203 of the mobile device within the defined world coordinate system 202. The “pose” of the mobile device is the position and orientation, six degrees of freedom (DOF), of the mobile device in the defined world coordinate system. This estimate of the pose of the mobile device can be used to render on the mobile device's display 101 a perspective view of the virtual surface—as if the virtual surface was being seen through a window from the estimated pose in the world coordinate system. This perspective view allows the user 200 to see the contents mapped on the virtual surface as if he was looking at the virtual surface through the viewfinder of a digital camera. FIG. 2B shows the world coordinate system 202, where a representation of the virtual surface 201 and the mobile device 100 are located. The pose 203 of the mobile device is therefore defined within the world coordinate system.

The perspective view rendered on the mobile device's display 101 changes as the user moves the mobile device 100, therefore changing its pose 203, within the world coordinate system 202. This allows the user to visualise on the mobile device's display the information that has been mapped onto the virtual surface by aiming and moving the mobile device towards the desired area of the virtual surface. FIG. 3A shows an example of what the user of the system can see on the mobile device's display as he moves the mobile device towards the left or right with respect to the shown representation of the virtual surface. In this example, the user has aimed the mobile device towards the virtual surface 201 and holds the mobile device such that it is horizontally centred 300 with respect to the virtual surface. In this case the system will render on the mobile device's display a perspective view of the central part of the virtual surface 303. When the user moves the mobile device toward the left 301 he can see on the display a perspective view of the left part of the virtual surface 304, and when the user moves the mobile device toward the right 302 he can see on the display a perspective view of the right part of the virtual surface 305. Similarly, as illustrated in FIG. 3B, when the user moves the mobile device towards the virtual surface 306 he can see on the display a near view of the virtual surface 308, and when the user moves the mobile device away from the virtual surface 307 he can see on the display a far view of the virtual surface 309. This way of presenting the visual output of the applications running on the mobile device can be especially advantageous when these applications involve dense and large displays of information. Furthermore, using this method of presentation users can navigate the visual output of such applications quickly, intuitively, and using a single hand to hold the mobile device.

Users of an embodiment of the system can then operate an application running on the mobile device by interacting with the application's perspective view as rendered on the mobile device's display. For example, if the mobile device has a touchscreen display, the user can tap on a point on the display and an embodiment of the system will translate that tap into the corresponding tap input for the application that is being visualised on the display. The application will react as if the tap on the display had occurred on the application's visual output during the default mode of presentation, i.e. without using an embodiment of the system.

Notice that in some embodiments of the system, the perspective view of the virtual surface can be rendered on top of, or blended with, the live video captured by the mobile device's forward facing camera. In this case, the virtual surface can appear to the user as fixed and integrated in the scene, as shown in the live video. In this sense, this embodiment of the system can be thought of as being a traditional augmented reality (AR) system. However, other embodiments of the system can render only the perspective view of the virtual surface on the mobile device's display. In this sense, this embodiment of the system can be thought of as being a pure virtual reality (VR) system.

The user can initiate an embodiment of the system on the mobile device and then return back to the default mode of presentation without interfering with the normal flow of interaction of applications running on the mobile device. In this respect, embodiments of the system are transparent to the applications running on the mobile device.

In specific embodiments, the system can allow its user to configure the position, size, shape and number of the virtual surfaces for each individual application running on the mobile device. For example, a web browser can be mapped to a virtual surface that is longer vertically than horizontally; or an application that shows maps can be mapped to a squared or circular virtual surface.

In these cases, the virtual surface refers to a bounded region 400 of certain size and shape, to which the visual output of applications running on the mobile device is mapped. In some embodiments of the system, the virtual surface can be extended beyond these bounded regions 400, to include a larger plane, or a curved surface that can partially, or totally, surround the user of the system. For example, the virtual surface can be a large sphere with the user at its centre. In these embodiments of the system, a user can position the location of the individual bounded regions 400 anywhere on the curved virtual surface. Each bounded region 400 will be mapping the visual output of an application running on the mobile device.

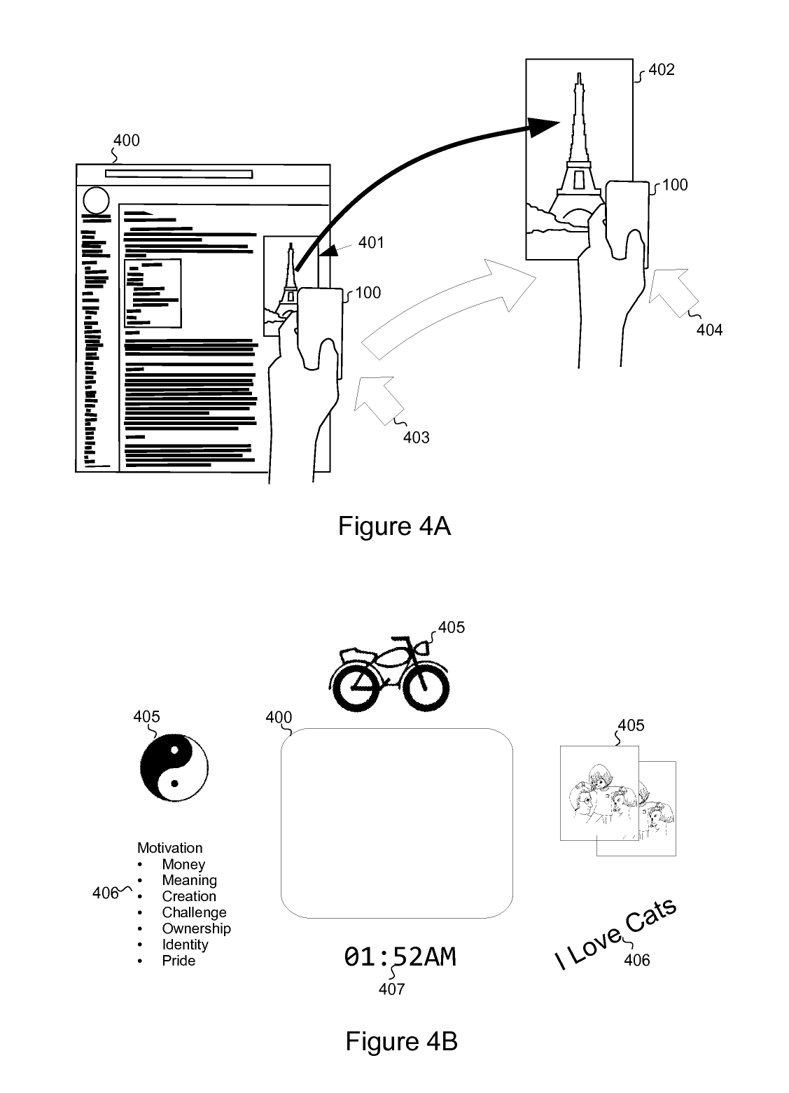

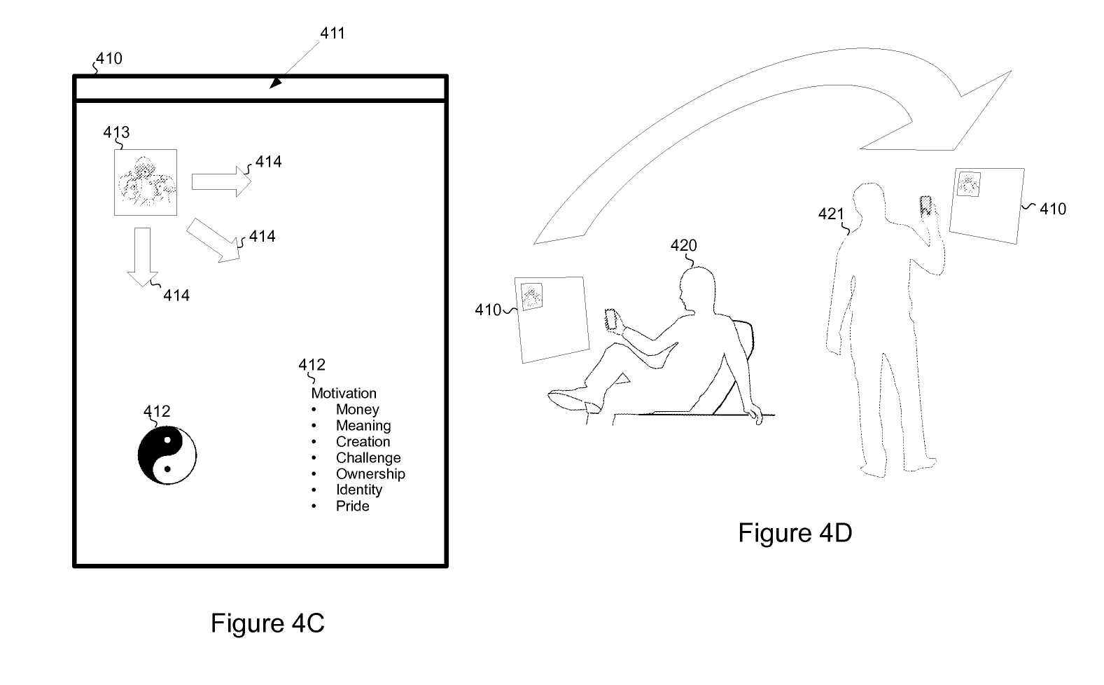

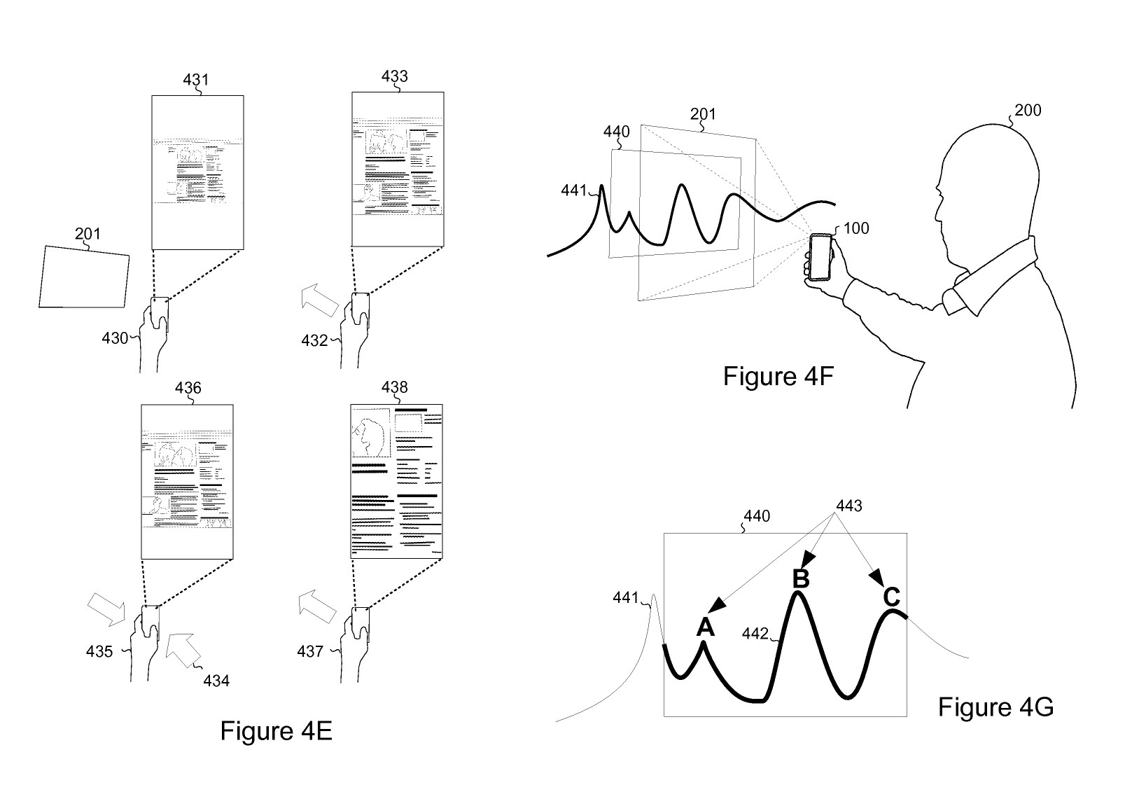

The areas on the virtual surface outside the bounded regions 400, can be utilised in various ways. In some embodiments of the system, the areas on the virtual surface outside the bounded regions 400, can be used to “drap and drop” images or text, from within the bounded region, to a location outside the bounded region. For example, FIG. 4A shows a virtual surface with a bounded region 400 corresponding to the visual output of a web browser application running on the mobile device. This bounded region 400 shows a webpage with an image 401 on it. The user of an embodiment of the system can aim the mobile device 100 towards the image 401 on that webpage in order to visualise the image on the mobile device's display. Then the user can tap and hold his thumb 403 on this image, as it is seen on the mobile device's display. While holding that tap, the user can move the mobile device (dragging) and aim it towards a new region on the virtual surface, outside the bounded region 400. Finally, the user can release the tap 404 on the mobile device's display (dropping), and this will result in releasing the image to a new location 402 outside the bounded region 400. This procedure can be repeated for other images, or for selected text, that can appear on the webpage, or on any other visual output, of applications running on the mobile device, mapped to that bounded region 400.

This capability of dragging and dropping content from the bounded regions 400 on the virtual surface to other regions on the virtual surface can effectively turn the virtual surface into a digital pin-board. This digital pin-board can be very useful. For example, when using an embodiment of the system to do web browsing, the user of the system can drag and drop various content, images or text, outside the web browser bounded region 400 and organise them along the virtual surface. In this situation, the images and text can store hyperlinks to the webpages that they were dragged from, and can act as bookmarks. The bookmarks can be activated by visualising them on the mobile device's display and taping on them as seen on the display.

Another way of utilising the areas on the virtual surface outside the bounded regions 400, is to let users of such embodiments of the system personalise these areas, FIG. 4B. Users can change the background colours of these areas; they can add and position (for example by drag and drop) various custom items 405 such as: photos of family, friends, hobbies, idols, music bands, cars, motorbikes, etc.; they can add and position text items 406 such as reminders, motivational quotes, cheat sheets, etc.; finally, they can add and position widgets 407 such as clocks, weather gauges, message notification displays, etc. These customised parts of the virtual surface can be stored as interchangeable overlays that can be activated in different situations. For example, when the visual output of a particular application running on the mobile device is mapped to a bounded region 400 of the virtual surface, the rest of the virtual surface can show an overlay with information relevant to that application, for instance, reminders or cheat sheets. Alternatively, the user of an embodiment of the system can manually activate different overlays. For example, when mapping a web browser to the bounded region 400 of the virtual surface, the user may activate an overlay that is clean, i.e. without any personalisation, so that he can use the overlay area as a pin-board, by dragging and dropping images and text from the bounded region 400 to the outside of the bounded region.

In other embodiments of the system, the bounded regions 400 on the virtual surface can be eliminated, and the entire virtual surface can be used as a surface to map contents to. In these embodiments, the mobile device can run an application whose visual output is specifically designed for the size and shape of the virtual surface, and this application does not need to have an alternative corresponding visual output following the traditional designs for mobile screens. In these embodiments of the system, individual content items can be placed anywhere on the virtual surface, and the users can move these content items to another location on the virtual surface by following the “drag and drop” procedure described in FIG. 4A, but in this case the drag and drop does not need to originate from any bounded region.

To make management and handling of the various content items mapped to the virtual surface easier, these embodiments of the system can place the content items in container regions 410 that can be handled as a single unit. These container regions 410 are different from the bounded regions 400, which map the visual output of applications running on the mobile device, in that they do not map the visual output of any specific application running on the mobile device, but they contain multiple content items mapped to the virtual surface and they allow the management of these as a single unit. The content items placed inside a container region 410 can originate from different applications running on the mobile device, and these can include bounded regions 400, which map the visual output of applications running on the mobile device. The content items inside the same container region can all be moved, copied, archived, deleted or generally managed as a single unit. The content items can be placed inside the container region in multiple ways, including a) dragging and dropping the content item from the outside of the container region; b) by using a separate GUI; or c) they can be placed in to the container region programatically. For example, the container region can be filled with photos as they are being taken, one by one, by the user of the embodiment. Or the container region can be automatically filled with photos already stored in the mobile device's memory. A practical application of this can be, for example, to enable a user of an embodiment of the system to place a container region in front of the fridge door, and each time he thinks about an item that needs replacement, he can take a photo of the old item. Then that photo will appear on the container region in front of the fridge door. In this way, the user of the embodiment of the system can maintain the equivalent of a shopping list on a container region in front of the fridge door.

FIG. 4C shows an example rectangular container region 410 with a number of content items 412, 413 that have been placed inside. The container region 410 shows an area at the top 411 that can be used to display a title for the container region. To simplify the management of the content items within a container region, these content items can be attached to the container region and only be allowed to be moved by the user within the two dimensional container region. For example, in FIG. 4C, the content item 413, can be restricted to move only along the directions indicated by the arrows 414.

In other embodiments, the system can be calibrated to the particular reach of the users arm in order to facilitate usage. For example, looking at FIG. 3B, a calibration step can ask the user to bring the mobile device towards the virtual surface as much as possible, or comfortable 306, then the desired zoom level can be adjusted separately with an on-screen graphic user interface (GUI). Then the calibration step can ask the user to move the mobile device away from the virtual surface as much as possible, or comfortable 307, then again, the desired zoom level can be adjusted separately with an on-screen GUI. These two points can be used to adjust the way the perspective view of the virtual surface is rendered on the mobile device's display so that the user can comfortably visualise the desired level of detail between the two extremes. Similarly, a calibration step can be performed to adjust the horizontal or vertical sensitivity of the system. For example, looking at FIG. 3A, a calibration step can ask the user to bring the mobile device 100 towards the left side 301 as much as comfortable, or possible, then adjust the desired position of the virtual surface using an on-screen GUI. Then the calibration step can ask the user to bring the mobile device 100 towards the right side 302 as much as comfortable, or possible, then adjust the desired position of the virtual surface using an on-screen GUI.

Notice that while on some embodiments of the system the virtual surface can appear to the user as fixed and integrated in the scene (in a traditional augmented reality sense), when the specific embodiment of the system allows performing a calibration step, the virtual surface will appear to the user as moving on the scene—although moving with predictable dynamics with respect to the scene.

An alternative to the calibration process described above is to use a mode of interaction with the virtual surface in which the virtual surface moves in reaction to the change in pose of the mobile device, matching the change in pose of the mobile device, in reverse, by a predetermined factor. There are six predetermined factors, one for each of the six parameters of the pose 203 of the mobile device. If all these six factors have a value of one, the result is that when the user moves the mobile device with respect to the virtual surface, he can see the virtual surface as integrated with the scene, at a fixed position (in a traditional augmented reality sense). This is the default interaction behaviour. If the factors relating to the translation components of the pose are doubled, i.e. set to a value of two, the virtual surface will move in the opposite direction to the mobile device's change in translation by an equal amount. For example, if the user moves the mobile device towards the virtual surface by one unit of distance within the world coordinate system 202, the virtual surface will also move toward the mobile device by one unit of distance. If the user moves the mobile device towards the left by one unit of distance within the world coordinate system 202, the virtual surface will move towards the right by one unit of distance within the world coordinate system 202. Equally, if the user moves the mobile device upwards by one unit of distance within the world coordinate system 202, the virtual surface will move downwards by one unit of distance within the world coordinate system 202. In consequence, for a given change in the translation components of the pose 203 of the mobile device, the part of the virtual surface rendered on the mobile device's display 101 will change twice as fast than with the default interaction behaviour. The net result of these factors being set to a value of two is that the user will need to move the mobile device half as much than with the default interaction behaviour, to visualise the entire virtual surface. The predetermined factors corresponding to the rotation components of the pose 203 of the mobile device can also be set to values different from one, resulting in different interaction behaviours with respect to the rotation of the mobile device. If the factors corresponding to the rotation components of the pose 203 of the mobile device are set to a value of two, the result of a rotation of the mobile device will be doubled. For example, if the user rotates the mobile device by one degree clockwise (roll) within the world coordinate system 202, the virtual surface will also rotate by one degree anti-clockwise (roll) within the world coordinate system 202. The same principle can be applied for pitch and yaw rotations of the mobile device.

The values of the predetermined factors described above can be grouped in interaction profiles that a user of an embodiment of the system can use depending on circumstances such as comfort or available space to operate the system. For example, the default interaction profile would set all the predetermined factors to one. This will result in the default interaction behaviour where the virtual surface appears integrated with the scene, at a fixed position (in a traditional augmented reality sense). Another example interaction profile can set all the factors corresponding to the translation components of the pose 203 of the mobile device to two, while leaving the factors corresponding to the rotation components of the pose 203 of the mobile device at one. This profile could be useful when operating an embodiment of the system in a reduced space as the user will need to move the mobile device half as much than with the default interaction profile to visualise any part of the virtual surface. Another example interaction profile can set the factor corresponding to the Z component of the pose 203 of the mobile device to 1.5 and set the rest of factors to one. In this profile, when the user moves the mobile device towards or away from the virtual surface, the rendered view of the virtual surface on the mobile device's display will approach or recede 1.5 times faster than in the default interaction profile, while the rest of translation and rotation motions will result in the same interaction response as with the default interaction profile. This interaction profile can be suitable for a user that wants to zoom in towards and zoom out from the virtual surface content with less motion of the mobile device.

In some embodiments of the system, a facility can be added to the system that allows the user of the system to quickly suspend the tracking of the pose of the mobile device, freeze the current pose of the virtual surface, and enable keypad navigation of the virtual surface pose. Then, when the user has finished with this mode of interaction, the user can quickly return the system to pose tracking navigation without losing the flow of interaction with the applications running on the mobile device. The trigger of this facility can be, for example, detecting that the mobile device has been left facing upwards on top of a surface, at which point the system can automatically switch to keypad navigation. When the user picks up the mobile device, then the system can automatically return to pose tracking navigation.

This suspension of the tracking of the pose of the mobile device, and freezing of the current pose of the virtual surface, can also have other uses. For example, a user of the mobile device can manually activate this feature and then walk to a different place. In the meantime, the user can continue the interaction with the virtual surface by using keypad navigation, instead of the pose tracking navigation. This keypad navigation would allow the user to interact with the virtual surface by using the mobile device's keypad. If the mobile device's keypad is a touch screen, the user will be able to use traditional navigation gestures to zoom in and zoom out (pinch gesture), roll (rotation gesture), pan (pan gesture) and click (tap gesture). Pitch and yaw rotation could be achieved by first setting a separate mode, and then using the pan gesture instead. When the user has finished walking to a new location, and has finished the keypad navigation of the virtual surface, he can unfreeze the pose tracking navigation. At this point the world coordinate system 202 can be redefined using the current pose of the mobile device. Then the pose tracking navigation can continue from the last frozen state of the virtual surface. This can be the last state of the virtual surface used while the user performed keypad navigation, or, if no keypad navigation occurred, the last state of the virtual surface just before the suspension of the tracking of the pose of the mobile device. FIG. 4D shows an example situation in which a user is operating an embodiment of the system while comfortably sitting on a sofa 420. Then he enables the suspension of the tracking of the pose of the mobile device and freezing of the current pose of the virtual surface. He stands up and walks to a different location 421. Finally, he restarts the tracking of the pose 203 of the mobile device, at which point a new world coordinate system 202 is defined, the pose of the virtual surface is unfrozen, and he can continue operating the embodiment of the system, on the new location 421, and from the last state of the virtual surface just before the suspension of the pose 203 of the mobile device.

The same principle can be used, for example, to show the contents of the virtual surface to another user. The first user visualises the desired part of the virtual surface, using pose tracking navigation. Then, he suspends the tracking of the pose 203 of the mobile device, and freezes the current pose of the virtual surface. Then he can pass the mobile device to a second user. Then the second user will aim the mobile device to a desired direction and unfreeze the pose of the virtual surface. At this point the world coordinate system 202 can be redefined using the new pose 203 of the mobile device, and the interaction with the virtual surface can continue using pose tracking navigation.

Other embodiments of the system can implement the tracking suspension and freezing of the current pose of the virtual surface by enabling a hold and continue mode. After enabling the hold and continue mode, each time the user touches the mobile device keypad (hold) the tracking of the pose 203 of the mobile device is suspended, and the pose of the virtual surface frozen. When the user releases the touch from the keypad (continue), the world coordinate system 202 is redefined using the new position and orientation of the mobile device, then tracking of the pose 203 of the mobile device is restarted within the new world coordinate system 202, and the user can continue operating the embodiment of the system from the last state of the virtual surface just before the user touched the mobile device keypad. This hold and continue mode can enable easy successive holds and continues, which can be used by a user of an embodiment of the system to perform a piece-wise zoom in, zoom out, translation or rotation of the virtual surface. For example, FIG. 4E illustrates the steps involved in a piece-wise zoom in when using the hold and continue mode. Initially, the user of an embodiment of the system aims the mobile device towards a virtual surface 201 from a certain distance 430. This enables the user to visualise the entire contents mapped to the virtual surface on the mobile device's display 431. Then, the user moves the mobile device towards the virtual surface 432. This results in a zoom in of the region of the virtual surface visualised on the mobile device's display 433. The user then performs a hold action 434, while moving the mobile device away from the virtual surface 435. As the user is performing a hold action, the region of the virtual surface visualised on the mobile device's display does not change 436. Finally, the user finishes the hold action (continue) and moves 437 the mobile device towards the virtual screen, this results in a further zoom in of the region of the virtual surface visualised on the mobile device's display 438.

In other embodiments of the system, the location, orientation and current contents mapped on a virtual surface can be saved for later use. These embodiments of the system can be placed in a search mode that continuously checks for nearby saved virtual surfaces. When a saved virtual surface is within the visualisation range of the mobile device, the perspective view of the contents mapped on the saved virtual surface will be displayed on the mobile device's display. These embodiments of the system generally use the video from a forward facing camera to perform the search. For example, looking at FIG. 4D, a user can initialise the system, defining a new world coordinate system 202, in a certain direction while sitting on a sofa 420. The user can then operate the embodiment of the system to create a container region 410, place some content items within the container region, name the container region as “sofa”, and save its location, orientation, and contents. The user can then leave the sofa. Next time the user sits on the sofa he can activate the search mode, aim the mobile device towards the direction where the container region was saved, and see that the container region is restored at the same place, and in the same state it was left when saved. From that point onwards, the user of the embodiment of the system can operate the restored virtual surface, change its contents, move the virtual surface to a different location (as for example in 421) and save it again under the same or other identifier.

If multiple saved virtual surfaces are within the visualisation range of the mobile device, embodiments of the system can select one of them as the active one while leaving the other ones as not active. In these situations the pose 203 of mobile device will be estimated within the world coordinate system 202 of the active virtual surface. The selection of the active virtual surface can be left to the user, for example, by means of a screen GUI; or it can be automatised, for example, by making a virtual surface active when it is the nearest or the most frontal to the mobile device. Some embodiments of the system can merge multiple saved virtual surfaces that are in close spatial proximity so that they share the same world coordinate system 202. This can allow the user of these embodiments to operate all the merged virtual surfaces without having to make the individual virtual surfaces active.

Some embodiments of the system can automatically save any changes to a selection of, or the entirety of, the current contents mapped on a virtual surface. Automatically saving the contents means that if a user alters the contents of the virtual surface in any way, the new contents and arrangement will be immediately saved. For example, a user of an embodiment of the system can: add a new content item to a container region on the virtual surface; delete an existing content item in a container region on the virtual surface; resize or alter the nature of the content item in the container region on the virtual surface; or move an existing content item to another location inside or outside a container region on the virtual surface. After having performed any of these actions, the contents mapped to the virtual surface will be automatically saved. This automatic saving of the contents can be used to synchronize or share multiple virtual surfaces so that they all have the same contents. For example, multiple users of this embodiment of the system can operate a shared virtual surface independently. Each time one of the users updates their virtual surface, the other users can see the update happening in their virtual surfaces. These embodiments of the system can also be used to broadcast information to a set of users that all have a shared virtual surface.

Embodiments of the system having a forward facing camera, that is the camera on the opposite side of the screen, can create a Photomap image of the surrounding scene while the user of the embodiment of the system interacts with a virtual surface. This Photomap image is similar to a panoramic image that can extend in multiple directions. Some embodiments of the system use this Photomap image for pose estimation only, but other embodiments of the system can use this Photomap image for a number of extra image processing tasks. For example, the Photomap image can be processed in its entirety to detect and recognize faces or other objects in it. The results of this detection can be shown to the user of the embodiment by displaying it on the current visualisation of the virtual surface. Depending on the particular implementation, the Photomap image can be distorted and may not be the best image on which to perform certain image processing tasks.

Embodiments of the system that can create a Photomap image of the surrounding scene, can define a region of attention on the virtual surface than can be used for extra image processing tasks. This region of attention can be completely within the currently visible part of the virtual surface 201; it can be partially outside the currently visible part of the virtual surface 201; or it can be completely outside the currently visible part of the virtual surface 201. The currently visible part of the virtual surface will generally be the same area as the area currently captured by the forward facing camera. The region of attention on the virtual surface will have a corresponding region of attention on the Photomap image. The region of attention on the virtual surface can be reconstructed at any time from the Photomap image. Because of this, the region of attention on the virtual surface does not need to be completely within the currently visible part of the virtual surface. However, the region of attention on the Photomap image has to be completely within the Photomap image in order to be a complete region for image processing tasks. Embodiments of the system implementing this type of region of attention on the virtual surface, can perform an image processing task on visual content captured by the forward facing camera even if this visual content is not currently visible from the forward facing camera. For most applications though, this visual content will have to remain constant until the image processing task is completed. If the visual content changes, the user of the embodiment will have to repeat the mapping of the region of attention on the virtual surface, in order to create a new Photomap image that can be used for an image processing task.

For example, FIG. 4F shows a user 200 of an embodiment of the system aiming the mobile device 100 towards a mountain range 441. A region of attention 440 is defined on the virtual surface, but part of the region of attention is outside the currently visible part of the virtual surface 201. FIG. 4G shows the part 442 of the mountain range 441 that is within the region of attention 440 on the virtual surface. This part 442 of the mountain range 441 can be processed to identify the names of the mountain peaks on it. The names of the mountain peaks can then be displayed as labels 443, on top of each of the mountain peaks as they appear on the virtual surface.

Normally, embodiments of the system will display the perspective projection of the virtual surface on the display 101 embedded on a mobile device 100. However, it is also contemplated that other embodiments of the system can use displays that are not connected to the mobile device, for example: a computer display can be used to display what would normally be displayed on the embedded display; a projector can be used to project on a wall what would normally be displayed on the embedded display; or a Head Mounted Display (HMD) can be used to display what would normally be displayed on the embedded display. In all these embodiments of the system, the part of the virtual surface that is visualised on the specific display can be controlled by the pose of a separate mobile device.

In embodiments of the system using a HMD as display, the part of the virtual surface displayed on the HMD can be controlled by the pose 451 of the HMD in the same way that the part of the virtual surface displayed on a mobile device's display is controlled by the pose 203 of the mobile device. This HMD needs to have at least one sensor. This sensor can be a forward facing camera, it can be motion sensors (such as accelerometers, compasses, or gyroscopes) or it can be both a forward facing camera and motion sensors. In these embodiments of the system the HMD 450 takes the place of the mobile device 100. Similarly to FIG. 2B, FIG. 4H shows the world coordinate system 202, where a representation of the virtual surface 201 and the HMD 450 are located. The pose 451 of the HMD is defined in the same way as the pose 203 of the mobile device in FIG. 2B. In these embodiments of the system when the user turns his head in any direction, the pose 451 of the HMD will change, and the HMD display will show the part of the virtual surface corresponding to the new pose 451 of the HMD.

In embodiments of the system using a HMD as display, a separate mobile device can be used for data input and extra control of the visualization of the virtual surface. The mobile device can have, for example, a GUI that allows the user of the embodiment to move a cursor on the virtual surface and select objects on there. Alternatively, the GUI can allow the user of an embodiment to have partial, or complete, control over the part of the virtual surface displayed on the HMD. For example, the GUI on the mobile device can allow zoom ins, and zoom outs of the part of the virtual surface currently displayed on the HMD.

In embodiments of the system using a HMD as display and a separate mobile device for data input, the pose 451 of the HMD and the pose 203 of the mobile device can be estimated within a common world coordinate system 202. In these embodiments of the system, the world coordinate system 202 can be defined during an initialisation stage by either the mobile device or the HMD. The initialisation stage will involve the user aiming either the mobile device, or the HMD, towards the desired direction, then indicating to the system to use this direction. After the world coordinate system 202 is defined in the initialisation stage, both the pose 203 of the mobile device and the pose 451 of the HMD can be estimated within the defined world coordinate system. Either the mobile device or the HMD can be used as display.

If the HMD is used as display, the perspective projection of the virtual surface can be shown on the HMD display according to the pose 451 of the HMD within the common world coordinate system 202. In this scenario, the pose 203 of the mobile device, estimated within the common world coordinate system 202, can be used as a form of data input. For example, the pose 203 of the mobile device, estimated within the common world coordinate system 202, can be used to control the level of zoom of the part of the virtual surface shown on the HMD, while the pose 451 of the HMD, estimated within the common world coordinate system 202, can be used to control the rotation of the part of the virtual surface shown on the HMD. In another example, the pose 203 of the mobile device, estimated within the common world coordinate system 202, can be used to control a three dimensional cursor (6 degrees of freedom) within the common world coordinate system 202. This three dimensional cursor can be used to manipulate objects within the common world coordinate system 202. For example, this three dimensional cursor can be used to: select content items on the virtual surface; drag and drop content items to different parts of the virtual surface; click on links or buttons shown on a bounded region (mapping the visual output of an application running on the mobile device) on the virtual surface.

FIG. 4I depicts a typical configuration of an embodiment of the system showing the relative positions of a user 200, HMD 450, mobile device 100, and a representation of the virtual surface 201. The pose 451 of the HMD, the pose 203 of the mobile device, and the representation of the virtual surface 201 can all be defined within a common world coordinate system 202.

If the mobile device is used as display, the perspective projection of the virtual surface will be shown on the mobile device's display according to the pose 203 of the mobile device within the common world coordinate system 202. In this scenario, the HMD can show extra information relating to the contents mapped on the virtual surface. For example, the HMD can show a high level map of all the contents on the virtual surface, indicating the region that is currently being observed on the mobile device's display.

An embodiment of the described system can be used to palliate the problem scenario described at the beginning of this section. Looking at FIG. 1, the user of the mobile device 100 with a display 101 showing a webpage that is very crowded with contents and difficult to read, can now activate an embodiment of the system and browse and interact with the same webpage contents, now mapped on a large virtual surface. The user will still need to navigate the contents, but this can be achieved by holding and moving the mobile device towards the desired area of the virtual surface. The user can perform this navigation with a single hand and in a continuous manner, for example, while tracking the text that he is reading. The user can also interact with the contents of the webpage while navigating them. For example, if the mobile device has a touchscreen, the user can tap his thumb on a link on the webpage, as shown by the current perspective view of the virtual surface, while the user is tracking and reading the text on the webpage (by tracking meaning to slowly move the mobile device following the text that is being read).

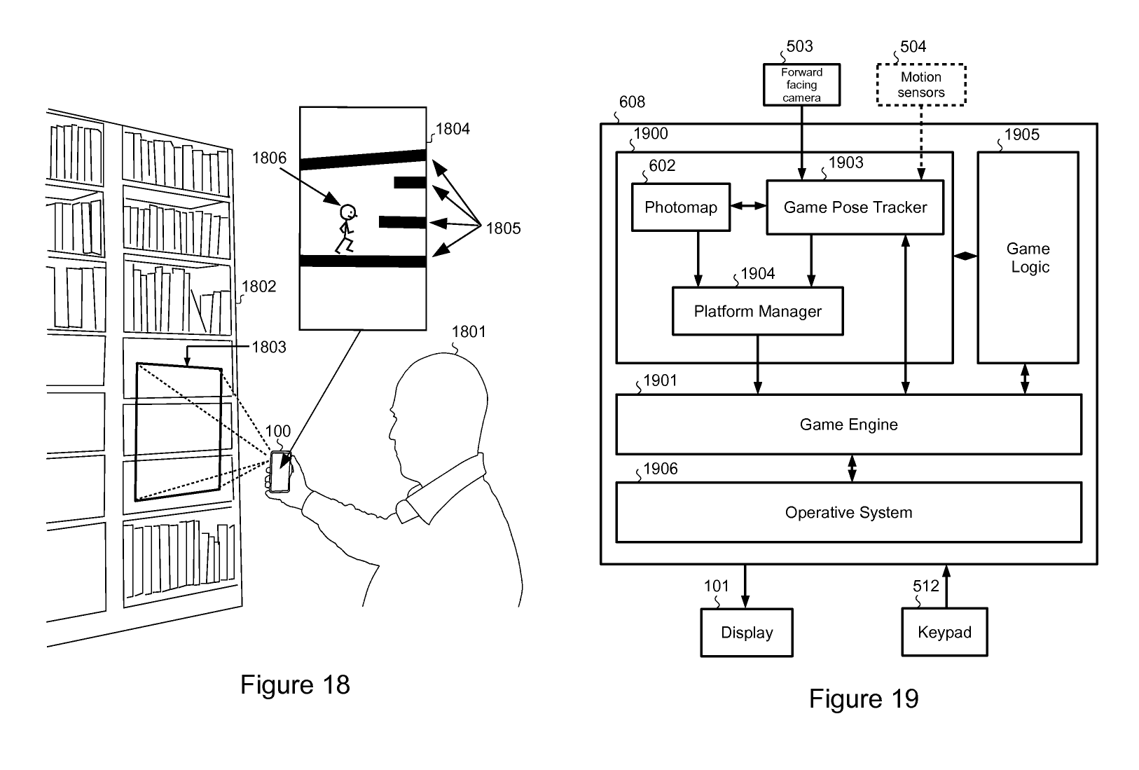

Other alternative embodiments of the system allow for dynamically creating and playing platform based Augmented Reality (AR) games on arbitrary scenes. Embodiments of the system estimate the pose of a mobile device within a user defined world coordinate system by tracking the video input of the mobile device's forward facing camera and simultaneously creating a map of the captured scene. This map is analysed to identify image features that can be interpreted as candidate platforms. The identified platforms are then selected according to one or more game rules. The resulting platforms together with the mapped scene will be used as a playground for an AR game. FIG. 18 depicts a typical usage of an embodiment of the system showing the relative positions of a user 1801 holding a mobile device 100 and using it to play an AR game on a bookshelf 1802 (an example scene). An embodiment of the system implemented in a mobile device 100 estimates the pose of the mobile device within a user defined world coordinate system by tracking the video input of the mobile device's forward facing camera and simultaneously creating a map of the captured scene. In some embodiments of the system, the user 1801 first maps the scene that is going to be used as playground for the AR game by sweeping the mobile device's forward facing camera over the whole scene, then when the mapping of the scene is complete, the system analyses the map of the scene to identify areas that can be used as platforms. A platform in this context corresponds to a horizontal surface or edge identified on the mapped scene that can be used by a game character to stand on. The identified platforms are then selected according to one or more game rules. At this point the AR game can begin. When the user of the system 1801 aims the mobile device's forward facing camera towards a region of the scene 1803 that has previously been mapped, the system shows on the mobile device's display an augmented view 1804 of the same region of the scene. The augmented view 1804 includes a number of selected platforms 1805 in that region and possibly game characters 1806 or game objects that happen to be in this region at that particular time.

Other embodiments of the system are capable of a continuous mode operation, which allows the system to dynamically identify and select platforms for the AR game at the same time the scene is being mapped and the game is being played. Platforms in this continuous mode are dynamically identified and selected both according to one or more game rules and a consistency constraint with previously identified platforms on the same scene. In these embodiments of the system, the user first defines a world coordinate system by aiming the mobile device's forward facing camera towards the scene to be used as playground for the AR game. Then, the current view of the scene is mapped, and platforms within that view are identified and selected. At this point the AR game will begin and the game's avatar will appear standing on one of the platforms within the current view. As the user moves the game's avatar within the current view of the scene, and the avatar gets nearer to the borders of the current view, the user aims the mobile device in the direction the avatar is heading, to centre the avatar on the current view. This action results in mapping a new region of the scene and identifying and selecting new platforms for that new region. Theoretically, the playground for the AR game can be extended indefinitely by following this procedure.

Some embodiments of the system map the scene to be used as a playground for the AR game onto an expanding plane. FIG. 2C depicts typical relative positions of an expanding plane 204 defining a world coordinate system 202 and the pose 203 of a mobile device within that coordinate system. The world coordinate system 202 is defined by the user of the system at the beginning of the mapping procedure by aiming the mobile device's forward facing camera towards an initial region of the scene where the map of the scene will begin. This initial region sets the world coordinate system 202 and the expanding plane 204. The expanding plane 204 lies on the X and Y axes of the world coordinate system 202, with the Z axis coming out of the plane towards the mobile device 100. The pose 203 of the mobile device is then defined within this world coordinate system 202.

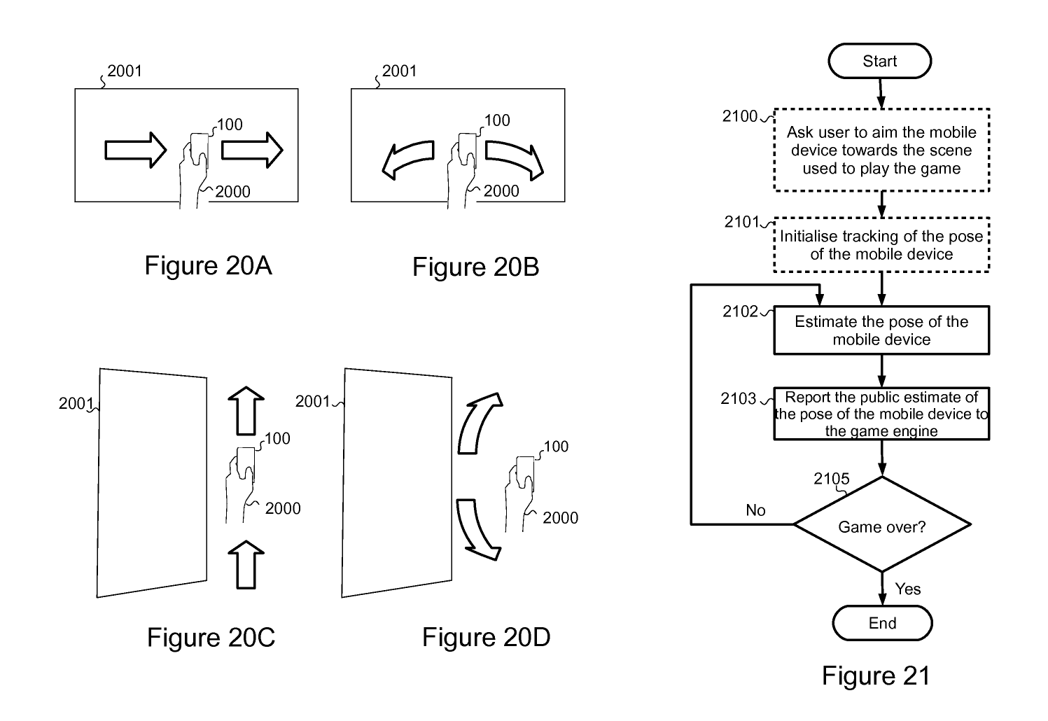

The mapping of the scene is performed by the user sweeping the mobile device's forward facing camera (i.e. the camera on the opposite side of the mobile device's display) over the scene while the system is tracking the input video and estimating the pose 203 of the mobile device. Texture from the input video frames is captured and stitched together on the expanding plane 204. As more texture from the input video frames is captured and stitched on the expanding plane 204, the plane grows to represent a map of the scene. This map is used both for estimating the pose 203 of the mobile device and identifying and selecting platforms for the AR game. The image representing the combined texture mapped on the expanding plane will be later referred to as Photomap image. FIG. 20A, FIG. 20B, FIG. 20C and FIG. 20D depict the types of mobile device motions that a user of an embodiment of the system can perform in order to map a scene. These motions involve holding 2000 the mobile device 100 with its forward facing camera aiming toward the scene to be mapped 2001, and performing: a horizontal translating motion as illustrated in FIG. 20A, a horizontal rotating motion as illustrated in FIG. 20B, a vertical translating motion as illustrated in FIG. 20C, or a vertical rotating motion as illustrated in FIG. 20D. In fact, the map can be captured by using any combination of the said four motions as well as roll rotation motions around the z axis of the pose 203 of the mobile device. The map does not have to have any particular shape, and there is no theoretical limit on how large the map of the scene can be as long as translating motions are applied. However, given that the scene is mapped onto a plane, there is is a limit to how much rotating motion can be reliably used while mapping the scene. Therefore, embodiments of the system mapping the scene onto a plane can discontinue mapping for rotations larger than a predefined limit. Other embodiments of the system can overcome this limit by mapping the scene onto a different surface, for example: a multi-plane, a cube, a curved surface, a cylinder, a sphere, or either a pre-calculated or inferred 3D mesh surface model of the scene. Each scene model will result on different qualities and working volumes of pose estimation.

Embodiments of the system that map the scene onto a surface, such as a plane, cube, curved surface, a cylinder or a sphere, will typically enable AR games with a 2D profile view of the platforms. Embodiments of the system that map the scene onto a 3D mesh surface will typically enable AR games with a 3D view of the platforms.

The types of scenes for which embodiments of the system can map and create an AR platform game include any indoors or outdoors scenes. However, in order to make the game interesting, the scenes need to include a number of horizontal surfaces or edges that can be identified by the system as platforms. A blank wall is not a good candidate scene as no platforms will be found on it. Good candidate scenes include man made scenes with multiple straight lines, for example, the shelves and books on a bookshelf, the shelves and items in a cupboard, furniture around the house, a custom scene formed by objects arranged by the user in order to create a particular AR game, etc.

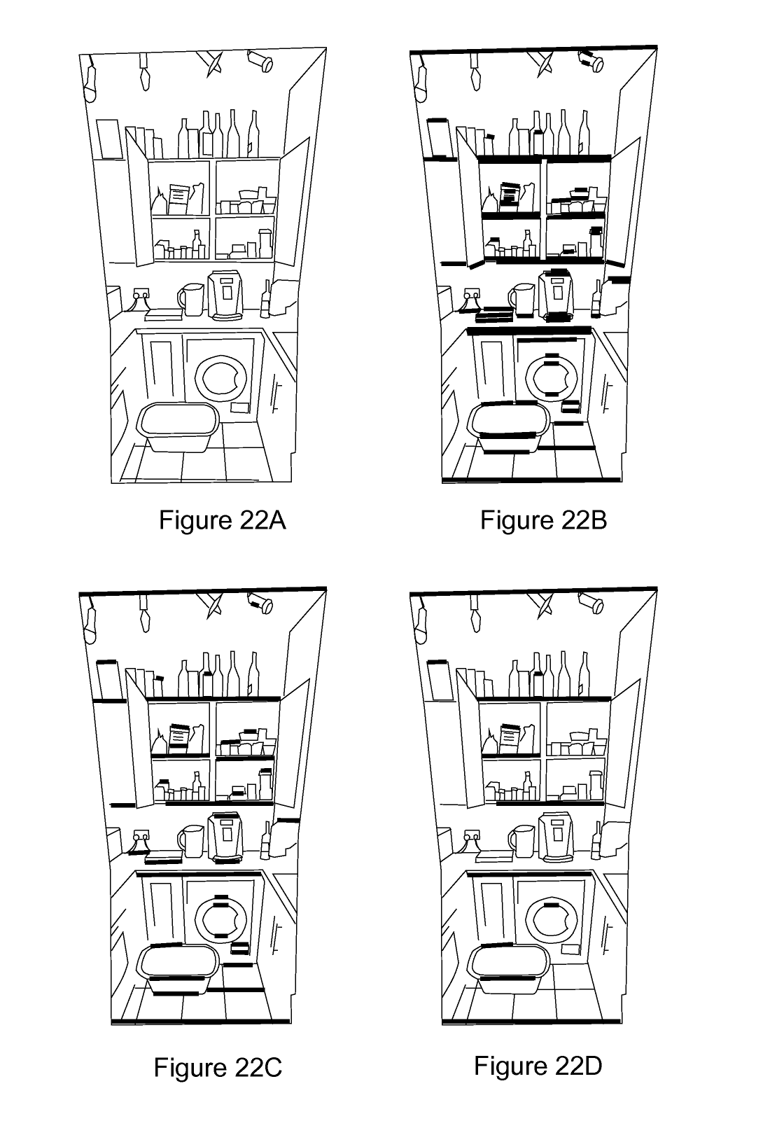

FIG. 22A depicts a map of a scene where an AR platform game can be played. The scene corresponds to a kitchen scene, where the straight lines of the objects, cupboards and furniture constitute good candidates for platforms. This map is captured by the user of an embodiment of the system standing in front of the scene and aiming the mobile device's forward facing camera towards the kitchen scene while performing a vertical rotating motion. Once a map of the scene has been captured, embodiments of the system can process the image containing the texture on the map, also referred to as Photomap image, in order to find all the possible candidate platforms on the scene. A vertical direction for the map needs to be either defined by the user or automatically determined, for example using motion sensors, during the capture of the map. If the vertical direction is not aligned with the y axis of the map, the map is first rotated so that the vertical direction is parallel to the y axis of the Photomap image coordinate system. This facilitates subsequent image processing operations. The map is then processed to find all candidate platforms. FIG. 22B depicts a map of the same scene where all the candidate platforms have been identified. In this example, the candidate platforms are all the possible horizontal edges that meet certain criteria. However, depending on the particular AR game other types of features can be detected on the map and be used for a particular purpose, for example: vertical edges meeting certain criteria can be identified as vertical walls; diagonal edges meeting certain criteria can be identified as ramp platforms; and specific objects detected on the map can be identified and have a particular meaning in the AR game.

The total number of identified candidate platforms can be filtered using one or more game rules. The game rules depend on the particular objectives of the AR game, and multiple rules are possible, some examples are:
for a game where the average distance between platforms is related to the difficulty of the game, horizontal platforms can be selected based on selecting the largest platform within a certain distance window. With this rule, if the distance window is small, the selected platforms can be nearer to each other, and if the distance window is larger, the selected platforms will be farther apart from each other (increasing the difficulty of the game).
for other games where, as well as detecting horizontal platforms, vertical edges are detected as walls, a game rule can be used to maintain a certain ratio between the number of selected walls and the number of selected horizontal platforms. Alternatively, a game rule can select platforms and walls in a way such that it guarantees a path between key game sites.
for other games where an objective is to get from one point of the map to another as soon as possible, a game rule can select walls and horizontal platforms with a certain spread so as to make travelling of the characters to a certain location more or less difficult.

FIG. 22C depicts a map of the same scene as in FIG. 22A where all the candidate platforms identified in FIG. 22B are further filtered by using a game rule based on selecting the largest platform within a distance window of 20 pixels. FIG. 22D depicts a map of the same scene as in FIG. 22A where all the candidate platforms identified in FIG. 22B are further filtered by using a game rule based on selecting the largest platform within a distance window of 40 pixels. The selected platforms are then passed to a game engine (possibly involving a physics engine) that can interpret them as platforms, which characters in the AR game can interact with, stand on and walk over.

In some embodiments of the system, the mapped scene, together with the identified platforms, can be stored locally or shared online for other users to play on in Virtual Reality (VR) mode. In VR mode, the user loads a scene from local or from an online server and plays the game on that loaded scene. As is the case for AR mode, the user first needs to define a local world coordinate system 202 by aiming the mobile device in a desired direction and indicating to the system to use this direction. Then the world coordinate system of the downloaded scene is aligned with the local world coordinate system. Finally, the loaded scene, together with platforms and other game objects, is presented to the user within the local world coordinate system 202. In VR mode, the system can estimate the pose of the mobile device within a local world coordinate system 202 by tracking and mapping the input video of a local scene as seen by the mobile device's forward facing camera, while instead presenting to the user the downloaded scene with its corresponding platforms and other game objects. As in VR mode the scene presented to the user is downloaded, the only need for a mobile device's forward facing camera is to use it to estimate the pose 203 of the mobile device. As the pose 203 of the mobile device can also be estimated just by using motion sensors, embodiments of the system that work on VR mode can operate without the need of a forward facing camera.

Embodiments of the system using VR mode can enable multi-player games. In this case, multiple users will download the same scene and play a game on the same scene simultaneously. A communications link with a server will allow the system to share real-time information about the characters position and actions within the game and make this information available to a number of VR clients that can join the game. FIG. 31 shows a block diagram of a multi-player architecture. The AR player 3100 can map a local scene and upload this scene, together with the identified platforms on that scene, to a Server 3101 that will handle the Shared Scene Data 3102 and make it available to other players.

While an AR player 3100 plays an AR game on its local scene, other remote VR players 3103 can download the same Shared Scene Data 3102, and join the AR player game in VR mode. During the game, both the AR player 3100 and the VR players 3103 will synchronize their game locations and actions through the Server 3101, making it possible for all of them to play the same game together.

FIG. 26 depicts an example usage of an embodiment of the system where one user is playing a game in AR mode on a local scene, while another two remote users are playing in VR mode on the same scene as the AR user. In this situation, a user of an embodiment of the system 1801 (the AR player in this figure) can map a local scene and upload this scene, together with the selected platforms on that scene, to a Server 3101. The Server 3101 will make the Shared Scene Data 3102 available to VR clients. Continuing with the example in FIG. 26, two other users 2606 and 2607 can download from the Server 3101 the shared scene and can play the same game in VR mode. The VR players can play a shared scene either simultaneously or at different times. If the scene is played simultaneously with an AR player or with other VR players, real-time information is exchanged through the Server 3101, and the AR player or VR players are able to interact with each other within the game. Assuming simultaneous playing on the same game, when the AR player 1801 aims the mobile device 100 towards a region on the scene 2601 that has been previously mapped, the system will present on the mobile device's display a view 2603 of the platforms and game objects corresponding to that region in the scene. Then, a remote VR player 2606 can join the game by connecting to the Server 3101, downloading the same scene, and sharing real-time data. This will allow the VR player 2606 to see on his mobile device's display a region of the shared scene corresponding with the local pose of his mobile device. Following the example in FIG. 26, if the VR player 2606 aims his mobile device towards a local region corresponding with the remote region 2600 on the downloaded scene, his mobile device's display will show a view 2604 of the scene including the platforms and any current game characters located within that region of the scene. If another VR player 2607 connects to the same game, and aims his mobile device towards a local region corresponding with the remote region 2602 on the shared scene, his mobile device's display will show a view 2605 of the scene including the platforms and any current game characters located within the region 2602. In this particular case, the view 2605 of the region 2602 on the shared scene, includes the game character labelled A, belonging to the AR player 1801, and the game character labelled C, belonging to the second VR player 2607.

As used herein, the term “mobile device” refers to a mobile computing device such as: mobile phones, smartphones, tablet computers, personal digital assistants, digital cameras, portable music players, personal navigation devices, netbooks, laptops or other suitable mobile computing devices. The term “mobile device” is also intended to include all electronic devices, typically hand-held, that are capable of AR or VR.

### 2. Exemplary Architecture

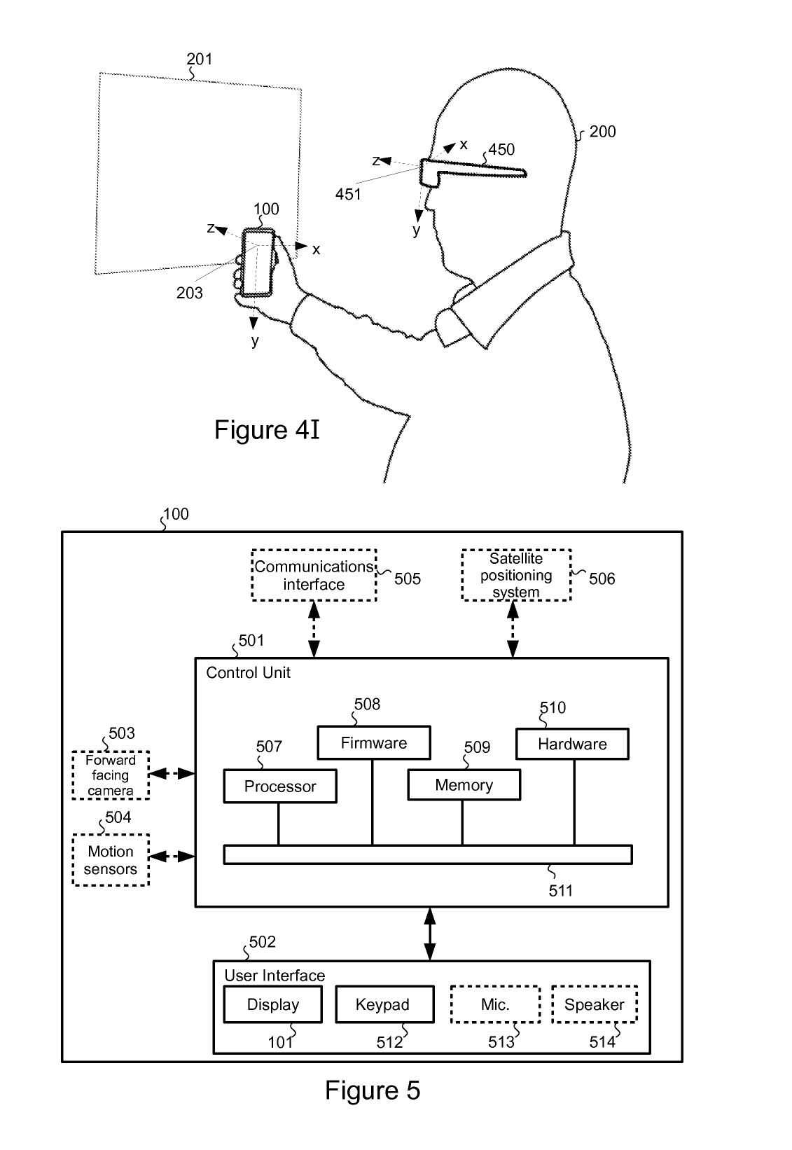

FIG. 5 shows a block diagram of an exemplary architecture of the mobile device 100 in which embodiments of the system can be implemented. The architecture has a minimum computational capability sufficient to enable the running of native applications; the capture of the applications visual output and mapping to the virtual surfaces; the pose estimation of the mobile device; and the rendering of the virtual surfaces on the mobile device's display according to the estimated pose of the mobile device. The computational capability is generally provided by one or more control units 501, which comprise: one or more processors 507, these can be single core or multicore; firmware 508; memory 509; and other sub-systems hardware 510; all interconnected through a bus 511. In some embodiments, in addition to the control units 501, part of or all of the computational capability can be provided by any combination of: application specific integrated circuits (ASICs), digital signal processors (DSPs), programmable logic devices (PLDs), field programmable gate arrays (FPGAs), graphic processing units (GPUs), micro-controllers, electronic devices, or other electronic units capable of providing the required computational resources. In embodiments where the system is implemented in firmware and/or software, the functions of the system may be stored as a set of instructions on a form of computer-readable media. By way of example, and not limitation, such computer readable media can comprise RAM, ROM, Flash Memory, EEPROM, CD-ROM or other optical disk storage, magnetic storage, or other magnetic storage devices. Combinations of the above should also be included within the scope of computer-readable media. In FIG. 5 the blocks corresponding to firmware 508 or memory 509 generally represent the computer-readable media needed to store either the firmware or software implementation of the system. The block hardware 510 generally represents any hardware sub-systems needed for the operation of the mobile device, for example, bus controllers, coprocessors or graphic processing units.

Generally, the architecture has a user interface 502, which will include at least a display 101 to visualise contents and a keypad 512 to input commands; and optionally include a microphone 513 to input voice commands; and a speaker 514 to output audio feedback. The keypad 512 can be a be a physical keypad, a touchscreen, a joystick, a trackball, or other means of user input attached or not attached to the mobile device.

Normally, embodiments of the system will use a display 101 embedded on the mobile device 100. However, other embodiments of the system can use displays that are not connected to the mobile device, for example: a computer display can be used to display what would normally be displayed on the embedded display; a projector can be used to project on a wall what would normally be displayed on the embedded display; or a Head Mounted Display (HMD) can be used to display what would normally be displayed on the embedded display. In these cases, the contents rendered on the alternative displays would still be controlled by the pose 203 of the mobile device and the keypad 512.

In order to estimate the pose 203 of the mobile device, the architecture uses at least one sensor. This sensor can be a forward facing camera 503, that is the camera on the opposite side of the screen; it can be motion sensors 504, these can include accelerometers, compasses, or gyroscopes; or it can be both a forward facing camera 503 and motion sensors 504.

The mobile device architecture can optionally include a communications interface 505 and satellite positioning system 506. The communications interface can generally include any wired or wireless transceiver. The communications interface includes any electronic units enabling the mobile device to communicate externally to exchange data. For example, the communications interface can enable the mobile device to communicate with: cellular networks, WiFi networks; Bluetooth and infrared transceivers; USB, Firewire, Ethernet, or other local or wide area networks transceivers. The satellite positioning system can include for example the GPS constellation of satellites, Galileo, GLONASS, or any other suitable territorial or national satellite positioning system.

### 3. Exemplary Implementation

Embodiments of the system can be implemented in various forms. Generally, a firmware and/or software implementation can be followed, although hardware based implementations are also considered, for example, implementations based on application specific integrated circuits (ASICs), digital signal processors (DSPs), programmable logic devices (PLDs), field programmable gate arrays (FPGAs), graphic processing units (GPUs), micro-controllers, electronic devices, or other electronic units capable of providing the required computational resources for the system operation.

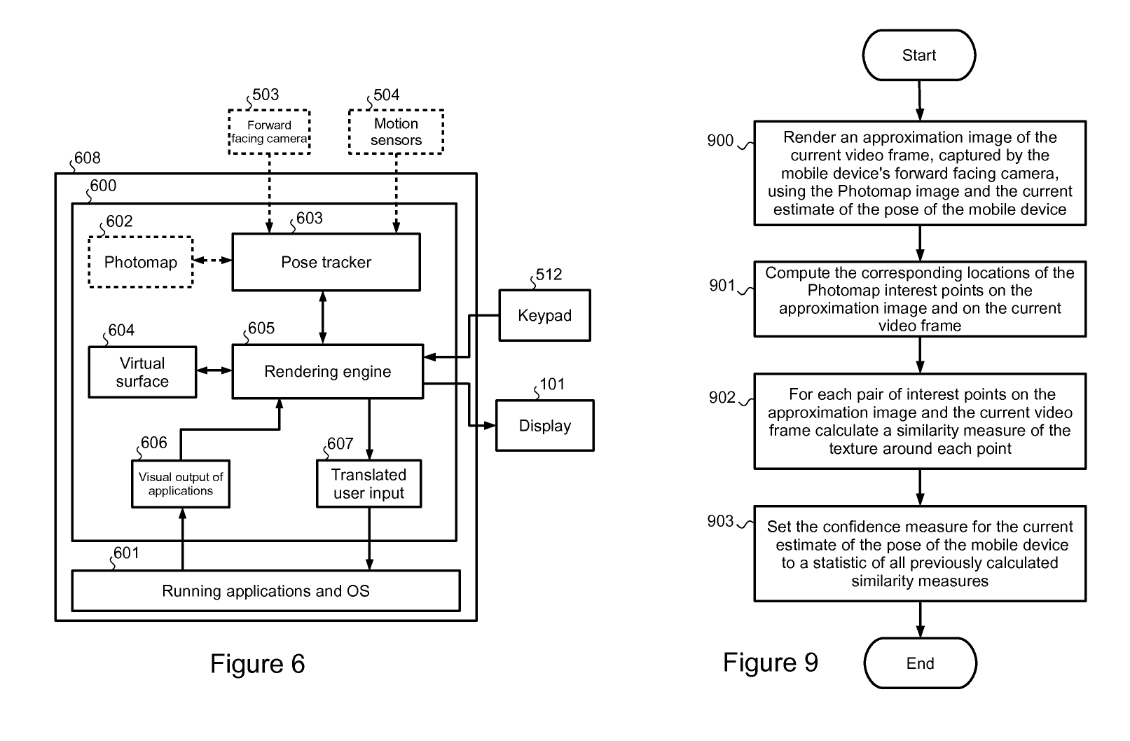

Embodiments using a software implementation will need to interact with an operative system (OS) and other applications running on the mobile device, as well as with a user interface and sensor hardware. FIG. 6 is a block diagram for a preferred embodiment of the system, showing the interrelation between the various parts of the system, the operating system and running applications, the user interface, and the sensor hardware. Generally, a mobile device will store its software components 608 on some form of computer-readable media, as previously defined in the exemplary architecture. The software components include an implementation of the system 600, and typically, an operative system (OS) running other applications 601. In specific embodiments of the system, the OS can be substituted by a hardware or firmware implementation of basic services that allow software to boot and perform basic actions on the mobile device's hardware. Examples of this type of implementation include the Basic Input/Output System (BIOS) used in personal computers, OpenBoot, or the Unified Extensible Firmware Interface (UEFI). In these embodiments of the system, the concept of applications running on the mobile device can be substituted by a single or limited number of software instances, possibly combined with the interaction systems and methods herein described.

The preferred implementation of the system has two major operational blocks: the pose tracker 603 and the rendering engine 605.

The pose tracker block 603 is responsible for the definition of the world coordinate system 202 and the computation of estimates of the pose 203 of the mobile device within the defined world coordinate system. To estimate the pose 203 of the mobile device, the pose tracker 603 needs to read and process data from sensors. In some embodiments of the system, the sensors can be motion sensors 504, typically accelerometers, compasses, and gyroscopes. These motion sensors require sensor-fusion in order to obtain a useful signal and to compensate for each other's sensor limitations. The sensor-fusion can be performed externally in specialised hardware; it can be performed by the operative system of the mobile device; or it can be performed totally within the pose tracker block 603. The estimation of the pose 203 of the mobile device using motion sensors is called motion sensor based pose estimation. In other embodiments of the system, the sensor used to estimate the pose 203 of the mobile device can be a forward facing camera 503. When a forward facing camera 503 is used to estimate the pose 203 of the mobile device, images captured by the camera are sequentially processed in order to find a relative change in pose between them, due to the mobile device changing its pose, this is called vision based pose estimation.

In preferred embodiments of the system, both motion sensors 504 and forward facing camera 503 will be used to estimate the pose 203 of the mobile device. In this case two estimates of the pose will be available, one from processing the data coming from the motion sensors, and another from processing the images captured by the forward facing camera 503. These two estimates of the pose are then combined into a more robust and accurate estimate of the pose 203 of the mobile device.

Typically, vision based pose estimation systems that do not depend on specific markers implement simultaneous localisation and mapping (SLAM). This means that as the pose of a camera is being estimated, the surroundings of the camera are being mapped, which in turn makes possible further estimation of the pose of the camera. Embodiments of the system that use vision based SLAM to estimate the pose of the mobile device need to store the mapping information. In a preferred embodiment of the system this mapping information is stored in a data structure named Photomap 602. The Photomap data structure 602, also referred in this description as simply Photomap, stores mapping information that enables the pose tracker block 603 to estimate the pose 203 of the mobile device within a certain working volume.

Other less preferred embodiments of the system may use other types of vision based pose estimation that do not require the storage of the surroundings of the mobile device in order to estimate its pose, for example, optical flow based pose estimation or marker based pose estimation. These pose estimation methods do not require an equivalent to the Photomap data structure 602.

If the specific embodiment of the system does not use a forward facing camera 503 to estimate the pose 203 of the mobile device, for example embodiments using only motion sensors 504, the Photomap data structure 602 is not necessary.

Some embodiments of the system can use multiple Photomaps 602. Each Photomap can store mapping information for a specific location, each one enabling the pose tracker block 603 to estimate the pose of the mobile device within a certain working volume. Each Photomap can have a different world coordinate system associated with it. These world coordinate system can be connected to each other, or they can be independent of each other. A management subsystem can be responsible for switching from one Photomap to another Photomap depending on sensor data. In these embodiments of the system, the virtual surface can be located at the same coordinates and orientation for each Photomap and associated world coordinate system, or they can be located at different coordinates and orientation for each Photomap and associated world coordinate system.

Other means for estimating the pose 203 of the mobile device are possible and have been considered. For example:
If a backward facing camera is available on the mobile device, the system can track the users face, or other target in the users body, and estimate the pose of the mobile device relative to that target;
Sensors, such as optical sensors, magnetic field sensors, or electromagnetic wave sensors, can be arranged around the area where the mobile device is going to be used, then, a visual or electromagnetic reference can be attached to the mobile device. This arrangement can be used as an external means to estimate the pose of the mobile device, then, the estimates of the pose, or effective equivalents, can be sent back to the mobile device. Motion capture technologies are an example of this category;
Generally, a subsystem containing any combination of sensors on the mobile device that measure the location of optical, magnetic or electromagnetic references, present in the surroundings of the user or on the same users body, can use this information to estimate the pose of the mobile device with respect to these references;

The rendering engine block 605 is responsible for collecting the visual output of applications 606 running on the mobile device and mapping it to the virtual surface 604. A virtual surface can be thought of as a sort of virtual projection screen onto which visual contents can be mapped. Element 201 in FIG. 2A represents a virtual surface in context with the mobile device 100 and the user of the interaction system 200. The visual output of applications running on the mobile device can be reformatted to better suit the specific size of the virtual surface. The virtual surface will generally be a flat rectangular surface, of a predetermined size, typically at a permanent location within the world coordinate system 202. Other shapes, either flat or curved, are also considered as possible virtual surfaces. Multiple virtual surfaces are also possible, in which case each surface can be mapped to the output of a individual application running on the mobile device. The rendering engine 605 is also responsible for creating a perspective view of the virtual surface onto the mobile device's display 101. This perspective view will depend on the position and orientation of the virtual surface within the world coordinate system 202 and the estimate of the pose of the mobile device, provided by the pose tracker block 603. The rendering engine 605 is also responsible for collecting user input, from keypad 512, related to the current perspective view rendered on the mobile device's display 101 and translating that input 607 into the corresponding input for the running applications 601 whose visual output has been mapped to the virtual surface. For example, if the keypad is a touchscreen, when a user taps on the touchscreen at position (xd, yd), the rendering engine 605 collects this point and performs the following actions:
Projects the point (xd, yd) into a corresponding point (xv, yv) on the virtual surface. The corresponding point (xv, yv) will depend on the original (xd, yd) point, the pose of the virtual surface and the estimate of the pose 203 of the mobile device within the world coordinate system 202.
Maps the point (xv, yv) on the virtual surface to the corresponding point (xa, ya) on the local coordinate system of the visual output of the application that has been mapped to that virtual surface.
Finally, the point (xa, ya) is passed to the application that has been mapped to that virtual surface. The application reacts as if the user had just tapped on the point (xa, ya) of its visual output coordinate system.

Finally, the rendering engine 605 can also forward various user input from keypad 512 to the pose tracker 603, for example, so that the pose tracker can deal with user requests to redefine the world coordinate system 202. The user input, either to interact with the contents rendered on the display or to generally control the interaction system, will normally come from keypad 512, but alternative embodiments of the system can use microphone 513 for voice commanded user input.

In preferred embodiments of the system, the pose tracker block 603 and the rendering engine block 605 can run simultaneously on separate processors, processor cores, or processing threads, in order to decouple the processing latencies of each block. Single processor, processor core, or processing thread implementations are also considered as less preferable embodiments of the system.

### 4. Pose Tracker Block

The pose tracker block is responsible for the definition of the world coordinate system 202 and the computation of estimates of the pose 203 of the mobile device within the defined world coordinate system.

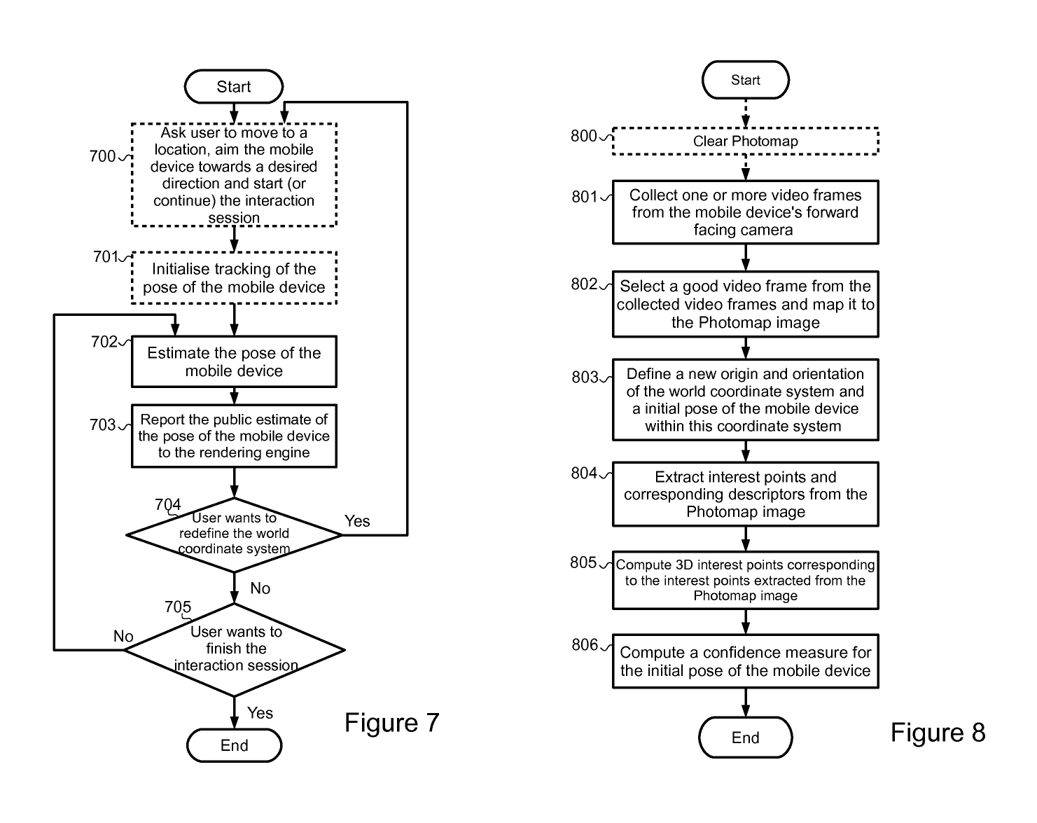

FIG. 7 shows a flowchart for the general operation of a preferred implementation of the pose tracker block. This is an extended description of the pose tracker block 603 in FIG. 6. The operation begins when the user decides to start an interaction session with the applications running on the mobile device. In the first step 700, the system asks the user to position himself and aim the mobile device towards a desired direction. When the user is ready to continue, he indicates this through a user interface. The position and direction of the mobile device at this point will determine the origin and direction of the world coordinate system 202 and the pose 203 of the mobile device within this world coordinate system. The world coordinate system 202 and the pose 203 of the mobile device within this world coordinate system are defined in the pose tracking initialisation, step 701. Next, the system enters into a main loop where the pose 203 of the mobile device is estimated 702, and the resulting estimate of the pose, here referred to as public estimate of the pose, is reported to the rendering engine 703. This main loop continues indefinitely until the user decides to finish the interaction session 705. The user can then continue operating the applications running on the mobile device by using the default user interface on the mobile device.

During an interaction session the user may decide to redefine the world coordinate system, for example to keep working further away on a different position or orientation, step 704. At this point the system goes back to step 700. Then, the system asks the user to position himself and aim the mobile device towards a desired direction. This will result in a new origin and direction of the world coordinate system 202. Redefining the world coordinate system, as opposed to ending and restarting the interaction session, allows the system to keep all the pose tracking information and make the transition to the new world coordinate system quick and with minimal disruption to the flow of interaction with the applications running on the mobile device.

Preferred embodiments of the system estimate the pose 203 of the mobile device using both forward facing camera 503 and motion sensors 504. These pose estimations are known as vision based pose estimation and motion based pose estimation. Motion based pose estimation alone tends to produce accurate short term estimates, but estimates tend to drift in the longer term. This is especially the case when attempting to estimate position. In contrast, vision based pose estimation may produce less accurate estimates on the short term, but estimates do not drift as motion based estimates do. Using both motion based pose estimation and vision based pose estimation together allows the system to compensate for the disadvantages of each one, resulting in a more robust and accurate pose estimation.

The vision based pose estimation preferably implements vision based SLAM by tracking and mapping the scene seen by the forward facing camera 503. A data structure that will be used throughout the rest of the vision based pose estimation description is the Photomap data structure 602. The Photomap data structure 602, also referred in this description as simply Photomap, stores mapping information that enable the pose tracker block 603 to estimate the pose 203 of the mobile device within a certain working volume. This Photomap data structure includes:
A Photomap image. This is a planar mosaic of aligned parts of images captured by the forward facing camera 503.
A Photomap offset. This is a 3×3 matrix representing the offset of data on the Photomap image as the Photomap image grows. It is initialised to an identity matrix.
A Photomap reference camera. This is a 3×4 camera matrix that describes the mapping between 3D points in the world coordinate system 202 and the points on a video frame captured by the forward facing camera 503 at the moment of pose tracking initialisation.
A Photomap mapping, this is a 3×3 matrix that connects points on the Photomap image with points on the plane used to approximate the scene seen by the forward facing camera 503.
Photomap interest points. These are 2D points on the Photomap image that are distinctive and are good candidates to use during tracking;
Photomap interest point descriptors. These are descriptors for the Photomap interest points.
Photomap 3D interest points. These are 3D points lying on the surface of the plane used to approximate the scene seen by the forward facing camera 503, and that correspond to each of the Photomap interest points.

In some embodiments of the system, steps 700 and 701 in FIG. 7, can be optionally executed. When they are not executed, the operation begins directly at the pose estimation step 702. This means that the user of the embodiment does not have to define a world coordinate system to begin using the interaction system. In these embodiments, the system can either use a world coordinate system that is implicit in the pose tracking algorithms, or a world coordinate system that has previously been defined and saved, then loaded when the interaction system starts. Saving and loading the Photomap data structure 602 makes it possible to save and load world coordinate system definitions. In these embodiments of the system the user can still redefine the world coordinate system, and if desired, save it for a later use.

To approximate the scene captured by the forward facing camera 503, preferred embodiments of the system use a plane, passing by the origin of the world coordinate system. In these embodiments, the Photomap image can be thought of as a patch of texture anchored on this plane. A plane approximation of the scene is accurate enough for the system to be operated within a certain working volume. In the rest of this description, the model used to approximate the scene seen by the forward facing camera 503 is a plane passing by the origin of the world coordinate system 202.

Other embodiments of the system can use different models to approximate the scene captured by the forward facing camera 503 which can result in larger working volumes. For example, some embodiments of the system can use a multi-plane, a cube, a curved surface, a cylinder, or a sphere—each one resulting in different qualities and working volumes of pose estimation. More accurate approximations of the scene are also possible, for example, a pre-calculated surface model of the scene, or an inferred surface model of the scene. In these cases, the Photomap image would become a UV texture map for the surface model.

Depending on which model is used to approximate the scene, the Photomap data structure can still be relevant and useful after redefining the world coordinate system 202. An example of such a model is an inferred surface model of the scene. In this case the Photomap data can be kept and pose tracking can continue using the same Photomap data. If the model used to approximate the scene is a plane, the Photomap data will probably not be useful after a redefinition of the world coordinate system. In this case the Photomap data can be cleared.

FIG. 8 shows a flowchart for a preferred implementation of the pose tracker initialisation. This is an extended description of step 701 in FIG. 7. The first step 800 is optional. As explained above, this step involves clearing some or all the data in the Photomap data structure 602. This is relevant when step 800 is reached because the user wants to redefine the world coordinate system 202.

The next step 801 in the pose tracker initialisation, involves collecting one or more video frames (images) from the mobile device's forward facing camera 503. These video frames will be used to establish the origin and orientation of the world coordinate system.

Some embodiments of the system can establish the world coordinate system 202 by assuming it to have the same orientation as the image plane of the forward facing camera 503, and assuming it to lie at a predetermined distance from the camera. In other words, in these embodiments, the X and Y axes of the world coordinate system 202 can be assumed to be parallel to the x and y axes of the mobile device's forward facing camera coordinate system, and the distance between these two coordinate systems can be predetermined in the configuration of the system. Notice that the pose 203 of the mobile device and the forward facing camera coordinate system coincide. According to this method, the plane used to approximate the scene seen by the forward facing camera 503 is aligned with the X and Y axes of the world coordinate system, having Z axis equal to zero. A selected video frame from the collected video frames is then mapped to this plane, this establishes the world coordinate system. The rest of the flowchart in FIG. 8 shows this method. Other embodiments of the system can use other methods to establish the world coordinate system 202, for example, the system can extract a number of 2D interest points from each of the images in the collected video frames, while prompting the user of the system to slightly change the orientation of the mobile device; then, assuming that these interest points correspond to coplanar points in the real scene, the orientation of that plane, and therefore the orientation of the world coordinate system 202, can be found using bundle adjustment on the collection of 2D interest points.

In step 802, the system proceeds to select a good video frame from the collected video frames and map it to the Photomap image. In some embodiments of the system, a video frame can be considered good when intensity changes between the previous and following collected video frames is small. This approach filters video frames that may contain motion blur and can result in poor Photomap images. In other embodiments of the system, a good frame can be synthesised from the collected video frames, for example, using a median filter on the collected video frames; using a form of average filter or other statistic measures on the collected video frames; also superesolution techniques can be used to synthesise a good video frame out of the collected video frames. The resulting good video frame can have better resolution and less noise than any of the individual collected video frames.

The selected video frame is then mapped to the Photomap image. At this point, the Photomap image can be thought of as a patch of texture lying on a plane passing through the origin of the world coordinate system, the patch of texture being centred on this origin. By definition, at the moment of pose tracking initialisation, the Photomap image is considered to be parallel to the camera's image plane, that is, in this case, the selected video frame. Therefore, an identity mapping can be used to map the selected video frame to the Photomap image. At this point, the X and Y axes of the world coordinate system 202 are parallel to the x and y axes of the camera coordinate system, which coincides with the pose 203 of the mobile device. The distance along the world coordinate system Z axis between this plane and the mobile device is predefined in the configuration of the system, and can be adjusted depending on the scene. This defines the world coordinate system 202 and the initial pose for the mobile device 203, step 803.

Another data structure that will be used throughout the rest of the vision based pose estimation description is the “current camera”. The current camera is a 3×4 camera matrix, also called projection matrix in the literature, that relates 3D points in the world coordinates system 202 with points on the image plane of the forward facing camera 503. The intrinsic parameters of the current camera are assumed to be known and stored in the configuration of the system. The extrinsic parameters of the current camera are equal to the current pose 203 of the mobile device—as the camera coordinate system is attached to the mobile device. Estimating the pose 203 of the mobile device is equivalent to estimating the current camera's extrinsic parameters. Accordingly, references to estimating the “current camera pose” in fact mean estimating the pose 203 of the mobile device.

At this point, the Photomap reference camera is defined to be equal to the current camera. The Photomap reference camera is therefore a record of the current camera pose at the moment of pose tracking initialisation. Also, at this point, the Photomap mapping is defined. The Photomap mapping associates points on the Photomap image with points on the plane used to approximate the scene captured by the forward facing camera 503, this is then a plane to plane mapping. In preferred embodiments of the system, both planes are parallel, which results in a Photomap mapping that only performs scaling and offsetting. Finally, during step 803, the output of the motion sensors is recorded to serve as a reference. This reference will be later used in conjunction with the sensor fusion to produce motion based estimates of the pose within the defined world coordinate system 202.

Next, Interest points and corresponding descriptors are extracted from the Photomap image. In preferred embodiments of the system, these interest points and descriptors are used in two ways:
In a global search, the interest point descriptors are used by matching them to new descriptors found on incoming video frames.
In a local search, the interest points are used by matching patches of their neighbouring texture around the Photomap image with the new textures observed on incoming video frames.

Step 804, extracts interest points and corresponding descriptors from the Photomap image. The resulting 2D interest points are defined on the Photomap image local coordinate system. For the purpose of pose tracking, an interest point is a point in an image whose local structure is rich and easily distinct from the rest of the image. A range of interest point detectors can be used in this step. Some examples of popular interest points detectors are, Harris corner detectors, Scale-invariant feature transform (SIFT) detectors, Speeded Up Robust Features (SURF) detectors, and Features from Accelerated Segment Test (FAST) detectors. An interest point descriptor is a vector of values that describes the local structure around the interest point. Often interest point descriptors are named after the corresponding interest point detector of the same name. A range of interest point descriptors can be used in this step. In a preferred embodiment of the system, a Harris corner detector is used to detect the interest points, and a SURF descriptor is used on the detected interest points. The Harris corner detector produces good candidate points for matching the Photomap image texture local to the interest points, which is useful when calculating a vision based estimate of the pose of the mobile device following a local search strategy. Typically, a number from 25 to 100 of the strongest Harris corners are detected as interest points during step 804. The SURF descriptor is both scale and rotation invariant, which makes it a good candidate when calculating a vision based estimate of the pose of the mobile device following a global search strategy.

The next step 805, computes the 3D points corresponding to the Photomap interest points. The 3D points corresponding to the Photomap interest points are computed by applying the previously defined Photomap mapping to each of the of the Photomap interest points. In other embodiments of the system, the model used to approximate the scene can be different from a plane, for example, a surface model of the scene. In these cases, assuming a triangulated mesh, the computation of the 3D points would involve projecting the triangulation of the surface model on the Photomap image, calculating the barycentric coordinates of each Photomap interest point within their corresponding triangle, and finally applying the same barycentric coordinates to the corresponding triangles on the surface model.

The last step of the pose tracker initialisation, step 806, involves computing a confidence measure for the initial pose of the mobile device. Typically, at this point the confidence of the initial pose of the mobile device should be high—as the pose has just been defined. However, different implementations of the pose tracker initialisation may introduce different processing delays, and if the pose of the mobile device is not constant during the entire initialisation, the initial pose of the mobile device may be different from the real pose of the mobile device. To illustrate this, imagine that in the aforedescribed initialisation process, the selected video frame from the collected video frames, step 802, is the first video frame of the collection. The world coordinate system 202, and the pose 203 of the mobile device, will be defined in terms of this first video frame. If the pose of the mobile device changes by the time the last video frame in the collection is reached, the defined initial pose of the mobile device may be different to the actual pose of the mobile device. This situation will be reflected by a low confidence measure.

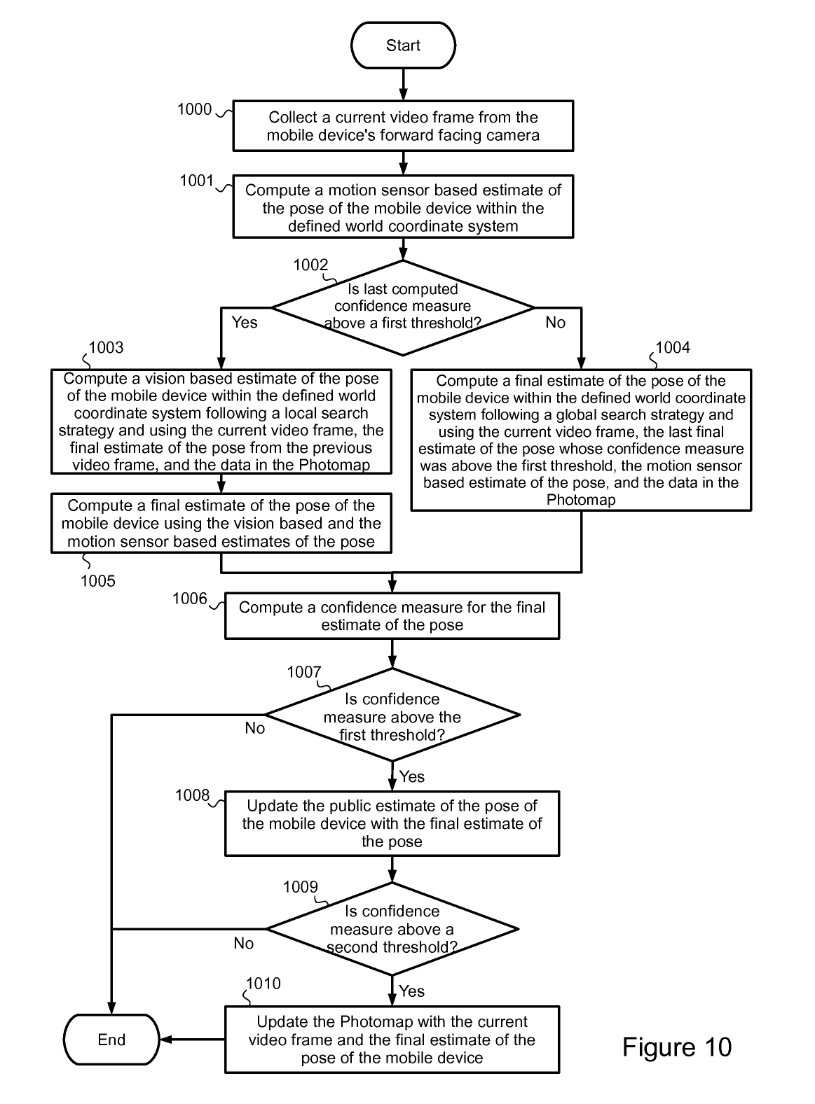

FIG. 9 shows a flowchart for a preferred implementation of a confidence measure for an estimate of the pose of the mobile device. This is an extended description of both step 806 in FIG. 8 and step 1006 in FIG. 10. The first step 900 for computing the confidence measure involves rendering an approximation image of the current video frame captured by the mobile device's forward facing camera 503. The approximation image is intended to look as similar as possible to the real video frame. This approximation image is rendered using the Photomap image and the current estimate of the pose of the mobile device. To this end, a homography is defined that takes points on the Photomap image to points on the approximation image. The Photomap image coordinate system is registered using the Photomap reference camera. Therefore, this homography can be easily calculated as the homography that transforms the Photomap reference camera image plane to the current camera image plane. The equation to calculate this homography is:

$$H = Ka ( R - t \frac{{n}^{T}}{d} ) {Kb}^{-} \qquad ( 1 )$$

where Ka and Kb are the intrinsic parameters of the current camera and Photomap reference camera; R is the rotation between the Photomap reference camera and the current camera; t is the translation between the Photomap reference camera and the current camera; n is the normal to the plane used to approximate the scene seen by the forward facing camera 503; and d is the distance between that plane to the camera centre of the current camera.

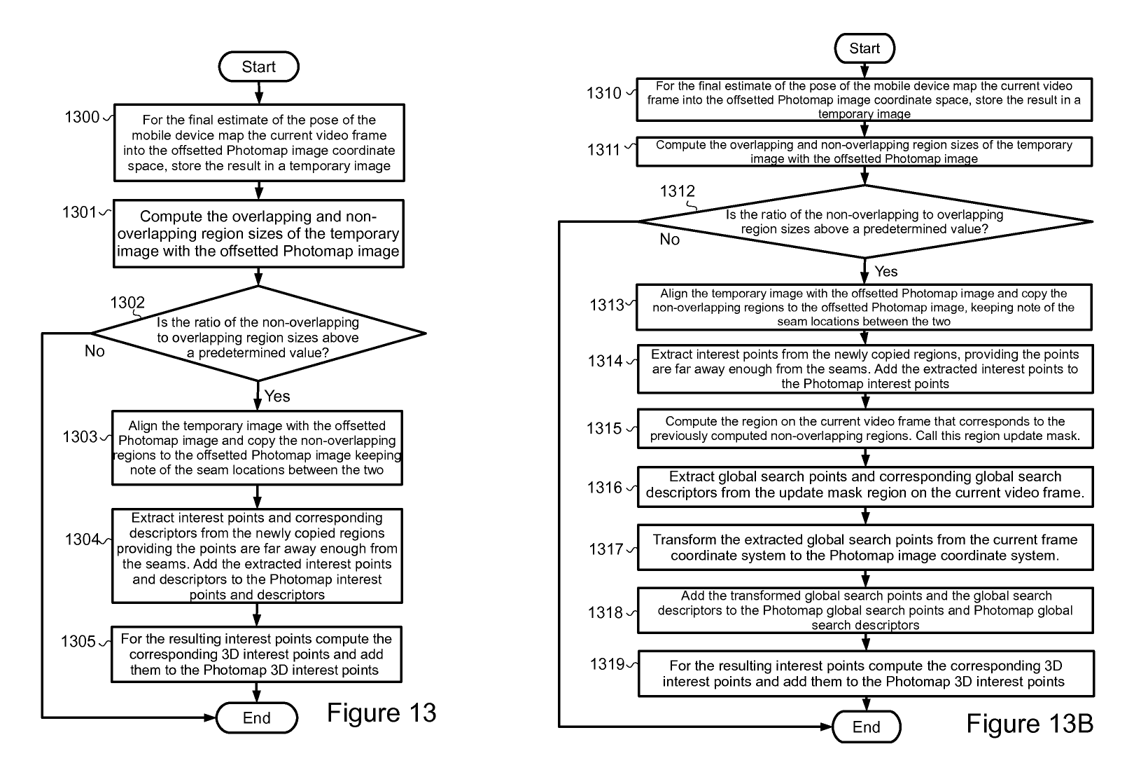

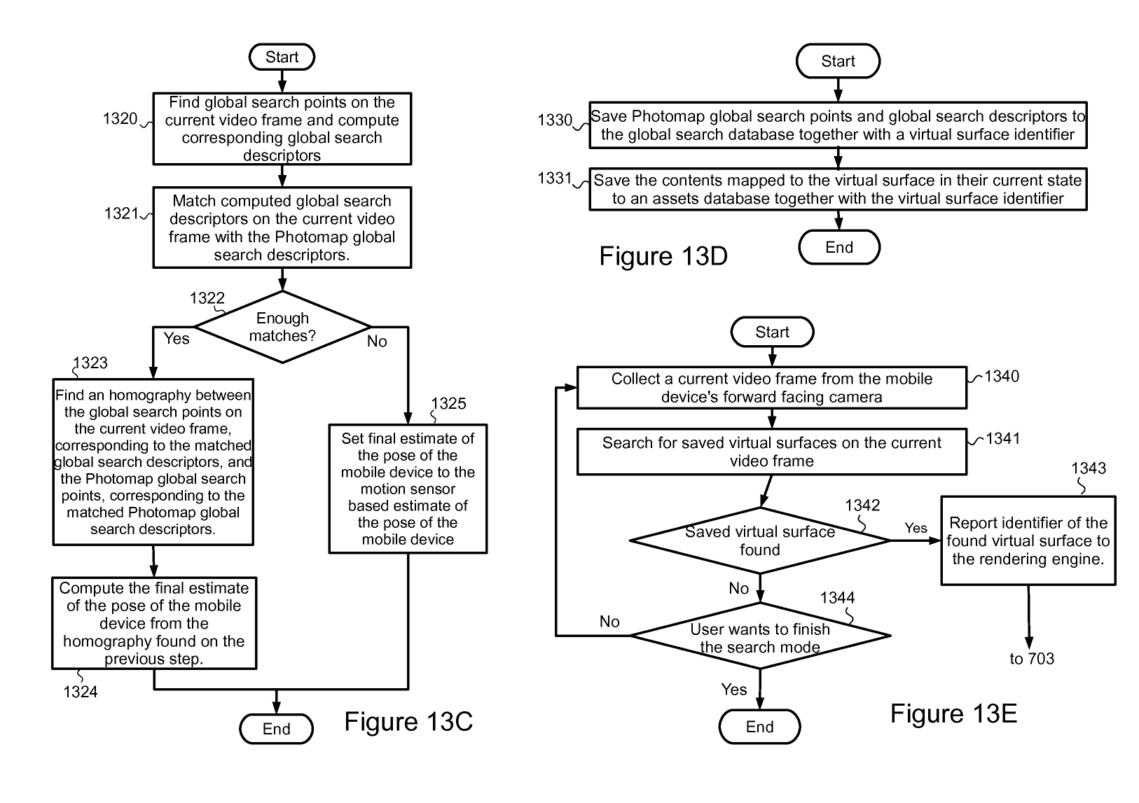

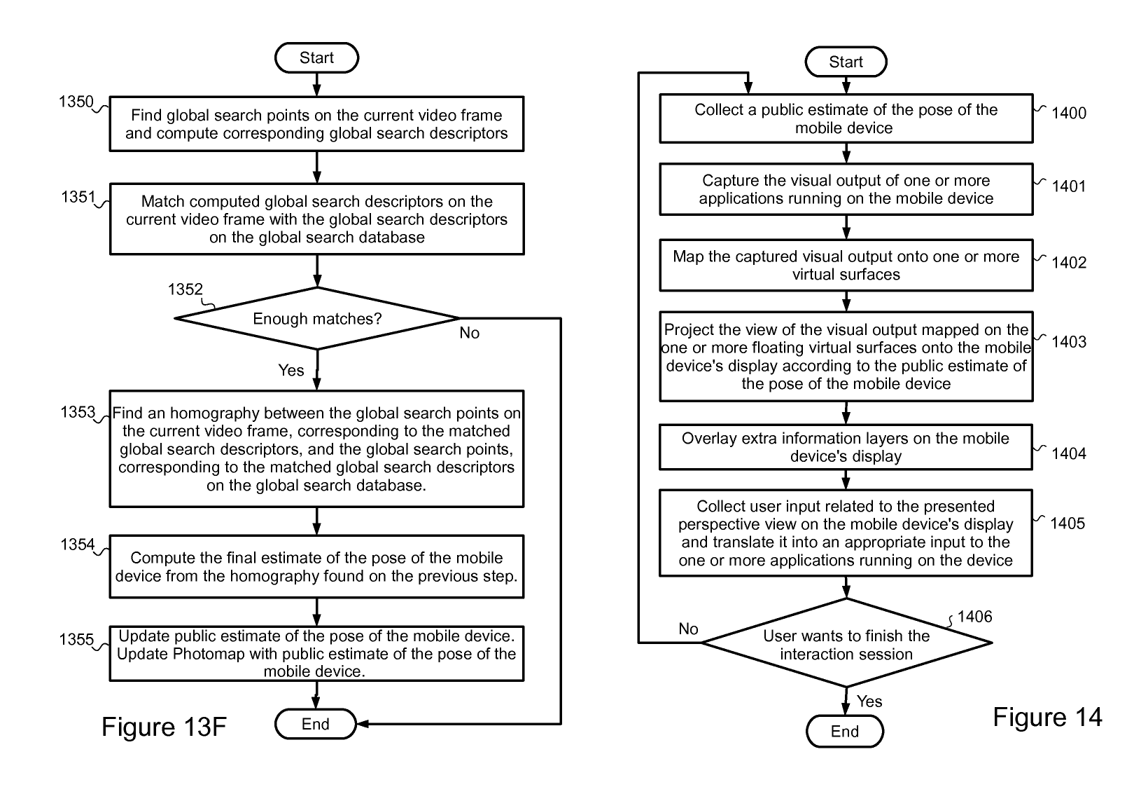

Remember that the current camera's extrinsic parameters are equal to the current estimate of the pose 203 of the mobile device. As the Photomap image can change in size during a Photomap update, the resulting homography needs to be right multiplied with the inverse of the Photomap offset. The Photomap offset is initially equal to the identity, but every time the Photomap image is updated this Photomap offset is recalculated. The Photomap offset relates the data in the Photomap image before an update, with the data in the Photomap image after the update. See FIG. 13 for a complete description of the Photomap update. A Photomap image to approximation image mapping is then defined as the previously calculated homography right multiplied with the inverse of the Photomap offset. The Photomap image to approximation image mapping is then used to perform a perspective warp of the Photomap image into the approximation image. The approximation image then becomes a “virtual camera” view of the Photomap image from the current estimate of the pose of the mobile device. During the pose tracker initialisation the resulting approximation image should be fairly similar to the current video frame captured by the forward facing camera 503.

Step 901, calculates the corresponding locations of the Photomap interest points on the approximation image and the current video frame. This is achieved by applying the previously calculated Photomap image to approximation image mapping to the Photomap interest points. The result is valid both for the approximation image and for the current video frame.

In step 902, rectangular regions centred on the interest points on the approximation image and current video frame, as calculated in step 901, are extracted and compared. The rectangular regions are often square, and can be of any suitable size depending on the size of the video frames used, for example, for 800×600 video frames the rectangular regions can be any size between 5 and 101 pixels for height and width. To compare the rectangular regions a similarity measure is used. Many similarity measures are possible, for example, Sum of Absolute Differences (SAD), Sum of Squared Differences (SSD), Cross Correlation (CC), and Normalised Cross Correlation (NCC). In preferred embodiments of the system a NCC similarity measure is used.

Finally, in step 903, the confidence measure for the current estimate of the pose of the mobile device is calculated. This is generally done by applying a statistic to the similarity measures corresponding to each of the Photomap interest points, as calculated in step 902. Preferred embodiments of the system use a mean, but other statistics are possible, for example: a median, an average or weighted average, etc. Similarity measures can also be excluded from the statistics based on a threshold.

FIG. 10 shows a flowchart for a preferred implementation of the pose estimation subsystem. This is an extended description of step 702 in FIG. 7. The pose estimation subsystem starts by collecting a current video frame from the mobile device's forward facing camera 503, step 1000. This current video frame will be used by the vision based pose estimation.

In the following step 1001, a motion sensor based estimate of the pose of the mobile device within the world coordinate system 202 is computed. Motion sensors 504 typically include accelerometers, compasses, and gyroscopes. These motion sensors require sensor-fusion in order to obtain a useful signal and to compensate for each other's sensor limitations. Typically, the sensor-fusion can be performed externally in specialised hardware; it can be performed by the operative system of the mobile device; or it can be performed totally within the pose tracker block. At this point, the output of the motion sensors recorded during the pose tracker initialisation (step 803) is used as a calibration reference. The resulting motion based estimate of the pose is then transformed to the world coordinate system 202.

The pose estimation subsystem can follow two strategies while estimating the pose 203 of the mobile device. One strategy is called global search, the other is called local search. Global search is used when the pose estimation conditions are poor and the certainty of the estimates of the pose is low, which is reflected by a low confidence measure. During global search there is no continuity on the estimates of the pose, meaning that these can change substantially from one estimation to the next. Local search is used when the pose estimation conditions are good and the certainty of the estimates of the pose is high, which is reflected by a high confidence measure. Some embodiments of the system can use these two strategies simultaneously. This can grant the system higher robustness, however, it can also be more computationally expensive. Preferred embodiments of the system use these two strategies in a mutually exclusive fashion controlled by the confidence measure. This decision is implemented in step 1002, checking the last calculated confidence measure. If the confidence measure, as described in FIG. 9, uses a mean of NCC similarity measures, the first threshold is typically set from 0.6 to 0.9.

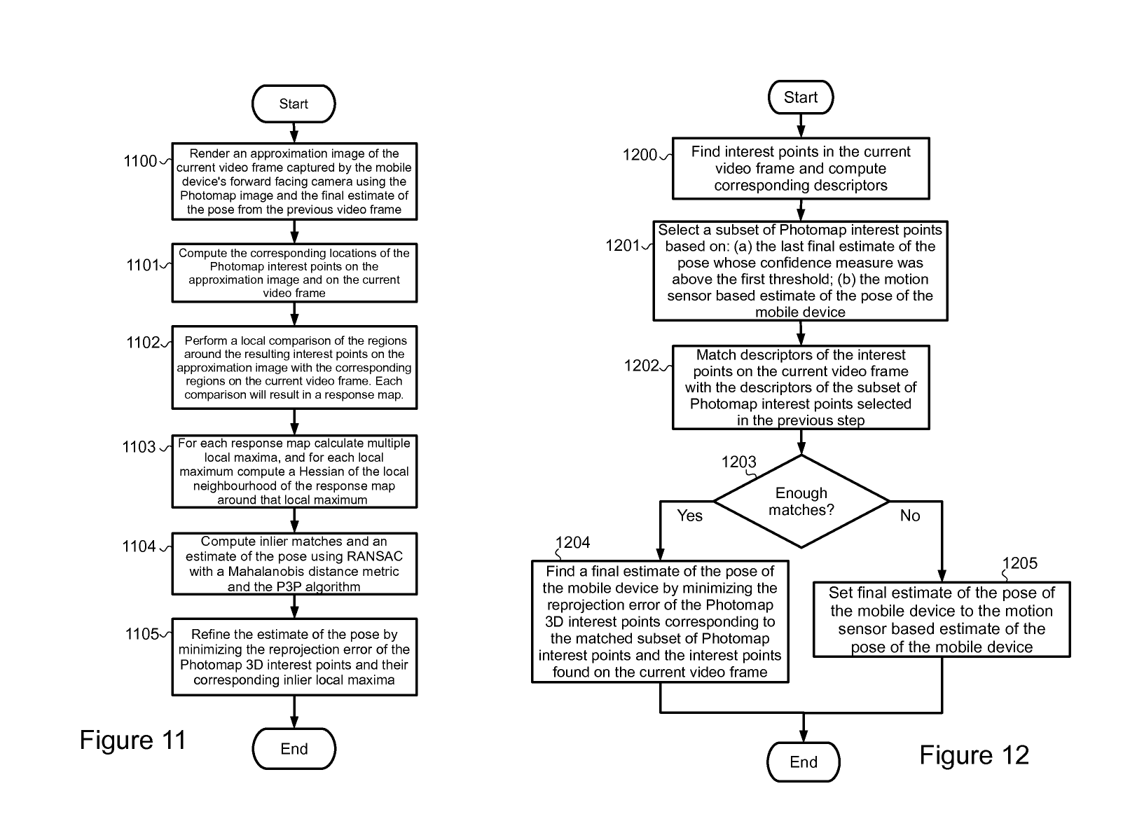

Following a local search strategy path, step 1003 proceeds to compute a vision based estimate of the pose 203 of the mobile device within the defined world coordinate system 202. The vision based posed estimate computation uses the final estimate of the pose calculated for the previous video frame as an initial point for a local search. The local search is performed on the current video frame by using information stored in the Photomap. The computation of the vision based estimate of the pose is fully described subsequently in discussions regarding FIG. 11.

After the vision based estimate of the pose is computed, this estimate is combined with the motion sensor based estimate of the pose to produce a more robust and accurate final estimate of the pose 203 of the mobile device. Embodiments of the system can use different techniques to combine these two estimates of the pose, for example, probabilistic grids, Bayesian networks, Kalman filters, Monte Carlo techniques, and neural networks. In preferred embodiments of the system an Extended Kalman filter is used to combine the vision based estimate of the pose and the motion sensor based estimate of the pose into a final estimate of the pose of the mobile device (step 1005).

Following a global search strategy path, step 1004 proceeds to compute a final estimate of the pose 203 of the mobile device within the defined world coordinate system 202. The global search uses the last final estimate of the pose that was above the first threshold and the motion sensor based estimate of the pose to narrow down where the real pose of the mobile device is. The process finds interest points and corresponding descriptors on the current video frame and tries to match them with a subset of the Photomap interest point descriptors. The computation of the global search estimate of the pose is fully described subsequently in discussions regarding FIG. 12.

Once a final estimate of the pose of the mobile device has been computed, a confidence measure for this final estimate of the pose is computed in step 1006. A detailed description of how to calculate this confidence measure is available in discussions regarding FIG. 9. If the confidence measure is above a first threshold (step 1007), the final estimate of the pose is deemed reliable enough as to be used by the rendering engine block 605. To this purpose, a public estimate of the pose is updated with the final estimate of the pose in step 1008. If the confidence measure is not above the first threshold, the final estimate of the pose is not considered good enough to be used by the rendering engine block 605, however, the final estimate of the pose will still be used in the next iteration of the pose estimation which will involve a global search.

The confidence measure is checked again (step 1009) to determine if the final estimate of the pose is good enough to be used to update the Photomap data 602. If the confidence measure is above a second threshold the Photomap data is updated with the current video frame and the final estimate of the pose of the mobile device, step 1010. The second threshold is typically set between 0.7 and 1. Final estimates of the pose with a confidence measure below the second threshold are considered unreliable for the purpose of updating the Photomap data. Using low confidence estimates of the pose to update the Photomap data would potentially corrupt the Photomap data by introducing large consistency errors. The Photomap data update is fully described subsequently in discussions regarding FIG. 13.

FIG. 11 shows a flowchart for a preferred implementation of the computation of a vision based estimate of the pose of the mobile device following a local search strategy. This is an extended description of step 1003 in FIG. 10. The first two step 1100 and 1101 are equal to steps 900 and 901 in FIG. 9, see discussion about steps 900 and 901 for a detailed description. The first step 1100 involves rendering an approximation image of the current video frame captured by the mobile device's forward facing camera 503 using the Photomap image and the final estimate of the pose from the previous video frame. Step 1101, calculates the corresponding locations of the Photomap interest points on the approximation image and on the current video frame.

Once the corresponding locations of the Photomap interest points on the approximation image and on the current video frame have been calculated, the texture regions around each interest point on the approximation image are compared to texture regions around the corresponding interest point on the current video frame (step 1102). The regions on the approximation image are rectangular and centred on the interest points. These have similar size to those described in step 902. These regions are compared with larger rectangular regions, centred around the interest points, on the current video frame. The size of the rectangular regions on the current video frame can be several times the size of the corresponding region on the approximation image. The larger region size in the current video frame allows the system to match the approximation regions to the current video frame regions even if the video frame has moved with respect to the approximation image. The regions on the approximation image are compared with their corresponding larger regions on the current video frame by applying a similarity measure between the approximation image region and each possible subregion of equal size on the larger region of the current video frame. Many similarity measures are possible, for example, Sum of Absolute Differences (SAD), Sum of Squared Differences (SSD), Cross Correlation (CC), and Normalised Cross Correlation (NCC). In preferred embodiments of the system a NCC similarity measure is used. Each comparison will result in a response map.

Local maxima on each response map correspond to locations on the current video frame that are likely to match the centre of the regions in the approximation image. Step 1103 begins by computing the local maxima for each response map. To find the local maxima on the response map, the response map is first thresholded to contain only values above 0.6. Then, the resulting response map is dilated with a rectangular structuring element the same size as the region in the approximation image. Finally, the dilated response map is compared with the original response map, equal values represent local maxima for that response map. The process is repeated for each response map corresponding to each region in the approximation image. Then, a Hessian of the local neighbourhood on the response maps around each local minima is computed. The eigen values and vectors of the Hessian can provide information about each particular local maxima, indicating whether it was an isolated peak or it occurred along an edge, and if it occurred along an edge, what was the orientation of the edge. The Hessian is calculated over a neighbourhood about half the width and height of the region size used on the approximation image.

The following step 1104 proceeds to estimate the pose of the mobile device using the RANSAC algorithm. The RANSAC algorithm computes the pose associated with random minimal subsets of Photomap 3D interest points and corresponding subsets of local maxima, out of all the local maxima sets calculated in step 1103, until it finds a minimal subset that has the largest support from all the available data. The pose associated with this minimal subset becomes the RANSAC estimate of the pose. A minimal subset in this case involves 3 Photomap 3D interest points and 3 local minima. A candidate estimate of the pose can be calculated from a minimal subset by using the P3P algorithm. To find the support for a candidate estimate of the pose, a distance metric is needed. The distance metric used is a Mahalanobis distance metric. The Mahalanobis metric is used to find a distance measure between a given 2D point on the current video frame and a local minimum point, transformed to the video frame coordinates, according with the Hessian of that local minimum point. Local minima points that are close enough to the projections of the Photomap 3D interest points onto the current video frame, according to the candidate pose, are considered inlier points and increase the support of that candidate pose. The RANSAC algorithm provides an estimate of the pose and finds which minima points constitute inliers and which constitute outliers.

The RANSAC estimate of the pose is just an approximation of the real pose 203 of the mobile device. In step 1105, the estimate of the pose is refined. The refinement involves a non-linear least squares minimization of the reprojection error residuals of the Photomap 3D interest points and their corresponding inlier local minima. The error residuals are computed as the projected distances of a 2D point (reprojections of a Photomap 3D interest point on the video frame for a given pose) with the axes of the ellipse centred at the corresponding inlier local minima and given by the eigen values and eigen vectors of the Hessian of the corresponding inlier local minima. This results into the vision base estimate of the pose 203 of the mobile device.

FIG. 12 shows a flowchart for a preferred implementation of the computation of a final estimate of the pose of the mobile device following a global search strategy. This is an extended description of step 1004 in FIG. 10. A global search strategy is used when the pose estimation conditions are poor and the certainty of the estimates of the pose is low, which is reflected by low confidence measures. During global search there is no continuity on the estimates of the pose, meaning that these can change substantially from one estimation to the next.

The global search begins by finding interest points in the current video frame and computing their corresponding descriptors (step 1200). In a preferred embodiment of the system, a Harris corner detector is used to detect the interest points, and a Speeded Up Robust Features (SURF) descriptor extractor is used on the detected interest points.

Then a subset of the Photomap interest points is selected, step 1201, based on: (a) the last final estimate of the pose whose confidence measure was above the first threshold, and (b) the motion sensor based estimate of the pose. The last final estimate of the pose whose confidence measure was above the first threshold can be used to project (in combination with the camera intrinsics) the rectangle boundary of the image plane onto the plane used to approximate the scene seen by the forward facing camera 503. Then, the inverse of the Photomap mapping is used to compute the region on the Photomap image that corresponds to the image plane at the moment that the last final pose was recorded. This region on the Photomap image is grown 50% to account for the possible change of the pose of the mobile device. The Photomap interest points within the resulting grown region are added to the subset. Following the same procedure but this time using the motion based estimate of the pose, another region on the Photomap image is computed. This region is also grown 50% and the Photomap interest points within it are added to the subset.

Next, in step 1202, the descriptors corresponding to the subset of Photomap image points, computed in step 1201, are compared with the descriptors of the interest points found on the current video frame. If there are enough matches between these two sets, step 1203, the matches between these two sets of descriptors are then used to compute an estimate of the pose 203 of the mobile device. The minimum number of matches needed to compute an estimate of the pose is three. In step 1204, a final estimate of the pose of the mobile is found by minimizing the reprojection error of the Photomap 3D interest points, corresponding to the matched subset of Photomap interest points, and the interest points found on the current video frame. If not enough matches are available, the motion sensor based estimate is used as a final estimate of the pose of the mobile device, step 1205.

FIG. 13 shows a flowchart for a preferred implementation of the update of the Photomap data structure. This is an extended description of step 1010 in FIG. 10. When the final estimate of the pose of the mobile device is good enough (is above the second threshold), this estimate of the pose of the mobile device can be used in conjunction with the current video frame to update the Photomap data structure. The resulting updated Photomap will allow the system to perform estimation of the pose of the mobile device over a larger working volume of the world coordinate system 202.

The first step 1300 of the Photomap update, involves mapping the current video frame to the coordinate space of the Photomap image. In order to achieve this a video frame to Photomap image mapping is defined. This mapping is the inverse of the Photomap image to approximation image mapping described in FIG. 9, step 900, however, it is recalculated again (instead of inverting the previously calculated one) as at this point the new final estimate of the pose of the mobile device is available and this is a better estimate of the pose corresponding to the current video frame.

As in step 900, a homography is defined that takes points on the Photomap image to points on the approximation image (and equivalently the current video frame). This homography can be easily calculated from the Photomap reference camera and the current camera. Remember that the current camera's extrinsic parameters are equal to the current estimate of the pose 203 of the mobile device, and in this case the current estimate of the pose is the final estimate of the pose of the mobile device. As the Photomap image can change in size during a Photomap update, the resulting homography needs to be right multiplied with the inverse of the Photomap offset. The Photomap offset is initially equal to the identity, but every time the Photomap image is updated, this Photomap offset is recalculated. The Photomap offset relates the data in the Photomap image before an update with the data in the Photomap image after the update. A Photomap image to approximation image mapping is then defined as the previously calculated homography right multiplied with the inverse of the Photomap offset.

The inverse of the Photomap image to approximation image mapping is the video frame to Photomap image mapping. However, when applying this mapping, points on the video frame may go to negative point coordinates on the Photomap image. This is not desirable, therefore, the Photomap image needs to be resized and the Photomap offset recalculated. For this purpose the video frame corners are mapped to the Photomap image coordinate space using the calculated video frame to Photomap image mapping. The bounding box of the union of these mapped corners and the corners of the Photomap image is then computed. Then, a new offset matrix is calculated to offset the possible negative corners of the bounding box to the (0, 0) coordinate. This new offset matrix can be used to warp the Photomap image into another, larger, Photomap image of equal size to the calculated bounding box. This warp is performed leaving the result in an offsetted Photomap image. The Photomap offset is then updated as being itself left multiplied with the new offset matrix. The video frame to Photomap image mapping is then recalculated using the updated Photomap offset. The resulting mapping can be used to take points from the video frame coordinate space to points on positive coordinates of the offsetted Photomap image coordinate space. The video frame to Photomap image mapping is then used to warp the video frame data into a temporary image.

Next, the overlapping and non-overlapping region sizes of the temporary image with the offsetted Photomap image need to be calculated in order to assess whether an update of the Photomap is appropriate, step 1301. The overlapping region of the temporary image with the offsetted Photomap image can be calculated as the intersection of used pixels on the temporary image with the used pixels on the offsetted Photomap image. The non-overlapping region of the temporary image with the offsetted Photomap image can be calculated as the intersection of the used pixels on the temporary image with the unused pixels on the offsetted Photomap image. The region sizes are calculated by counting the pixels inside each region. Alternative implementations can calculate these region sizes in different ways, for example: the two polygons defined by the Photomap image corners and the video frame corners mapped to the Photomap image coordinate space can be first calculated; then the area of the intersection of these two polygons can be calculated resulting in the overlapping region size; finally, the area of the polygon defined by the video frame corners mapped to the Photomap image coordinate space minus the area of the overlapping region size will correspond to the non-overlapping region size.

When the ratio of the non-overlapping to overlapping region sizes is above a predetermined value the Photomap update can take place, step 1302. In preferred implementations the predetermined value is 1, but alternative implementations can use a predetermined value ranging from 0.1 to 10.

If the Photomap update takes place, step 1303 is executed. This step involves aligning the temporary image with the offsetted Photomap image. When the current camera pose is near the reference camera pose the temporary image data and the offsetted Photomap image will be reasonably well aligned. However, as the current camera pose separates further from the reference camera (both in position and rotation), the alignment between the temporary image and the offsetted Photomap image will become increasingly poor. This alignment is improved by an extra alignment step. Starting from the initial alignment of the temporary image with the offsetted Photomap image, an extra alignment step takes place to align the temporary image to the offsetted Photomap image. The extra alignment step can be optional, as the initial alignment can be good enough by itself to allow embodiments of the system to operate within a reasonable working volume. However, an extra alignment step can expand this working volume. When the extra alignment step is used, multiple implementations are possible, for example, using optical flow image alignment algorithms, such as the inverse compositional algorithm, or alternatively extracting a number of interest points and corresponding descriptors from the two images, matching them, computing a homography between the matches and warping the temporary image into the offsetted Photomap image. Preferred implementations of the system use the second example method. Alternative embodiments of the system can perform the entire alignment step in multiple other ways. For example, each time a new region on the current video frame is considered to add sufficient new information to the Photomap image, the video frame can be stored together with the current camera. This will result in a collection of video frames and corresponding cameras. Each time a new video frame and corresponding camera is added to the collection, an alignment of all the video frames in the collection can be computed using bundle adjustment, resulting in an updated Photomap image. This method can produce better aligned mosaics, but the computational cost is higher, especially as the collection of video frames and cameras grows.

At this point the non-overlaping regions of the temporary image and offsetted Photomap image are aligned like a mosaic. Image mosaicing typically performs a blending step at this point, to correct for average pixel intensity changes and vignetting effects between the various pieces of the mosaic. This step is also optional for the purpose of visual tracking. If this blending step is performed it can improve visual tracking performance. On the other hand, in preferred embodiments of the system, the Normalised Cross-Correlation (NCC) similarity feature and the Speed Up Robust Features (SURF) descriptors are used in local and global searches respectively. Both NCC and SURF are partially resistant to lighting condition changes and can cope with small lighting effects on the various pieces of the mosaic, making a blending step unnecessary.

Finally, the non-overlaping regions of the temporary image and offsetted Photomap image are copied on to the offsetted Photomap image, and the Photomap image is updated with the offsetted Photomap image.

The next step 1304, involves extracting new interest points and corresponding descriptors from the non-overlaping regions of the temporary image and offsetted Photomap image. The interest points are extracted keeping a minimum distance from the seam of the two regions. Preferred implementations use a minimum distance equal to the size of the regions described in step 902. Interest points are found on the selected region using a Harris corner detector, and their corresponding descriptors are extracted using a SURF descriptor extractor. The newly detected interest points are already in the coordinate system of the updated Photomap image, but the current Photomap interest points are in the older Photomap coordinate system. At this point, the current Photomap interest points are transformed to the updated Photomap image coordinate system by applying to them the new offset matrix calculated in step 1300. Both the newly detected interest points and transformed Photomap interest points become the updated Photomap interest points. The newly extracted interest point descriptors are added to the Photomap interest point descriptors. Older Photomap interest point descriptors do not need to be altered because of the update to the Photomap image.

The final step in the Photomap update involves calculating the 3D interest points corresponding to each of the newly detected interest points, and adding them to the Photomap 3D interest points, step 1305. This can be easily achieved by applying the Photomap mapping, right multiplied with the inverse of the Photomap offset, to each of the newly detected interest points. Notice that all the 3D interest points will have a Z axis equal to zero. The resulting 3D interest points are then added to the Photomap 3D interest points. Existing Photomap 3D interest points do not need any updates.

### 4.1 Save Location, Orientation and Contents of a Virtual Surface

Some embodiments of the system can save the location, orientation and contents of a virtual surface for later retrieval and use. At retrieval time, these embodiments of the system can be placed in a search mode which is continuously searching the video coming from the forward facing camera 503. When the embodiment of the system finds that a video frame coming from the forward facing camera 503 corresponds to the location of a previously saved virtual surface, the saved virtual surface is restored and becomes the current virtual surface. From that point onwards, the user of the embodiment of the system can operate the restored virtual surface, move it to a new location, change it and save it again under the same or other identifier.

The restoring of a virtual surface involves estimating the pose 203 of the mobile device and updating the Photomap with the estimated pose and the current video frame. After this point, the identifier of the found virtual surface is reported to the rendering engine, and the rendering engine will display the contents associated with that virtual surface identifier.

Embodiments of the system that support saving the location and orientation of a virtual surface can add two extra data objects to the Photomap data structure. These two data objects are:
Global search points
Global search descriptors

The global search points are similar to the previously described Photomap interest points, but the global search points are only used for pose estimation using a global search strategy and not for a local search strategy. Global search descriptors will replace the previously described Photomap interest point descriptors. Both global search points and global search descriptors are computed on video frames, as opposed to the Photomap interest points and Photomap interest point descriptors which are computed on the Photomap image.

A range of interest point detectors and descriptor pairs can be used to compute the global search points and global search descriptors. Some examples of suitable interest point detectors and descriptors include, Scale-invariant feature transform (SIFT) detectors, Speeded Up Robust Features (SURF) detectors, and Features from Accelerated Segment Test (FAST) detectors, Binary Robust Independent Elementary Features (BRIEF) detectors, Oriented FAST and Rotated BRIEF (ORB) detectors, etc. Preferred embodiments of the system use both a SURF interest point detector for the global search points, and SURF descriptors for the global search descriptors.

Embodiments of the system that support saving the location and orientation of a virtual surface will have a slightly different implementation of the computation of a final estimate of the pose of the mobile device following a global search strategy than the one described in FIG. 12; and will have a slightly different implementation of the update of the Photomap data structure than the one described in FIG. 13.

FIG. 13B shows a flowchart for an alternative implementation of the update of the Photomap data structure. This is an extended description of step 1010 in FIG. 10. Part of the flowchart is the same as the flowchart shown in FIG. 13. In particular, step 1310 is the same as step 1300; step 1311 is the same as step 1301; step 1311 is the same as step 1301; step 1312 is the same as step 1302; step 1313 is the same as step 1303; and finally step 1319 is the same as step 1305. Steps 1314 to 1318 involve the global search points and global search descriptors. This alternative implementation of the update of the Photomap data structure can also be used by embodiments of the system that do not support saving the location and orientation of the virtual surface.

Step 1314 is similar to step 1304, but step 1314 only extracts interest points and no descriptors are computed. Step 1315 computes the region on the current video frame that corresponds to the previously computed non-overlapping regions on the offsetted Photomap image. To compute this region, the Photomap image to approximation image mapping is used. This mapping is the inverse of the video frame to Photomap image mapping computed in step 1310. The resulting region on the current video frame will be referred to as the update mask.

Step 1316 extracts the global search points and computes their corresponding global search descriptors from the area in the current video frame that is within the update mask. Preferred embodiments of the system use both a SURF interest point detector for the global search points, and SURF descriptors for the global search descriptors.

Step 1317 transforms the extracted global search points from the current frame coordinate system in to the Photomap image coordinate space. The video frame to Photomap image mapping computed in step 1310 can be used for this transformation. However, this transformation does not need to include the Photomap offset as the global search points are independent of the Photomap image. Nonetheless, the transformed global search points will be associated with the Photomap reference camera, and can be used at a later time to estimate the pose 203 of the mobile device.

Step 1318 adds the transformed global search points and the global search descriptors to the Photomap global search points and Photomap global search descriptors.

FIG. 13C shows a flowchart of an alternative implementation of the computation of a final estimate of the pose of the mobile device following a global search strategy. This is an extended description of step 1004 in FIG. 10. Part of the flowchart is the same as the flowchart shown in FIG. 12. This alternative implementation of the computation of a final estimate of the pose of the mobile device following a global search strategy can also be used by embodiments of the system that do not support saving the location and orientation of the virtual surface.

Step 1320, involves finding global search points on the current video frame and computing their corresponding global search descriptors. Preferred embodiments of the system use both a SURF interest point detector for the global search points, and SURF descriptors for the global search descriptors. Step 1321 matches the computed global search descriptors with the Photomap global search descriptors. If the number of matches is enough, step 1322, the final estimate of the pose of the mobile device is computed. Depending on the desired speed/quality trade off, the number of matches considered enough can go from tens of matches to hundreds of matches.

Step 1323, proceeds to compute an homography between the global search points on the current video frame, corresponding to the global search descriptors matches, and the Photomap global search points, corresponding to the Photomap global search descriptors. This homography can then be used to compute the final estimate of the pose of the mobile device, step 1324. A method to compute the final estimate of the pose of the mobile device involves the computed homography, the Photomap reference camera and the Faugeras method of homography decomposition. An alternative method to compute the final estimate of the pose of the mobile device from the computed homography is to create a number of fictitious 2D and 3D point pairs in the Photomap reference camera coordinate system. Then transform the fictitious 2D points with the previously computed homography, and use a minimization approach on the reprojection error between the fictitious 3D points and the transformed fictitious 2D points.

If the are not enough matches, the final estimate of the pose of the mobile device is set to the motion sensor based estimate of the pose of the mobile device, step 1325. This step is the same as step 1205 in FIG. 12.

When a user of an embodiment of the system indicates that he wants to save the location and orientation of a virtual surface, the system saves the current Photomap global search points and the current Photomap global search descriptors to the global search database. This information is saved together with an identifier of the virtual surface, that is provided by the user of the system through a GUI. The contents mapped to the virtual surface are also saved, in their current state, to an assets database using the virtual surface identifier as a retrieval key. The virtual surface identifier will be used at a later time to retrieve the location, orientation and contents of the saved virtual surface. FIG. 13D shows the saving of the virtual surface. Step 1330 involves saving the current Photomap global search points and the current Photomap global search descriptors to the global search database. Step 1331, involves saving the contents mapped to the virtual surface, in their current state, to an assets database using the virtual surface identifier as a retrieval key.

Embodiments of the system that support saving the location and orientation of a virtual surface can be placed in a search mode, that continuously check whether the current video frame corresponds to a part of a previously saved virtual surface. Once a video frame is identified as corresponding to a part of a saved virtual surface, a new world coordinate system 202 is defined, and the user of the embodiment can start operating the saved virtual surface. The user of the embodiment will be able to place the system in search mode through a GUI. FIG. 13E shows a flowchart of an implementation of the search mode.

The first step 1340 involves collecting a current video frame from the mobile device's forward facing camera. The next step 1341 searches for saved virtual surfaces on the current video frame. A detailed description of this search is available in the discussion of FIG. 13F. If a saved virtual surface is found, step 1342, the identifier of the found virtual surface is reported to the rendering engine, step 1343, which will retrieve the contents associated with that virtual surface identifier from the assets database, and will render these contents on the virtual surface. After this point, the system can proceed to the main loop of the pose tracker block FIG. 7, entering the loop at step 703. If no virtual surface is found, the system checks whether the user wants to finish the search mode, step 1344, before continuing with the search mode loop.

FIG. 13F, shows a flowchart of an implementation of the search for saved virtual surfaces on the current video frame. This is an extended description of step 1341 in FIG. 13E. The first step 1350 involves finding global search points on the current video frame and computing corresponding global search descriptors. This step is the same as step 1320 in FIG. 13C. The computed global search descriptors are then matched with descriptors on the global search database, step 1351. The matching can be performed in multiple ways. For example, the matching can occur sequentially between the computed global search descriptors and each of the descriptor sets associated with a virtual surface identifier on the global search database. Other matching approaches using treelike data structures can be more efficient when the number of descriptors sets (each one associated with a different virtual surface identifier) on the global search databased is large. If the number of matches between the computed global search descriptors and one of the descriptor sets associated with a given virtual surface identifier is above a threshold, step 1352, a saved virtual surface has been found. If not enough matches are found, the search mode proceeds to search the next video frame. When a saved virtual surface has been found, an homography can be calculated between the global search points on the current video frame, corresponding to the matched global search descriptors, and the global search points, corresponding to the matched global search descriptors on the global search database, step 1353. The final estimate of the pose of the mobile device can be computed from the computed homography, step 1354, by following the instructions in step 1324 in FIG. 13C.

Finally, in step 1355, the public estimate of the pose of the mobile device is updated with the final estimate of the pose of the mobile device, and the Photomap data structure is updated by using the algorithm described in FIG. 13B.

### 5. Rendering Engine

The rendering engine block 605 is responsible for collecting the visual output of applications 606 running on the mobile device and mapping it to the virtual surface 604. A virtual surface can be thought of as a virtual projection screen to which visual contents can be mapped. Element 201 in FIG. 2A represents a virtual surface in context with the mobile device 100 and the user of the interaction system 200. The rendering engine 605 is also responsible for creating a perspective view of the virtual surface onto the mobile device's display 101 according with the public estimate of the pose 203 of the mobile device. Finally, the rendering engine 605 is also responsible for collecting user input, from keypad 512, related to the current perspective view rendered on the mobile device's display 101 and translating that input into the corresponding input 607 for the running applications 601 whose visual output has been mapped to the virtual surface.

The virtual surface 604 is an object central to the rendering engine. From a user perspective, a virtual surface can be thought of as a virtual projection screen to which visual contents can be mapped. Element 201 in FIG. 2A represents a virtual surface in context with the mobile device 100 and the user of the interaction system 200. From an implementation perspective, a virtual surface 604 is a 2D surface located within the world coordinate system 202, where texture can be mapped, the texture being the visual output of applications running on the mobile device. Preferred embodiments of the system use as a surface for texture mapping a simple rectangle object, embedded in the world coordinate system 202 at a fixed location, typically the origin. The virtual surface, that is the rectangle object, will have a predetermined size, location and orientation within the world coordinate system 202. This size, location and orientation is stored in the configuration of the system, and the user can change them as desired. Other embodiments of the system can use different shaped surfaces as a virtual surface. For example, a number of connected rectangles, a half cylinder, a spherical segment, or a generic triangulated mesh. Other embodiments of the system can use multiple virtual surfaces, in which case each surface can be used to map the visual output of an individual application running on the mobile device.

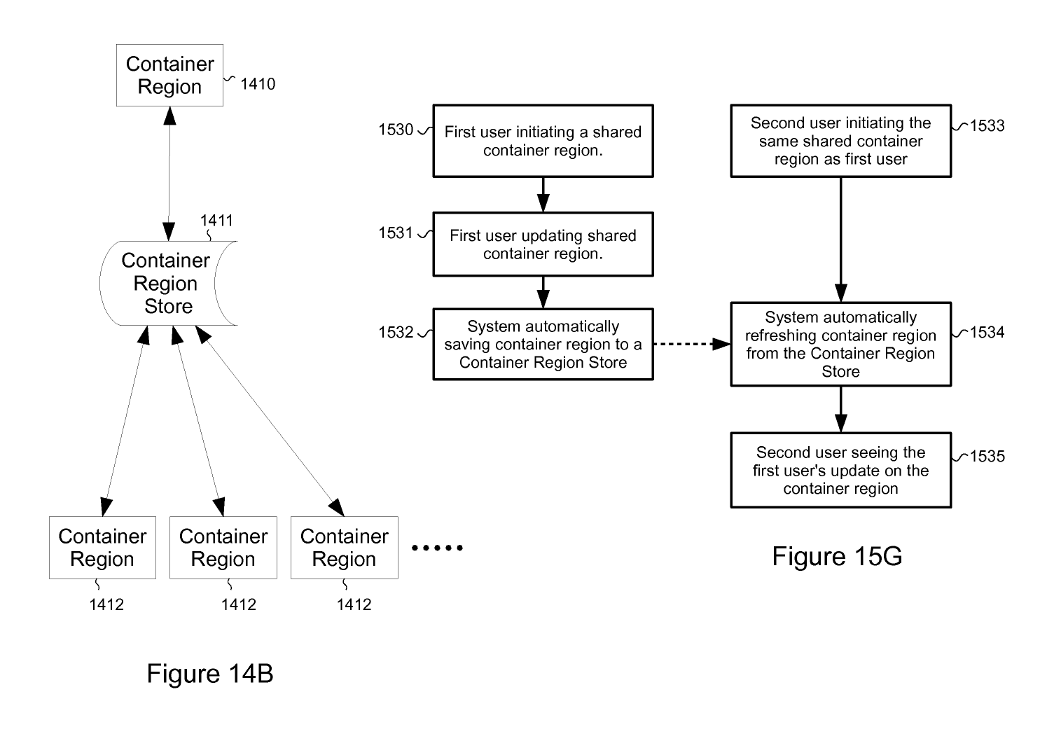

FIG. 14 shows a flowchart for a preferred implementation of the rendering engine block. This is an extended description of the rendering engine block 605 in FIG. 6. In preferred embodiments of the system, the pose tracker block 603 and the rendering engine block 605 will run simultaneously on separate processors, processor cores, or processing threads, in order to decouple the processing latencies of each block. Notice the rendering engine implementation involves a main loop that continues indefinitely until the user wants to finish the interaction session, step 1406.

The first step in the rendering engine main loop involves collecting a public estimate of the pose of the mobile device, step 1400. This public estimate of the pose of the mobile device is made available by the pose tracker, step 703, and is equal to the final estimate of the pose of the mobile device when the confidence measure is above a first threshold, step 1008.

The following step in the main loop involves capturing the visual output of one or more applications running on the mobile device, step 1401. Embodiments of the system can implement the capture of the visual output of an application in multiple ways, for example: in X windows systems a X11 forwarding of the application's display can be used, then the rendering engine will read the contents of the forwarded display; other systems can use the equivalent of a remote desktop server, for example using the Remote Frame Buffer (RFB) protocol, or the Remote Desktop Protocol (RDP), then the rendering engine will read and interpret the remote desktop data stream. Preferred embodiments of the system will capture the visual output of one single application at any given time. Notice that the operative system (OS) visual output can be captured as if it was just another running application, in this case the choice of which application's visual output is captured is made by using the corresponding OS actions to give focus to the chosen application. Other embodiments of the system can capture the visual output of one or more applications simultaneously. Each one of these visual outputs can be mapped to a different virtual surface.

Alternative embodiments of the system in which the concept of applications running on the mobile device is substituted by a single software instance combined with the interaction system, may not have a visual output that could be observed outside the interaction system. In these embodiments, the visual output of the single software instance can be designed to fit a certain virtual surface. In this case, the step for mapping the visual output of the single software instance can be embedded on the software instance itself rather that being a part of the interaction system.

Depending on the aspect ratio of the visual output of an application and the aspect ratio of the virtual surface, the visual output may look overstretched once mapped to the virtual surface. To avoid this the rendering engine needs to ask the OS to resize the application to a different aspect ratio before capturing the visual output. This resize can be easily done in X windows systems, and RDP servers. Alternatively, the virtual surface aspect ratio can be adjusted to match that of the target application's visual output.

The next step in the rendering engine main loop involves mapping the captured visual output onto one or more virtual surfaces, step 1402. Preferred embodiments of the system use a single rectangular virtual surface. Assuming that the visual output captured in step 1401 has rectangular shape, which is generally the case, and the virtual surface is rectangular, the mapping between visual output and virtual surface is a rectangle to rectangle mapping, which can be represented by an homography. This homography can be used to warp the visual output to the virtual surface. In general, the visual output becomes a texture that needs to be mapped to a generic surface. For example, if the surface is a triangulated mesh, then a UV map will be needed between the corners of the triangles in the mesh and the corresponding points within the texture (visual output). Embodiments of the system with multiple virtual surfaces will need to repeat the mapping process for each virtual surface and its corresponding application visual output.

Next, the visual output mapped on the one or more virtual surfaces is perspective projected on the mobile device's display, step 1403. Perspective projection is a common operation in computer graphics. This operation uses as inputs the poses, geometries, and textures mapped on the one or more virtual surfaces, and the pose of the viewport (the mobile device's display) within the world coordinate system 202. The pose of the mobile device's display is assumed to be the same a the public estimate of the pose 203 of the mobile device, collected in step 1400. The output of the perspective projection is a perspective view of the contents mapped on the virtual surface from the mobile device's point of view within the world coordinate system 202.

The following step 1404 involves overlaying extra information layers on the mobile device's display. These information layers involve any other information presented on the mobile device's display that is not the perspective projection of the one or more virtual surfaces. Examples of information layers can be: on-screen keyboards, navigation controls, feedback about the relative position of the virtual surfaces, feedback about the pose estimation subsystem, quality of tracking, a snapshot view of the Photomap image, etc.

Finally, in step 1405, the user input related to the perspective view of the virtual surface projected onto the mobile device's display is collected and translated into the appropriate input to the corresponding application running on the mobile device. This involves translating points through 3 coordinate frames, namely, from the mobile device's display coordinates to virtual surface coordinates, and from these onto the application's visual output coordinates. For example, using a single virtual surface, if the user of taps on the mobile device's touchscreen at position (xd, yd), this point is collected and the following actions occur:
The point (xd, yd) is projected onto a corresponding point (xv, yv) on the virtual surface. The corresponding point (xv, yv) will depend on the original (xd, yd) point, the pose of the virtual surface and the public estimate of the pose 203 of the mobile device within the world coordinate system 202.
The point (xv, yv) on the virtual surface is mapped to the corresponding point (xa, ya) on the local coordinate system of the visual output of the application that has been mapped to that virtual surface.
Finally, the point (xa, ya) is passed to the application that has been mapped to that virtual surface. The application reacts as if the user had just tapped on the point (xa, ya) of its visual output coordinate system.

The points translated to the application visual output coordinate system are typically passed to the corresponding application using the same channel used to capture the application's visual output, for example, through a X11 forwarding, or a through RFB or RDP protocols.

### 5.1 Hold and Continue Mode

Some embodiments of the system can implement a tracking suspension and freezing of the current pose of the virtual surface by enabling a hold and continue mode. An example implementation of this mode involves suspending the estimation of the pose of the mobile device while holding the rendering of the virtual surface in the same pose it had before the suspension (hold). During hold mode, the user of the embodiment can move to a new location. When the user is ready to continue the interaction with the embodiment of the system, then he can indicate to the system to continue (continue). At this point the system will reinitialise the tracking block on the new location and compose the hold pose of the virtual surface with the default pose of the virtual surface after a reinitialisation. This creates the illusion of having dragged and dropped the whole virtual surface to a new location and orientation.

According to this example implementation, a pose of the virtual surface is introduced in order to separate the public estimate of the pose of the mobile device from the displayed pose of the virtual surface. An Euclidean transformation is also introduced to connect the pose of the virtual surface with the public estimate of the pose of the mobile device. This transformation will be referred to as ‘virtual surface to public estimate pose transform’.

Initially, the virtual surface to public estimate pose transform is set to identity rotation and zero translation. This means that the pose of the virtual surface is the same as the public estimate of the pose of the mobile device. During estimation of the pose of the mobile device, the pose of the virtual surface is updated with the public estimate of the pose of the mobile device composed with the virtual surface to public estimate pose transform. This update will result in the pose of the virtual surface being equal to the public estimate of the pose of the mobile device until the first time the user activates the hold and continue mode, at which point, the virtual surface to public estimate pose transform can change. This update can occur at step 1008 in FIG. 10.

Assuming that the visual output captured in step 1401 on FIG. 14. has a rectangular shape, the rendering engine can render on the mobile device's display the captured visual output according to the previously defined pose of the virtual surface. To do this, a 3D rectangle corresponding to the captured visual output is defined in the world coordinate system 202. This 3D rectangle can be placed centred at the origin and aligned with the X and Y world coordinate system 202 axes. The size of this rectangle will determine the size of the rendered captured visual output on the mobile device's display. The 3D visual output rectangle is projected on to a virtual surface plane, using the pose of the virtual surface and, for example, the intrinsic parameters of the current camera. This results in a rectangle on the virtual surface plane. Then, the rendering engine calculates an homography between the rectangular region of the captured visual output and the rectangle on the virtual surface plane. This homography can be used to warp the captured visual output to the virtual surface plane, the result can be shown on the mobile device's display. This rendering operation can be performed in place of the steps 1402 and 1403 on FIG. 14.

When a user of the embodiment of the system activates the hold state, the pose estimation is suspended, but the rendering engine can continue displaying the virtual surface according to the last pose of the virtual surface. When the user of the embodiment activates the continue state, the tracking block is reinitialised. This results in a new world coordinate system 202, a new Photomap data structure, and a new public estimate of the pose of the mobile device. This reinitialisation of the tracking block does not affect the pose of the virtual surface, or the virtual surface to public estimate pose transform. However, the public estimate of the pose of the mobile device will have probably changed, so the virtual surface to public estimate pose transform will have to be updated. The virtual surface to public estimate pose transform is updated by composing the inverse of the new public estimate of the pose of the mobile device with the pose of the virtual surface.

Updating the pose of the virtual surface, at the above suggested step 1008 in FIG. 10, with the new virtual surface to public estimate pose transform will result in a pose of the virtual surface that when used to render the captured visual output on the mobile device's display, will produce an output that looks the same as it did before the user activated the hold state. However, the world coordinate system 202 and the public estimate of the pose of the mobile device will be different.

Following this implementation, each time the user of the embodiment of the system performs a hold and continue action, the virtual surface to public estimate pose transform will represent the difference between the pose of the virtual surface (which will determine what is seen on the mobile device's display) and the current world coordinate system.

### 5.2 Container Regions

Some embodiments of the system can group the contents mapped to the virtual surface into container regions. The individual items placed within a container region will be referred to as content items. FIG. 4C shows an example rectangular container region 410 with a number of content items 412, 413 that have been placed inside. The use of container regions can enable the user to treat all the content items within the region as a single unit, allowing them to be moved, archived or deleted together. The management of a container region, and of the individual content items within the region, will generally involve a separate application running on the mobile device. This container region management application will generally perform the tasks associated with step 1401 and step 1405 in the flowchart shown in FIG. 14.

Some embodiments of the system can automatically save any changes to a selection of, or the entirety of, the current contents mapped on a virtual surface. Automatically saving the contents means that if a user alters the contents of the virtual surface in any way, the new contents and arrangement will be immediately saved. This automatic saving of the contents can be used to synchronize multiple shared virtual surfaces so that they all have the same contents. If the contents mapped to the virtual surface originate from one or more applications running on the mobile device, each of these applications will include an interface to save and load their state. If the contents mapped to the virtual surface are within a container region, the application managing the container region can perform the saving and loading of its state.

FIG. 14B shows a block diagram of an architecture where embodiments of the system can share content items inside a container region. The container regions 1410 and 1412 are shared and have the same content items in them. At one given point, a user of the embodiment of the system using the container region 1410 can update said container region, for example by adding a new content item. This update can trigger the embodiment of the system to automatically save the container region content items into a container region store 1411. Then, all the embodiments of the system that use a container region 1412 based on the container region 1410 stored in the container region store 1411, can be automatically refreshed with the new content item initially added to the container region 1410.

The container region store 1411 can be implemented using various technologies, for example, a shared file system on a cloud based storage system, or a database back-end system. Resolution of conflicting updates can be performed by the underlying file system or database.

### 6. Other Alternative Embodiments

A family of less preferred embodiments of the system can be implemented by removing two of the main blocks from the previously described block diagram in FIG. 6. These blocks are the virtual surface 604 and rendering engine 605. FIG. 17 shows the modified block diagram for a family of less preferred embodiments of the system. In these embodiments of the system, the part corresponding to estimating the pose 203 of the mobile device remains the same, but the pose estimate is converted, block 1701, into navigation control signals that can be directly used by the applications running on the mobile device. For example, if the target application is a web browser, the translation component of the estimate of the pose 203 of the mobile device can be converted into the appropriate horizontal scroll, vertical scroll, and zoom control signals that directly drive the web browser navigation. In another example, if the target application is a map browser, the translation components of the estimate of the pose 203 of the mobile device can again be converted into the appropriate horizontal scroll, vertical scroll, and zoom control signals, and the rotation components of the estimate of the pose 203 of the mobile device can be converted into pitch, yaw and roll control signals that directly drive the orientation of the map.

The user of the embodiments of the system described in this section, still needs to define the origin and direction of the world coordinate system 202 during an initialisation stage that involves the user aiming the mobile device towards the desired direction, then indicating to the system to use this direction. Also, the user needs to be able to reset this world coordinate system 202 during the interaction. The pose estimation and conversion manager block 1700 is in charge of collecting user input that will then be passed to the pose tracker block 603 to define or reset the world coordinate system 202.

The embodiments of the system described in this section, require a simpler implementation than the previously described embodiments, but they also lack the level of visual feedback on the pose 203 of the mobile device available to users of more preferred embodiments of the system. The user can move the mobile device to the left, right, up, down, forward and backward and see how this results in navigation actions on the target application, that is: horizontal scroll, vertical scroll, zoom in and zoom out; the same applies to rotations if the target application can handle this type of input. Thus, there exists a level of visual feedback between the current pose 203 of the mobile device and what is displayed on the mobile device's display 101, but this feedback is more detached than in more preferred embodiments of the system that use the virtual surface concept. This difference in visual feedback requires extra considerations, these include:
1. handling a proportional or differential conversion of the pose 203 of the mobile device into the corresponding navigation control signals. The proportional conversion can be absolute or relative.
2. handling the range of the converted navigation control signals with respect to the pose 203 of the mobile device.
3. handling the ratio of change between the pose 203 of the mobile device and its corresponding converted navigation control signals

In a proportional conversion of the pose 203 of the mobile device into the corresponding navigation control signals, the converted control signals change with the pose 203 of the mobile device in a proportional manner. Two variations of the proportional conversion are possible: absolute proportional, and relative proportional. To illustrate this, let's just focus on the X axis component of the translation part of the pose 203 of the mobile device, this will be referred to as tx component of the pose 203. In an absolute proportional conversion, if values of the tx component of the pose 203 of the mobile device are converted into a horizontal scroll control signal, a value K in the tx component of the pose will be converted into a value αK of the horizontal scroll control signal, with α being the ratio of change between the tx component of the pose and the horizontal scroll control signal. With a relative proportional conversion, a change of value D in the tx component of the pose will be converted into a change of value αD of the horizontal scroll control signal, with a being the ratio of change between the tx component of the pose and the horizontal scroll control signal.

In a differential conversion of the pose 203 of the mobile device, the resulting converted navigation control signals change according to the difference between the pose 203 of the mobile device and a reference. For example, let's assume that the tx component of the pose 203 of the mobile device is converted into the horizontal scroll control signal of a web browser, and that the reference for the differential conversion is the origin of the world coordinate system 202. After the user defines the origin of the world coordinate system 202, the tx component of the pose 203 of the mobile device will be zero. Assuming that the X axis of the defined world coordinate system is parallel to the horizontal of the user, if the user moves the mobile device towards the right, the tx component of the pose will increase, and so will the difference with the reference (the origin in this case). This difference is then used to control the rate of increase of the horizontal scroll control signal.

In differential conversion, the rate of change can be on/off, stepped, or continuous. Following the previous example, an on/off rate means that when the difference between the tx component of the pose and the reference is positive, the horizontal scroll control signal will increase at a predetermined rate. If the difference between the tx component of the pose and the reference is zero the horizontal scroll control signal will not change. If the difference between the tx component of the pose and the reference is negative, the horizontal scroll control signal will decrease at a predetermined rate. A more useful approach is to use a stepped rate of change depending on the value of the difference between pose and reference. Following the previous example, the difference between the tx component of the pose 203 and the reference can be divided into, for example, 5 intervals:
smaller than −10—fast decrease in the horizontal scroll value
between −10 and −5—slow decrease in the horizontal scroll value
between −5 and +5—no change in the horizontal scroll value
between +5 and +10—slow increase in the horizontal scroll value
larger than +10—fast increase in the horizontal scroll value

If the number of step intervals increases the rate of change becomes continuous. In this case, following the previous example, a positive difference between the tx component of the pose and the reference will result in a positive rate of change of the horizontal scroll control signal proportional to that positive difference. Equally, a negative difference between the tx component of the pose and the reference will result in a negative rate of change of the horizontal scroll control signal proportional to that negative difference.

Approaches for handling the range of the converted navigation control signals with respect to the pose 203 of the mobile device include saturation of the control signal. Saturation of the control signal means that the converted control signal will follow the pose 203 of the mobile device until the converted signal reaches its maximum or minimum, then it will remain fixed until the pose 203 of the mobile device returns to values within the range. To illustrate this, let's consider a web browser whose horizontal scroll control signal can vary from 0 to 100, this range will depend on the particular webpage presented. Let's assume an absolute proportional conversion and a steady increase of the tx component of the pose 203 of the mobile device. This increase in the tx component of the pose can be converted into an increase of the horizontal scroll control signal of the web browser. Let's assume the ratio of change between the tx component of the pose and the horizontal scroll is 1. When the horizontal scroll reaches the end of the web page, at a value of 100, the horizontal scroll will remain fixed at value 100 even if the tx component of the pose continues to increase. When the value of the tx component of the pose decreases below 100, the horizontal scroll will start to decrease accordingly. If the tx component of the pose then decreases below 0, the horizontal scroll will remain fixed at value 0, until the tx component of the pose again goes above the value 0. The same reasoning can be applied to the vertical scroll, zoom control, and to the pitch, yaw and roll if the target application supports these type of inputs.

Alternatively, if the conversion of the control signals follows a relative proportional approach, the converted control signals can follow the direction of change of the corresponding component of the pose 203 of the mobile device independently of the actual value of that component. To illustrate this, let's continue with the previous example. As the tx component of the pose 203 of the mobile device increases over value 100, the horizontal scroll control signal value will remain fixed at 100. However, in contrast with the absolute proportional conversion case, now the horizontal scroll control signal value can begin decreasing as soon as the tx component of the pose begins decreasing. This behaviour can result in an accumulated misalignment between the converted control signals and the pose 203 of the mobile device. A way of handling this accumulated misalignment is to include a feature to temporarily stop the conversion of the pose 203 of the mobile device into corresponding control signals, for example, by holding down a key press on a keypad or a touch click on a touchscreen. Meanwhile, the user can move the mobile device to a more comfortable pose. Then, releasing the key press or touch click can allow the navigation to continue from that more comfortable pose.

The ratio of change between the pose 203 of the mobile device and the converted control signals, can be handled using either a predetermined fixed ratio, or a computed ratio based on the desired range of the pose 203 of the mobile device. A predetermined fixed ratio means that when a given component of the pose changes and amount D, the corresponding translated control signal will change by an amount αD, with a being a predetermined ratio of change. Alternatively, this ratio of change can be computed by setting a correspondence between a given range of the pose 203 of the mobile device with a corresponding range of the converted control signals. To illustrate this, let's consider again the web browser example. Let's assume that the horizontal scroll control signal range varies on average from 0 to 100, and that the user defined a world coordinate system 202 with a X axis that is parallel to the users horizontal. Then, the user can move the mobile device towards the left as much as is comfortable and indicate to the system that this tx component of the pose 203 of the mobile device corresponds to the converted horizontal scroll control signal value 0. Then the user can repeat the operation this time moving the mobile device towards the right as much as is comfortable and indicating to the system that this tx component of the pose 203 of the mobile device corresponds to the converted horizontal scroll control signal value of 100. The system can then calculate the ratio of change between the tx component of the pose 203 of the mobile device and the converted horizontal scroll control signal so that the indicated limits are respected.

In FIG. 17, the pose estimation and conversion manager, block 1700, and pose estimate converter, block 1701, implement the above described extra considerations for embodiments of the system described in this section.

In embodiments of the system, where the handling of the conversion of the navigation control signals with respect the pose 203 of the mobile device is differential, the estimation of the pose 203 of the mobile device can be simplified considerably. In these embodiments of the system, the estimation of the pose 203 of the mobile device can be limited to a range within which the differential signal is calculated. For example, as described in examples above, let's assume that the conversion between the tx component of the pose 203 of the mobile device and the horizontal scroll control signal is differential and uses 5 step intervals, the differential signal being between the tx component of the pose 203 and the origin of the world coordinate system 202, and the intervals being:
smaller than −10—fast decrease in the horizontal scroll value
between −10 and −5—slow decrease in the horizontal scroll value
between −5 and +5—no change in the horizontal scroll value
between +5 and +10—slow increase in the horizontal scroll value
larger than +10—fast increase in the horizontal scroll value

In this case, the estimation of the tx component of the pose 203 of the mobile device does not need to extend much further than the range −10 to +10 to be operational. The same applies to each of the components of the pose 203 of the mobile device. As a result, a number of simpler pose estimation methods can be used. The only requirement now is that they can estimate the pose 203 of the mobile device within a much smaller working volume. Furthermore, depending on the target applications, not all the parameters of the pose 203 of the mobile device need to be estimated. For example, a web browser only needs 3 parameters, i.e. horizontal scroll, vertical scroll, and zoom control signals to perform navigation, therefore, in this case, the estimation of the pose 203 of the mobile device only needs to consider 3 parameters of the pose. These 3 parameters can either be the translation or rotation components of the pose. However, in most vision based pose estimation methods, estimating only 3 parameters will result in an ambiguity between the estimation of the translation and the rotation components of the pose 203 of the mobile device. This means that the 3 converted control signals will come from a combination of both the translation and the rotation components of the pose 203 of the mobile device.

Depending on the particular way of handling the conversion of the pose 203 of the mobile device into corresponding control signals, a number of simpler pose estimation methods (both vision based and motion sensor based) can be used to implement a number of less preferred embodiments of the system that operate on smaller working spaces. For example, if the target application only requires horizontal scroll, vertical scroll and zoom control signals, and these control signals result from the conversion of the translation part of the pose 203 of the mobile device, the pose estimation methods that can be used include:
For a relative proportional conversion of control signals, optical flow tracking methods can provide a change of direction signal for the translation part of the pose 203 of the mobile device. Another approach based on motion sensors would be to use a 3 axis accelerometer.
For a differential translation of control signals, patch tracking methods can be used. Patch tracking can be based on a similarity measure such as Sum of Absolute Differences (SAD), Sum of Squared Differences (SSD), Cross Correlation (CC), and Normalised Cross Correlation (NCC). This 3 axis pose estimation can also be based on: colour histogram tracking, tracking of salient features such as Harris corner features, Scale-invariant feature transform (SIFT) features, Speeded Up Robust Features (SURF) features, or Features from Accelerated Segment Test (FAST) features, or tracking of contours using Snakes, Active Contours Models (ACM), or Active Appearance Models (AAM).

### 7. Alternative Exemplary Architecture

FIG. 5 shows a block diagram of an exemplary architecture of the mobile device 100 in which embodiments of the system can be implemented. The architecture has a minimum computational capability sufficient to manage the pose estimation of the mobile device, and simultaneously running of an AR or VR game. The computational capability is generally provided by one or more control units 501, which comprise: one or more processors 507 (these can be single core or multicore); firmware 508; memory 509; and other sub-systems hardware 510; all interconnected through a bus 500. In some embodiments, in addition to the control units 501, part of or all of the computational capability can be provided by any combination of: application specific integrated circuits (ASICs), digital signal processors (DSPs), programmable logic devices (PLDs), field programmable gate arrays (FPGAs), graphic processing units (GPUs), micro-controllers, electronic devices, or other electronic units capable of providing the required computational resources. In embodiments where the system is implemented in firmware and/or software, the functions of the system may be stored as a set of instructions on a form of computer-readable media. By way of example, and not limitation, such computer readable media can comprise RAM, ROM, Flash Memory, EEPROM, CD-ROM or other optical disk storage, magnetic storage, or other magnetic storage devices. Combinations of the above should also be included within the scope of computer-readable media. In FIG. 5 the blocks corresponding to firmware 508 or memory 509 generally represent the computer-readable media needed to store either the firmware or software implementation of the system. The block hardware 510 generally represents any hardware sub-systems needed for the operation of the mobile device, for example, bus controllers, coprocessors or graphic processing units.

Generally, the architecture has a user interface 502, which will minimally include a display 101 to visualise contents and a keypad 512 to input commands; and optionally include a microphone 513 to input voice commands; and a speaker 514 to output audio feedback. The keypad 512 can be a be a physical keypad, a touchscreen, a joystick, a trackball, or other means of user input attached or not attached to the mobile device.

Normally, embodiments of the system will use a display 101 embedded on the mobile device 100. However, other embodiments of the system can use displays that are not connected to the mobile device, for example: a computer display can be used to display what would normally be displayed on the embedded display; a projector can be used to project on a wall what would normally be displayed on the embedded display; or a Head Mounted Display (HMD) can be used to display what would normally be displayed on the embedded display. In these cases, the contents rendered on the alternative displays would still be controlled by the pose 203 of the mobile device and the keypad 512.

In order to estimate the pose 203 of the mobile device, the architecture uses a forward facing camera 503, that is the camera on the opposite side of the mobile device's display, and motion sensors 504, these can include accelerometers, compasses, or gyroscopes. In embodiments of the system enabling AR mode, the forward facing camera 503 is required, to be able to map the scene, while the motion sensors 504 optional. In embodiments of the system enabling VR mode, a forward facing camera 503 is optional, but at least one of the forward facing camera 503 or the motion sensors 504 are required, to be able to estimate the pose 203 of the mobile device.

The mobile device's architecture can optionally include a communications interface 505 and satellite positioning system 506. The communications interface can generally include any wired or wireless transceiver. The communications interface includes any electronic units enabling the mobile device to communicate externally to exchange data. For example, the communications interface can enable the mobile device to communicate with: cellular networks, WiFi networks; Bluetooth and infrared transceivers; USB, Firewire, Ethernet, or other local or wide area networks transceivers. In embodiments of the system enabling VR games, the communications interface 505 is required to download scenes to game play. The satellite positioning system can include for example the GPS constellation of satellites, Galileo, GLONASS, or any other suitable territorial or national satellite positioning system.

### 8. Alternative Exemplary Implementation

Embodiments of the system can be implemented in various forms. Generally, a firmware and/or software implementation can be followed, although hardware based implementations are also considered, for example, implementations based on application specific integrated circuits (ASICs), digital signal processors (DSPs), programmable logic devices (PLDs), field programmable gate arrays (FPGAs), graphic processing units (GPUs), micro-controllers, electronic devices, or other electronic units capable of providing the required computational resources for the system operation.

FIG. 19 is a block diagram for a preferred embodiment of the system, showing the interrelation between the various parts of the system: the AR system 1900, the Game Engine 1901, the Game Logic 1905, the operating system 1906, the user interface 101, 512, and the sensor hardware 503, 504. Generally, a mobile device will store its software components 608 on some form of computer-readable media, as previously defined in the exemplary architecture. The software components include an implementation of the AR system 1900, a Game Engine 1901, a Game Logic 1905, and typically, an operative system (OS) 1906.

The AR system 1900 comprises the Game Pose Tracker block 1903, the Photomap 602 and the Platform Manager block 1904.

The Game Pose Tracker block 1903 is responsible for the definition of the world coordinate system 202 and the computation of estimates of the pose 203 of the mobile device within the defined world coordinate system 202. To estimate the pose 203 of the mobile device and map the scene to be used as playground for the AR game, the Game Pose Tracker 1903 requires a forward facing camera 503. Images captured by the forward facing camera 503 are sequentially processed in order to find a relative change in pose between them, due to the mobile device changing its pose. This is called vision based pose estimation. Optionally, the pose 203 of the mobile device, can also be estimated using motion sensors 504, typically accelerometers, compasses, and gyroscopes. These motion sensors require sensor-fusion in order to obtain a useful signal and to compensate for each other's sensor limitations. The sensor-fusion can be performed externally in specialised hardware; it can be performed by the operative system of the mobile device; or it can be performed totally within the Game Pose Tracker block 1903. The estimation of the pose 203 of the mobile device using motion sensors is called motion sensor based pose estimation.

In preferred embodiments of the system, both motion sensors 504 and forward facing camera 503 will be used to estimate the pose 203 of the mobile device. In this case two estimates of the pose will be available, one from processing the data coming from the motion sensors, and another from processing the images captured by the forward facing camera 503. These two estimates of the pose are then combined into a more robust and accurate estimate of the pose 203 of the mobile device.

Typically, vision based pose estimation systems that do not depend on specific markers implement Simultaneous Localisation And Mapping (SLAM). This means that as the pose of a camera is being estimated, the surroundings of the camera are being mapped, which in turn enables further estimation of the pose of the camera. Embodiments of the system enabling AR mode use vision based SLAM, which involves estimating the pose 203 of the mobile device and storing mapping information. In a preferred embodiment of the system this mapping information is stored in a data structure named Photomap 602. The Photomap data structure 602, also referred in this description as simply Photomap, stores mapping information that enables the Game Pose Tracker block 1903 to estimate the pose 203 of the mobile device within a certain working volume. The Photomap data structure 602 includes the Photomap image which corresponds to the texture mapped on the expanding plane 204.

Other means for estimating the pose 203 of the mobile device are possible and have been considered. For example:
Other types of vision based pose estimation different from vision based SLAM, for example: optical flow based pose estimation or marker based pose estimation.
If a backward facing camera is available on the mobile device, the system can track the users face, or other target in the users body, and estimate the pose of the mobile device relative to that target;
Sensors, such as optical sensors, magnetic field sensors, or electromagnetic wave sensors, can be arranged around the area where the mobile device is going to be used, then, a visual or electromagnetic reference can be attached to the mobile device. This arrangement can be used as an external means to estimate the pose of the mobile device, then, the estimates of the pose, or effective equivalents, can be sent back to the mobile device. Motion capture technologies are an example of this category;
Generally, a subsystem containing any combination of sensors on the mobile device that measure the location of optical, magnetic or electromagnetic references, present in the surroundings of the user or on the same users body, can use this information to estimate the pose of the mobile device with respect to these references;

Embodiments of the system using any of the above means for estimating the pose 203 of the mobile device, if capable of AR mode, still need a forward facing camera 503 to be able to capture a map of the scene.

Some embodiments of the system can use multiple Photomaps 602. Each Photomap can store mapping information for a specific scene, thus enabling the Game Pose Tracker block 1903 to estimate the pose of the mobile device within a certain working volume. Each Photomap can have a different world coordinate system associated with it. These world coordinate system can be connected to each other, or they can be independent of each other. A management subsystem can be responsible for switching from one Photomap to another depending on sensor data. In these embodiments of the system, an AR game can include the scenes corresponding to multiple Photomaps 602.

Another part of the AR system 1900 is the Platform Manager 1904. One of the functions of the Platform Manager is to analyse the map of the scene, which captures the playground for the AR game, identify image features that can correspond to candidate platforms, and apply one or more game rules to select the candidate platforms. The map of the scene is stored in the Photomap image. This image is typically rotated to align its y axis with the vertical direction in the scene before undertaking any image processing operations. The analysis of the map of the scene can occur in two ways:
a one-shot-analysis of the entire map, typically after the scene of the playground for the AR game has been mapped in its entirety.
a continuous mode where platforms are dynamically identified at the same time the scene is being mapped, and the game is being played. Platforms in this continuous mode are dynamically identified both according to one or more game rules and a consistency constrain with previously identified platforms on the same scene.

Another function of the Platform Manager 1904 is to select which platforms are visible and from what view point according to the current pose 203 of the mobile device. The Platform Manager then hands these platforms to the Game Engine 1901 performing any necessary coordinate system transformations. This function can be alternatively outsourced to the Game Engine 1901.

The Game Engine block 1901 provides generic infrastructure for game playing, including 2D or 3D graphics, physics engine, collision detection, sound, animation, networking, streaming, memory management, threading, and location support. The Game Engine block 1901 will typically be a third party software system such as Unity, SunBurn, Source, Box2D, Cocos2D, etc, or a specifically made system for the same purpose. The Platform Manager 1904 provides the Game Engine block 1901 with the visible platforms for the current pose 203 of the mobile device. These platforms will generally be line segments or rectangles. The physics engine component of the Game Engine can simulate the necessary gravity and motion dynamics so that game characters can stand on top of the provided platforms, walk on them, collide against walls, etc.

The Game Logic block 1905 handles the higher level logic for the specific game objectives. Typically, this block can exist as a separate entity from the Game Engine block 1901, but on some embodiments of the system the game logic can be integrated within the Game Engine block 1901.

Finally, the mobile device can include an Operative System (OS) 1906 that provides the software running on the mobile device 100 with access to the various hardware resources, including the user interface 502, the forward facing camera 503, the motion sensors 504, the communications interface, and the satellite positioning system 506. In specific embodiments of the system, the OS can be substituted by a hardware or firmware implementation of basic services that allow software to boot and perform basic actions on the mobile device's hardware. Examples of this type of implementation include the Basic Input/Output System (BIOS) used in personal computers, OpenBoot, or the Unified Extensible Firmware Interface (UEFI).

### 9. Game Pose Tracker Block

The Game Pose Tracker block 1903 is responsible for the definition of the world coordinate system 202 and the computation of estimates of the pose 203 of the mobile device within the defined world coordinate system. This Game Pose Tracker block 1903 is essentially equivalent to the Pose Tracker block 603, however, the higher level control flow of these two Pose Tracker blocks differ, hence, this section describes the differences between both blocks.

FIG. 21 shows a flowchart for the general operation of a preferred implementation of the Game Pose Tracker block. This is an extended description of the Pose Tracker block 1903 in FIG. 19. This flowchart is essentially equivalent to flowchart in FIG. 7, however, the higher level control flow differs. The operation begins when the user decides to start an AR game session on a particular scene. In the first step 2100, the system asks the user to position himself and aim the mobile device towards a desired scene. When the user is ready to continue, he indicates this through a user interface. The position and direction of the mobile device at this point will determine the origin and direction of the world coordinate system 202 and the pose 203 of the mobile device within this world coordinate system. The world coordinate system 202 and the pose 203 of the mobile device within this world coordinate system are defined in the pose tracking initialisation step 2101. Next, the system enters into a main loop where the pose 203 of the mobile device is estimated 2102. Finally, in step 2103, the resulting estimate of the pose, here referred to as public estimate of the pose, is reported to the Game Engine 1901. This main loop continues indefinitely until the game session is over 2105.

In some embodiments of the system, steps 2100 and 2101 in FIG. 21, can be optionally executed. When they are not executed, the operation begins directly at the pose estimation step 2102. This means that the user of the embodiment does not have to define a world coordinate system to begin playing the AR or VR game. In these embodiments, the system can either use a world coordinate system that is implicit in the pose tracking algorithms, or a world coordinate system that has previously been defined and saved, then loaded when the AR or VR game starts. Saving and loading the Photomap data structure 602 makes it possible to save and load world coordinate system definitions as well as entire maps of previously mapped scenes.

To approximate the scene captured by the forward facing camera 503, preferred embodiments of the system use an expanding plane 204, located at the origin of the world coordinate system. In these embodiments, the Photomap image can be thought of as a patch of texture anchored on this plane. A plane approximation of the scene is accurate enough for the system to be operated within a certain working volume. In the rest of this description, it will be assumed that the model used to approximate the scene seen by the forward facing camera 503 is an expanding plane 204 located at the origin of the world coordinate system 202.

The remaining aspects of the Game Pose Tracker block 1903 are equivalent to the Pose Tracker block 603.

### 10. Platform Manager

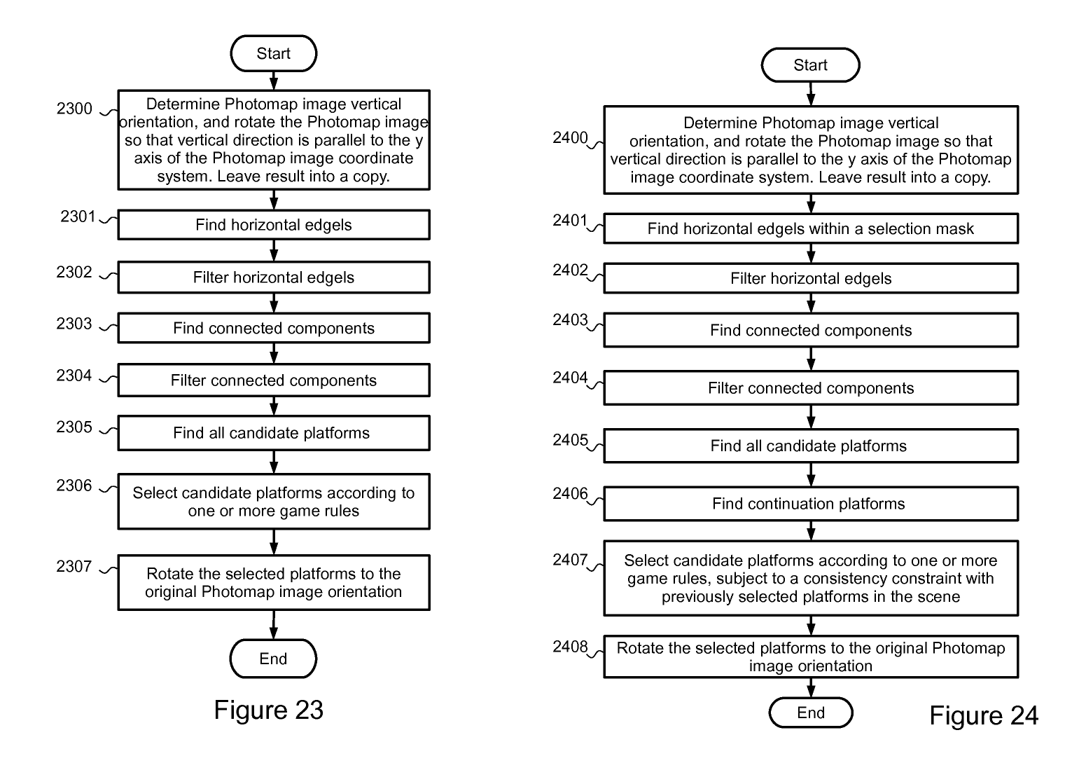

The Platform Manager block 1904 is responsible for identifying platforms on the mapped scene used as a playground for an AR game, and then selecting these platforms according to one or more game rules. In some embodiments of the system, platforms are identified and selected once the scene used as a playground for a AR game has been completely mapped, then the AR game can begin. An implementation of this approach is shown in FIG. 23. Other embodiments of the system are capable of a continuous mode operation, that allows the system to dynamically identify and select platforms for the AR game at the same time the scene is being mapped and the game is being played. Platforms in this continuous mode are dynamically identified and selected both according to one or more game rules and a consistency constraint with previously identified platforms on the same scene. An implementation of this approach is shown in FIG. 24.

In some embodiments of the system, while playing the AR game, the Platform Manager can also provide the currently visible platforms to the Game Engine 1901 handling the necessary coordinate system transformations. In other embodiments of the system, the Platform Manager block 1904 will send all the selected platforms to the Game Engine 1901 only once and the Game Engine will handle all the required platform visibility operations and coordinate system transformations. In some embodiments of the system, the Platform Manager block 1904 can deal with other objects identified in the scene, for example, walls, ramps, special objects, etc in the same way as it does with platforms.

FIG. 23 shows a flowchart for a preferred implementation of the platform identification and selection based on a mapped scene for the game. The mapped scene for the game is stored in the Photomap image. The first step 2300 involves determining the vertical orientation of the Photomap image and rotating the Photomap image so that the vertical direction is parallel to the y axis of the Photomap image coordinate system. This operation is required to facilitate subsequent image processing operations. In some embodiments of the system, the vertical direction can be set by the user of the system at the moment of mapping of the scene. This can be done by asking the user to map the scene in a vertical orientation, or asking the user to point out the vertical orientation after the mapping has been completed. Alternatively, other embodiments of the system can determine this vertical orientation automatically by using motion sensors 504 such as gyroscopes. The Photomap image is rotated into a copy image where all the following image processing operations take place.

The next step 2301, involves finding the horizontal edgels in the rotated Photomap image copy. An edgel is an edge pixel. To find the horizontal edgels, a vertical gradient of the rotated Photomap image copy is computed using a first order sobel filter. Then the found edgels are filtered, step 2302, by first thresholding their values and then applying a number of morphological operations on the edgels above the threshold. If the Photomap image stores pixels as unsigned integers of 8 bits (U8) a threshold value between 30 and 150 is typically suitable. The morphological operations involve a number of iterations of horizontal opening. These iterations of horizontal opening filter out horizontal edges that are smaller than the number of iterations. For an input video resolution of 480×640 (W×H), a number between 4 and 20 iterations is typically sufficient.

The following step 2303 involves finding the connected components of the edgels that remained after the filtering step 2302. The resulting connected components are themselves filtered based on their size, step 2304. For an input video resolution of 480×640 (W×H), a connected component size threshold between 25 and 100 pixels is typically sufficient.

The following step 2305 finds all the candidate platforms on the Photomap image. The candidate platforms are found by considering the edgels, after the filtering step 2302, that fall within each of the resulting connected components, after the filtering in step 2304. These edgels form groups, each group will correspond to a candidate platform. A line is fit to each of the edgel groups, and the line is segmented to fall within the corresponding connected component. Each of the resulting line segments is considered a candidate platform.

Step 2306 involves selecting a number of platforms, out of all the candidate platforms, according to one or more game rules. The game rules depend on the particular objectives of the AR game, and multiple rules are possible. Some examples are:
for a game where the average distance between platforms is related to the difficulty of the game, horizontal platforms can be selected based on selecting the largest platform within a certain distance window. With this rule, if the distance window is small, the selected platforms can be nearer to each other, and if the distance window is larger, the selected platforms will be farther apart from each other (increasing the difficulty of the game).
for other games where as well as detecting horizontal platforms, vertical edges are detected as walls, a game rule can be used to maintain a certain ratio between the number of selected walls and the number of selected horizontal platforms. Alternatively, a game rule can select platforms and walls in such a way that it guarantees a path between key game sites.
for other games where an objective is to get from one point of the map to another as soon as possible, a game rule can select walls and horizontal platforms with a certain spread so as to make travelling of the characters to a certain location more or less difficult.

The first of the suggested game rules can be easily implemented by iterating over each of the candidate platforms, looking at the platforms that fall within a certain distance of the current candidate platform (this involves computing the distance between the corresponding line segments) and selecting the platform that is the largest (longest line segment). FIG. 22A, FIG. 22B, FIG. 22C, and FIG. 22D depict the candidate platform identification and platform selection according to the distance window game rule. FIG. 22A depicts a map of a scene (Photomap image) where an AR platform game can be played. The scene corresponds to a kitchen scene, where the straight lines of the objects, cupboards and furniture constitute good candidates for platforms. The map is then processed to identify all candidate platforms, FIG. 22B. The candidate platforms are then selected according to the distance window game rule. In FIG. 22C this is done using a distance window of 20 pixels, and in FIG. 22D using a distance window of 40 pixels.

Finally, in step 2307, the selected platforms are rotated to match the original orientation of the Photomap image before the rotation at step 2300. The rotated selected platforms become the list of selected platforms in the scene.

The selected platforms are then passed to a game engine (possibly involving a physics engine) that can interpret them as platforms which characters in the AR game can stand on top, walk over and interact with.

Other embodiments of the system are capable of a continuous mode operation, that allows the system to dynamically identify and select platforms for the AR game at the same time the scene is being mapped and the game is being played. Platforms in this continuous mode are dynamically identified and selected both according to one or more game rules and a consistency constrain with previously identified platforms on the same scene. In these embodiments of the system, the user first defines a world coordinate system by aiming the mobile device's forward facing camera towards the scene to be used as playground for the AR game. Then, the current view of the scene is mapped, and platforms within that view are identified and selected. At this point the AR game will begin and the game's avatar will appear standing on one of the platforms within the current view. As the user moves the game's avatar within the current view of the scene, and the avatar gets nearer to the borders of the current view, the user aims the mobile device in the direction the avatar is heading, to centre the avatar on the current view. This action results in mapping a new region of the scene and identifying and selecting new platforms for that new region. Theoretically, the playground for the AR game can be extended indefinitely by following this procedure.

In preferred implementations of the continuous mode of operation, the identification and selection of platforms takes place once after every update of the Photomap. FIG. 24 shows a flowchart for a preferred implementation of the continuous mode of platform identification and selection. The first step 2400, is the same as step 2300, and involves rotating the Photomap image so that the vertical direction is parallel to the y axis of the Photomap image coordinate system. The result is left into a copy.

The next step 2401, similar to step 2301, involves finding the horizontal edgels on the Photomap image copy, but this time the operation is constrained by a selection mask. The selection mask is the region on the Photomap image that corresponds to the new region on the current video frame for which platforms need to be calculated. In preferred implementations, the continuous mode identification and selection process occurs once after every update of the Photomap. Therefore, the non-overlaping regions calculated in step 1301 of the Photomap update, FIG. 13, can be used as selection mask in step 2401. The selection mask is rotated to match the Photomap image copy.

Steps 2402, 2403, 2404 and 2405 are essentially the same as steps 2302, 2303, 2304, and 2305, but the former steps occur within the masked region of the Photomap image copy.

Step 2406 involves finding continuation platforms. A continuation platform is a platform that continues a platform previously selected in the scene. For a candidate platform P to continue a previously selected platform P′, the line segment representing the candidate platform P has to be a prolongation (within some predetermined tolerance) of the line segment representing the previously selected platform P′. A platform can then be continued multiple times, over multiple updates of the Photomap image. Then, in step 2406 all the candidate platforms that are continuations of previously selected platforms on the scene, are selected.

In step 2407, the remaining candidate platforms, that are not continuation platforms, are selected according to one or more game rules, subject to a consistency constraint with previously selected platforms in the scene. This step is similar to step 2306 in terms of the application of one or more game rules to all the candidate platforms in order to select some of them. However, there is one important difference: previously selected platforms in the scene cannot be removed even if a game rule indicates they should be; similarly, previously rejected candidate platforms cannot be selected even if a game rule indicates they should be. Nonetheless, previously selected platforms and previously rejected platforms must be considered within the game rule computation. For example, for a game rule that selects the largest platform within a distance window, assume that a new candidate platform P, within the new region of the scene for which platforms are being computed, is the largest platform within a distance window. According to the game rule this new candidate platform P should be selected. However, if a smaller platform P′, within the distance window, was selected in a previous run of the continuous mode platform identification and selection, then, the new candidate platform P will have to be rejected to keep consistency with the previously selected platforms in the scene. Similar reasoning can be applied for other game rules.

The final step 2408 of the continuous mode platform identification and selection process involves rotating the newly selected platforms to match the original orientation of the Photomap image before the rotation step 2400. The rotated selected platforms are then added to the list of selected platforms in the scene.

Platforms are identified and selected in the Photomap image coordinate space, but while playing the AR game, the visible platforms have to be interpreted in the current view coordinate space, which is connected with the pose 203 of the mobile device. In some embodiments of the system, this conversion will be performed by the Platform Manager block 1904. In other embodiments of the system, the Platform Manager block 1904 will send all the selected platforms to the Game Engine 1901 only once, (or as they become available in continuous mode) and the Game Engine will handle all the required platform visibility operations and coordinate system transformations.

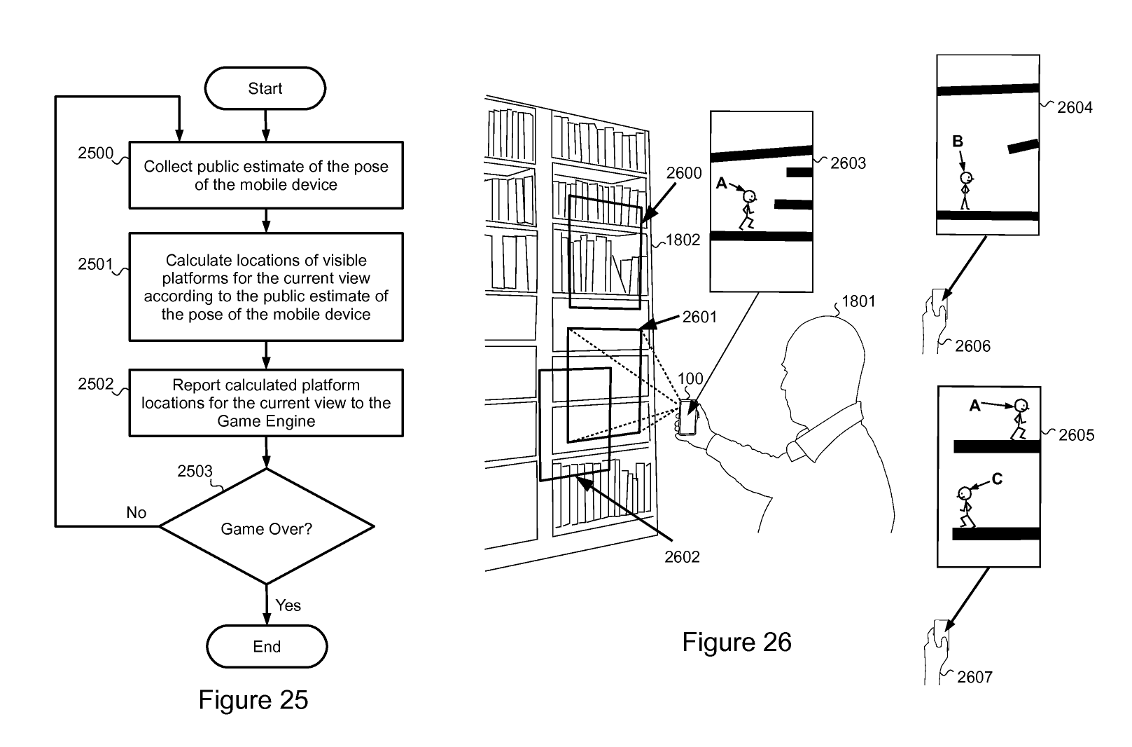

FIG. 25 shows a flowchart for a preferred implementation of the calculation of visible platforms for the current view. The calculation of visible platforms for the current view can run continuously for the duration of the game, step 2503. The first step 2500 involves collecting the public estimate of the pose 203 of the mobile device. The pose 203 of the mobile device will determine what area of the mapped scene is being viewed on the mobile device's display 101. Step 2501 involves calculating the locations of the visible platforms for the current view of the scene. The visible platforms are the platforms in the Photomap image coordinate space that fall within the region corresponding to the current video frame. To determine this region, a current video frame to Photomap image mapping is defined. This mapping was described in step 1300 of the Photomap update flowchart FIG. 13. The region in the Photomap image corresponding to the current video frame is calculated by applying the “current video frame to Photomap image mapping” to the rectangle defined by the border of the current video frame. The platforms that fall within this region are the platforms that will be visible in the current view. These platforms are selected and their coordinates transformed into the current video frame coordinate frame by applying to them the inverse of the current video frame to Photomap image mapping. Finally, in step 2502 the calculated platform locations are reported to the Game Engine 1901.

### 11. Virtual Reality Mode

In some embodiments of the system, the mapped scene, together with the identified and selected platforms, can be stored locally or shared online for other users to play on that scene in a Virtual Reality (VR) mode. In VR mode, the user loads a scene from a computer readable media or from and online server, and plays the game on that loaded scene.

As in the AR mode case, the user begins using the system by defining a local world coordinate system 202 by aiming the mobile device in a desired direction and indicating to the system to use this direction. Then, the world coordinate system of the loaded scene is interpreted as being the local world coordinate system. Finally, the loaded scene, together with platforms and other game objects, is presented to the user in the local world coordinate system 202. In VR mode, the system estimates the pose of the mobile device within a local world coordinate system 202 by, for example, tracking and mapping the input video of a local scene as seen by the mobile device's forward facing camera 503, while presenting to the user, in the same local world coordinate system, the loaded scene with its corresponding platforms and other game objects (all of which were originally defined in a remote world coordinate system).

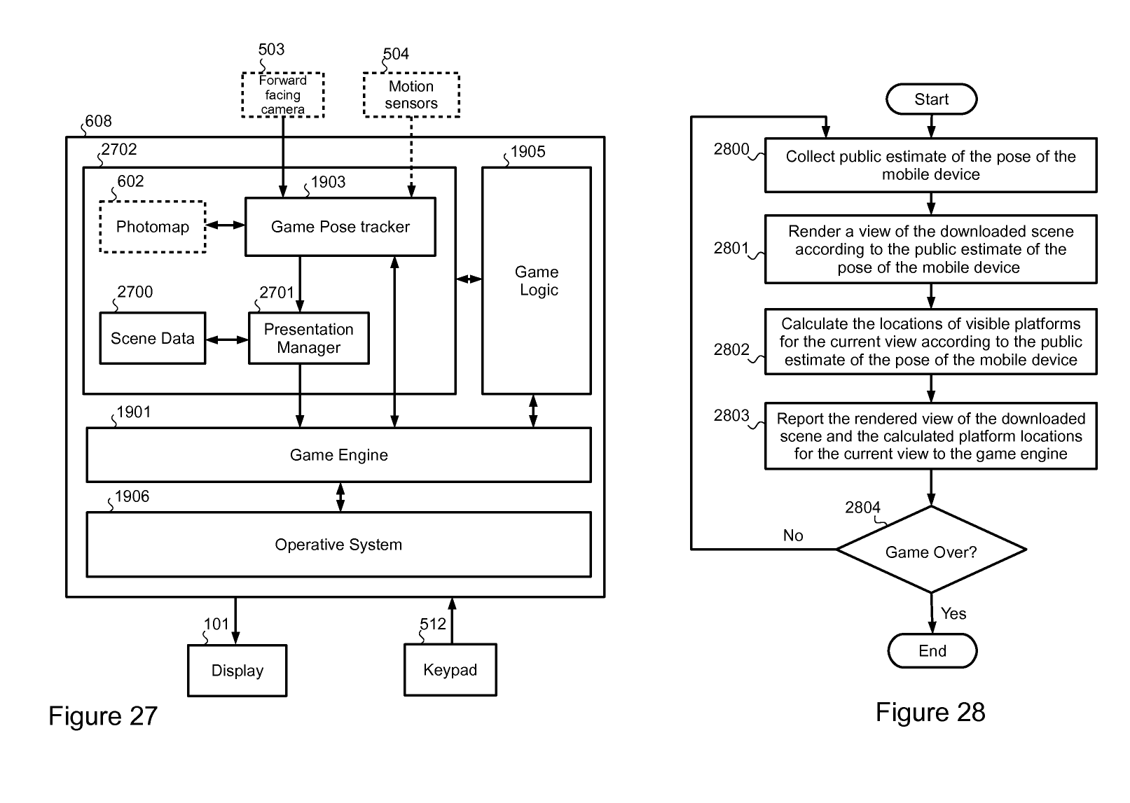

FIG. 27 is a block diagram of a preferred embodiment of the system operating in VR mode, showing the interrelation between the various parts of the system, the user interface, and the sensor hardware. This block diagram is similar to the block diagram for AR mode, FIG. 19, but with a few differences.

A first difference involves the optionality of the forward facing camera 503 and the Photomap data structure 602. In AR mode a local scene has to be mapped, therefore a forward facing camera 503 is necessary for the mapping, but in VR mode the scene is downloaded, therefore in VR mode the forward facing camera 503 is optional. The forward facing camera 503 can still be used in VR mode to perform vision based pose estimation, but motion based pose estimation can be used in isolation. If motion based pose estimation is to be used in isolation, the Photomap data structure 602 is not required.

A second difference involves the substitution of the AR system 1900 by a VR system 2702. The VR system 2702 is essentially the same as the AR system 1900 but the Platform Manager 1904 is replaced by a downloaded Scene Data 2700 and a Presentation Manager 2701. The downloaded Scene Data 2700 includes: a scene image, platforms and other game objects downloaded to play a VR game on them. The Presentation Manager 2701 is responsible for supplying the Game Engine 1901 with the visible part of the downloaded scene, visible platforms, and other visible game objects, for the current estimate of the pose 203 of the mobile device.

FIG. 28 shows a flowchart for a preferred implementation of the presentation of a downloaded scene including the calculation of visible platforms for the current view. This is an extended description of the Presentation Manager block 2701. The presentation of the downloaded scene involves a loop, that continues for the duration of the game 2804. During this loop the current view and the visible platforms in the current view are calculated from the downloaded Scene Data 2700.

The first step in the loop, 2800, involves collecting a public estimate of the pose 203 of the mobile device. Next, in step 2801, the public estimate of the pose 203 of the mobile device is used to render a view of the downloaded scene. This step is very similar to step 900 in FIG. 9. In step 900 an approximation image of the current video frame is rendered from data in the Photomap image and the current estimate of the pose 203 of the mobile device. In step 2801 the Photomap image is replaced by the scene image part of the downloaded Scene Data 2700, and the current estimate of the pose of the mobile device is replaced by the public estimate of the pose of the mobile device. The update overlap ratio is not relevant in 2801 as the scene is already mapped (downloaded) and no updates of the Photomap are necessary.

The following step, 2802, involves calculating the location of visible platforms for the current view according to the public estimate of the pose 203 of the mobile device. This step is similar to step 2501 in FIG. 25, but replaces the current video frame with the current view, and the Photomap image with the scene image. The visible platforms, in step 2802, are the platforms that fall within the region in the scene image corresponding to the current view. The current view here refers to the view of a virtual camera at a position and orientation set by the public estimate of the pose 203 of the mobile device.

The virtual camera is assumed to have known intrinsic parameters. To determine the region in the scene image corresponding to the current view, a current view to scene image mapping is defined. This mapping is similar to the mapping described in step 1300 of the Photomap update flowchart FIG. 13. The difference involves replacing the current video frame by the current view, and the Photomap image by the scene image. The region in the scene image corresponding to the current view is then calculated by applying the current view to scene image mapping to the rectangle defined by the border of the current view. The platforms that fall within this region are the platforms that will be visible in the current view. Then, these platforms are selected as visible and their coordinates are transformed to the current view coordinate system by applying to them the inverse of the current view to scene image mapping. If other game objects such as walls, ramps, etc. are used in the game, they are treated in the same way as platforms are treated. The last step in the loop, 2803, involves reporting the rendered view of the downloaded scene and the calculated platform locations for the current view to the Game Engine 1901.

Embodiments of the system using VR mode can enable multi-player games. In this case, multiple users will download the same scene and play a game on the same scene simultaneously. A communications link with a server will allow the system to share real-time information about the characters position and actions within the game and make this information available to a number of VR clients that can join the game. FIG. 31 shows a block diagram of a multi-player architecture. The AR player 3100 can map a local scene and upload this scene, together with the identified platforms on that scene, to a Server 3101 that will handle the Shared Scene Data 3102 and make it available to other players. The Shared Scene Data 3102 includes static data, such as a map of a scene, platform locations in that map of the scene, and other static game objects in that map of the scene. The Shared Scene Data 3102 also includes real-time data, such as the locations and actions of game characters.

While an AR player 3100 plays an AR game on its local scene, other remote VR players 3103 can download the same Shared Scene Data 3102, and join the AR player game in VR mode. During the game, both the AR player 3100 and the VR players 3103 will synchronize their game locations and actions through the Server 3101, making it possible for all of them to play the same game together.

FIG. 26 depicts an example usage of an embodiment of the system where one user is playing a game in AR mode on a local scene, while another two remote users are playing in VR mode on the same scene as the AR user. In this situation, a user of an embodiment of the system 1801 (the AR player in this figure) will map a local scene and upload this scene, together with the selected platforms on that scene, to a Server 3101. The Server 3101 will make the Shared Scene Data 3102 available to VR clients. This allows two other users, 2606 and 2607, to download the scene data and play a game in VR mode.

The VR players can play a shared scene either simultaneously or at different times. If the scene is played simultaneously with an AR player or with other VR players, real-time information is exchanged through the Server 3101, and the AR player or VR players are able to interact with each other within the game. Assuming simultaneous playing on the same game, when the AR player 1801 aims the mobile device 100 towards a region on the scene 2601 that has been previously mapped, the system will present on the mobile device's display a view 2603 of the platforms and game objects corresponding to that region in the scene. Then, a remote VR player 2606 can join the same game by connecting to the Server 3101, downloading the same scene, and sharing real-time data. This will allow the VR player 2606 to see on his mobile device's display a region of the shared scene corresponding to the local estimate of the pose 203 of his mobile device. For example, following FIG. 26, if the VR player 2606 aims his mobile device towards a local region corresponding with the remote region 2600 on the downloaded scene, his mobile device's display will show a view 2604 of the scene including the platforms and any current game characters located within that region of the scene. If another VR player 2607 connects to the same game, and aims his mobile device towards a local region corresponding to the remote region 2602 on the shared scene, his mobile device's display will show a view 2605 of the scene including the platforms and any current game characters located within the region 2602. In this particular case, the view 2605 of the region 2602 on the shared scene, includes the game character labelled A, belonging to the AR player 1801, and the game character labelled C, belonging to the second VR player 2607.

In embodiments of the system that support multi-player games, the platforms involved in the game are typically identified and selected by the AR player that shares the scene for the game. The VR players download the scene together with the previously identified and selected platforms and play a VR game on them. However, some embodiments of the system can allow each VR client to dynamically identify and select platforms on the downloaded scene according to one or more games rules, possibly different from the game rules that the AR player used when initially sharing the scene.

### 12. Description of Methods

This section describes the methods of interaction for mobile devices and the methods for playing AR and VR games that the described embodiments of the system can make possible.

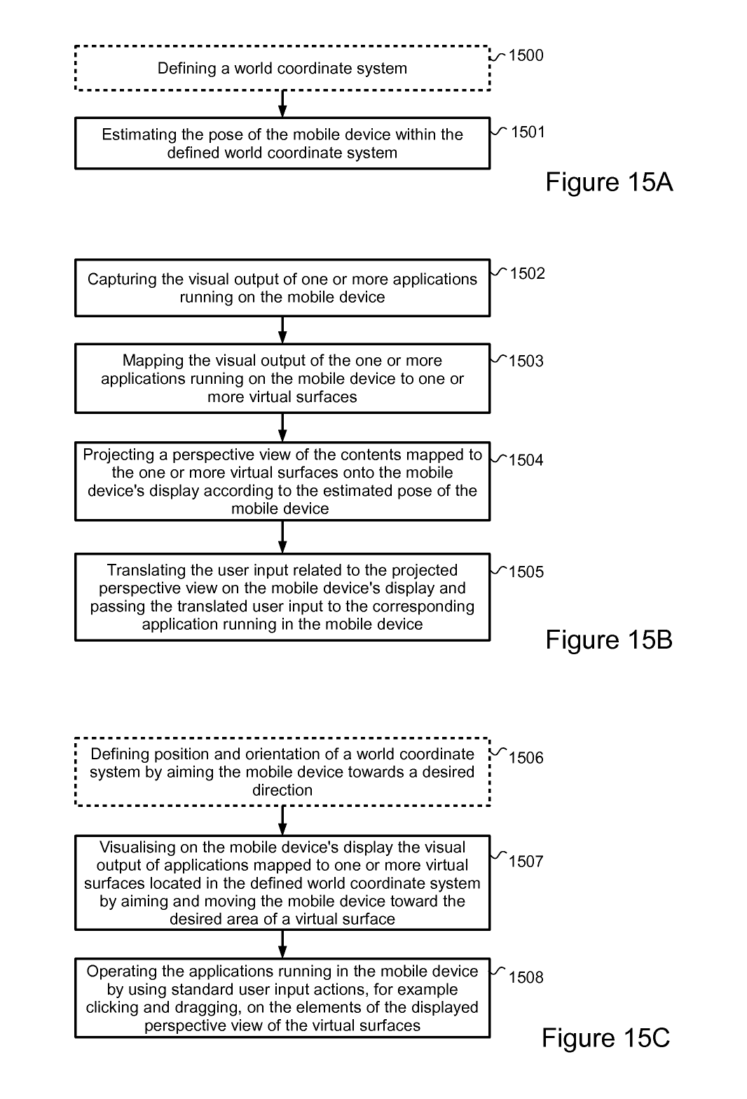

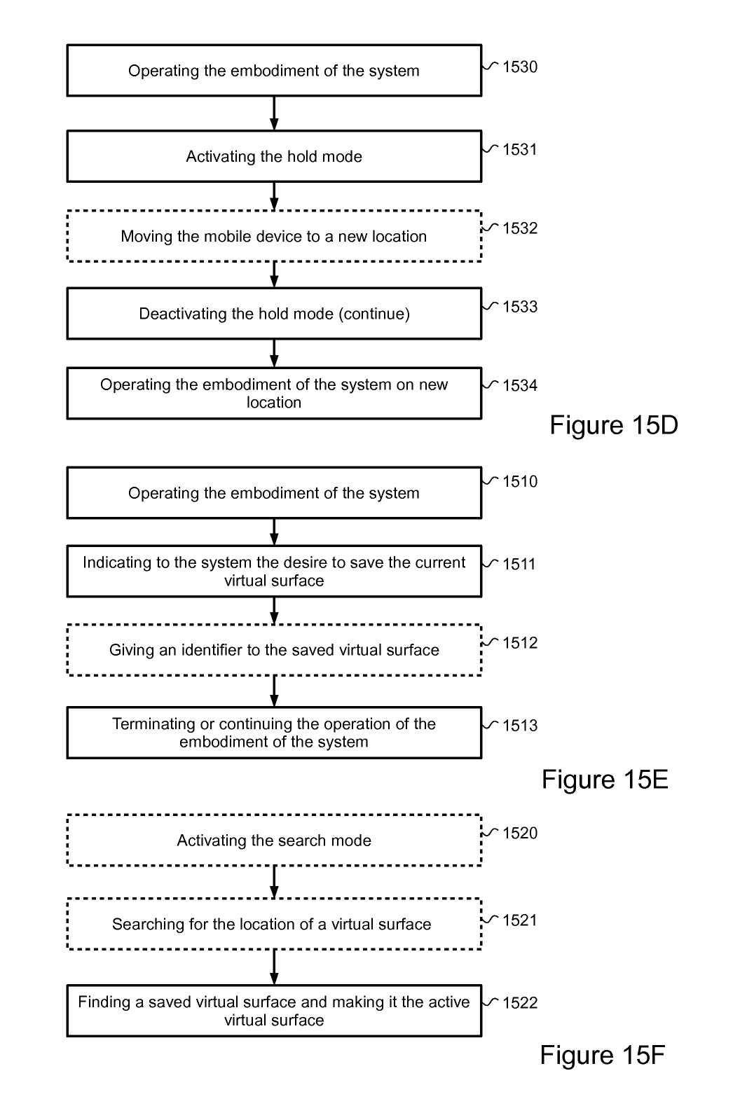

FIG. 15A shows a flowchart depicting a method for estimating the pose of a mobile device within a user defined world coordinate system. The first step 1500 in this method involves defining a world coordinate system. This step can be performed by asking the user to aim the mobile device towards a desired direction. When the user has indicated a direction, information related to this direction is used to define a world coordinate system. This step is implemented by described embodiments of the system by following the steps in FIG. 8. Step 1500 is optional as a previously defined world coordinate system can be used instead, see steps 700 and 701 in FIG. 7.

The following step 1501 involves estimating the pose of the mobile device within the defined world coordinate system. This step is implemented by described embodiments of the system by following the steps in FIG. 10. This step will typically be executed repeatedly during the interaction session until the user decides to finish the interaction session.

FIG. 15B shows a flowchart depicting a method for displaying and operating the visual output of one or more applications running on a mobile device. The first step 1502 in this method involves capturing the visual output of one or more applications running on the mobile device. This step is implemented by described embodiments of the system by following the step 1401 in FIG. 14.

The next step 1503 involves mapping the visual output captured in the previous step to one or more virtual surfaces. This step is implemented by described embodiments of the system by following the step 1402 in FIG. 14.

The next step 1504 involves projecting a perspective view of the contents mapped in the previous step to the one or more virtual surfaces, on the mobile device's display according to the estimated pose of the mobile device. This step is implemented by the described embodiments of the system by following the step 1403 in FIG. 14.

Finally, step 1505 involves translating the user input related to the projected perspective view on the mobile device's display and passing the translated user input to the corresponding application running on the mobile device. This step is implemented by the described embodiments of the system by following the step 1405 in FIG. 14.

Steps in FIG. 15B will typically be executed repeatedly in the given order during the interaction session until the user decides to finish the interaction session.

The methods described in FIG. 15A and FIG. 15B will typically be executed concurrently, but alternating their executions sequentially is also possible.

FIG. 15C shows a flowchart depicting a method for a user visualising and operating one or more applications running in a mobile device. The first step 1506 in this method involves the user defining the position and orientation of a world coordinate system by aiming the mobile device toward a desired direction and indicating to the interaction system to use that direction. Step 1506 is optional as the world coordinate system could have been defined previously, or may not need to be defined, see steps 700 and 701 in FIG. 7.

The next step 1507 involves the user visualising on the mobile device's display the visual output of applications mapped to one or more virtual surfaces located in the defined world coordinate system by aiming and moving the mobile device towards the desired area of a virtual surface.

Finally, step 1508 involves the user operating the applications running on the mobile device by using standard user input actions, for example clicking and dragging, on the elements of the displayed perspective view of the virtual surfaces.

The user of an embodiment of the interaction system will typically perform step 1506 first, unless a world coordinate system has been defined previously, and the user wants to use it again. Then the user will be visualising, step 1507, and operating, step 1508, the applications running on the mobile device through the interaction system for the length of the interaction session, which will last until the user wants to finish it. Occasionally, the user may want to redefine the world coordinate system, for example to continue working in a different location, in this case the user will repeat step 1506, and then continue the interaction session from the point it was interrupted.

Some embodiments of the interaction system can be placed in a hold and continue mode that makes it easier for the user of the system to redefine the location of the virtual surface being used. FIG. 15D shows a flowchart depicting a method for redefining the location of a virtual surface by using the hold and continue mode. At the beginning, step 1530, involves the user operating the embodiment of the system at a particular location. At some point, the user activates the hold mode, step 1531. This can be achieved, for example, by pressing a certain key on the mobile device's keypad, or pressing a certain area of the screen on a mobile device with touchscreen. Once the hold mode is activated, the user of the interaction system is free to move the mobile device to a new location, step 1532, while the presentation of the virtual surface is frozen. When the user wants to continue operating the interaction system in a new location, he can deactivate the hold mode (continue), step 1533, for example, by releasing a certain key on the mobile device's keypad, or releasing a certain area of the screen on a mobile device with touchscreen. At this point the virtual surface will be unfrozen and the user can continue operating the embodiment of the interaction system from the new location, step 1534. An example implementation of the hold and continue mode is described in the rendering engine section. This hold and continue mode can enable easy successive holds and continues, which can be used by a user of an embodiment of the system to perform a piece-wise “zoom in”, “zoom out”, translation or rotation of the virtual surface. For example, FIG. 4E illustrates the steps involved in a piece-wise “zoom in” when using the hold and continue mode.

Some embodiments of the system can allow the user to save the location, orientation and contents of the virtual surface, for retrieval at a later time. FIG. 15E shows a flowchart depicting a method for saving the location, orientation and contents of the virtual surface. Initially, the user of the embodiment of the system is operating the embodiment, step 1510. At some point, step 1511, the user indicates to the system the desire to save the current virtual surface. The embodiment of the system may ask the user for an identifier under which to save the virtual surface, step 1512. Alternatively, the identifier can be generated by the embodiment of the system. The embodiment of the system will then save the location, orientation, and contents of the virtual surface. This is implemented by described embodiments of the system by following the steps in FIG. 13D. Finally, the user will terminate or continue the operation of the embodiment of the system, step 1513.

Embodiments of the system that can allow the user to save the location, orientation and contents of the virtual surface, will generally be able to be placed in a search mode. During search mode the embodiment of the system will be continuously checking whether the current video frame corresponds to a part of a previously saved virtual surface. Once a video frame is identified as corresponding to a part of a saved virtual surface, a new world coordinate system 202 is defined, and the user of the embodiment can start operating the saved virtual surface. FIG. 15F shows a flowchart depicting a method for using the search mode. First, step 1520, the user activates the search, for example by using a GUI. While the search mode is operating, step 1521, the user can aim the mobile device in a direction he thinks there is a saved virtual surface. The embodiment of the system will then find the saved virtual surface and will make it the active virtual surface, step 1522. Some embodiments of the system may have a search mode always on, that allows users of the interaction system operate a virtual surface and activate a nearby saved virtual surface by just aiming the mobile device towards it. In these embodiments of the system steps 1520 and 1521 are not necessary. The search mode is implemented by described embodiments of the system by following the steps in FIG. 13E and FIG. 13F.

FIG. 15G shows a flowchart depicting a method for two users operating a shared container region. To begin with, the first user of an embodiment of the system initiates a shared container region, step 1530. At a similar time, the second user of an embodiment of the system initiates the same shared container region as the first user, step 1533. At some point in time, the first user will update the shared container region, step 1531, for example by adding a new content item. In response to this update, the embodiment of the system operated by the first user will automatically save the content items in the container region store, step 1532. The embodiment of the system operated by the second user will detect that the shared container region has changed in the container region store and will refresh the shared container region with the new content item, step 1534. Finally, the second user will see the refreshed container region, including the new content item added by the first user.

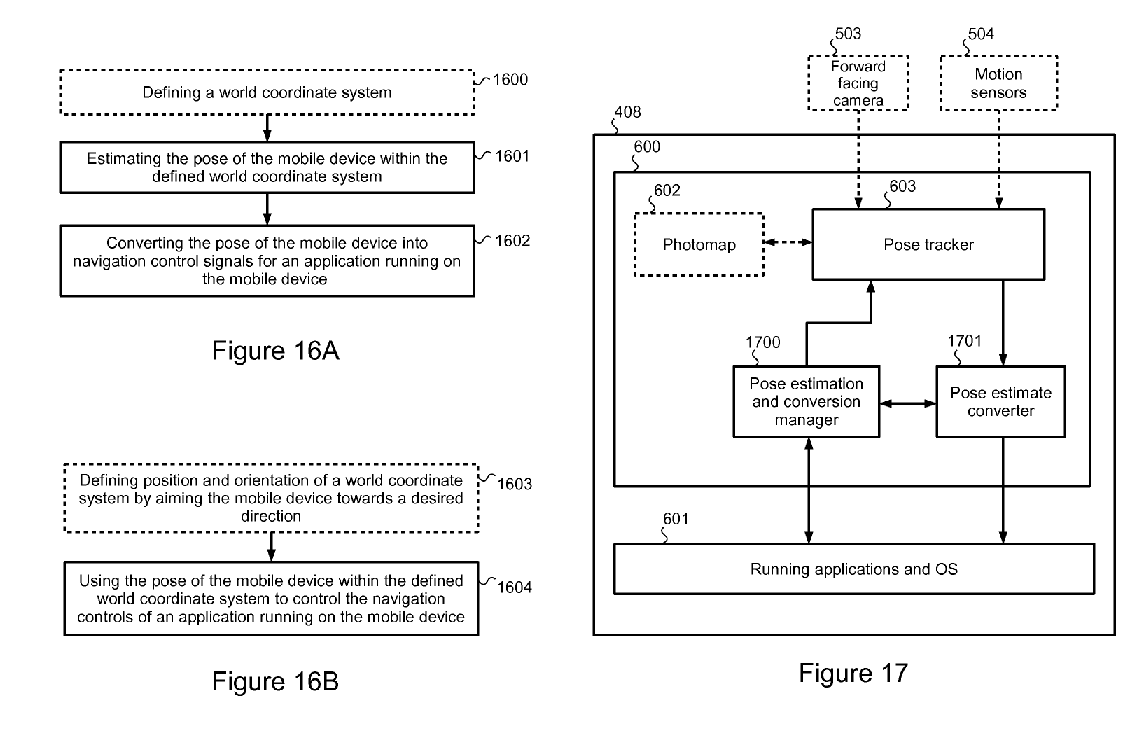

FIG. 16A shows a flowchart depicting a method for estimating the pose 203 of a mobile device within a user defined world coordinate system 202 and translating this pose into navigation control signals for an application running on a mobile device. This flowchart refers to the method followed by the family of less preferred embodiments of the system described in section 7 and implemented by the block diagram of FIG. 17. In FIG. 16A, the first and second steps, step 1600 and 1601, are equivalent to steps 1500 and 1501 in FIG. 15A, and these correspond to defining a world coordinate system 202, and estimating the pose 203 of the mobile device within the defined world coordinate system. Step 1602 involves converting the pose 203 of the mobile device into navigation control signals that can be directly used by an application running on the mobile device. Embodiments of the system can implement this step with blocks 1700 and 1701 in FIG. 17.

FIG. 16B shows a flowchart depicting a method for a user using the pose 203 of the mobile device within a user defined world coordinate system 202 to control the navigation controls of an application running on the mobile device. This flowchart refers to the method that users will follow to operate an instance of the family of less preferred embodiments of the system described in section 7. The first step 1603 is equivalent to step 1506 in FIG. 15C, and involves the user defining the position and orientation of a world coordinate system by aiming the mobile device toward a desired direction and indicating to the interaction system to use that direction. Step 1603 is optional as the world coordinate system could have been defined previously, or may not need to be defined, see steps 700 and 701 in FIG. 7. The next step 1604, involves the user using the pose of the mobile device to control the navigation controls of an application running on the mobile device. This step is made possible by estimating the pose 203 of the mobile device within the defined world coordinate system 202 and converting this pose into the appropriate navigation control signals for an application running on the mobile device.

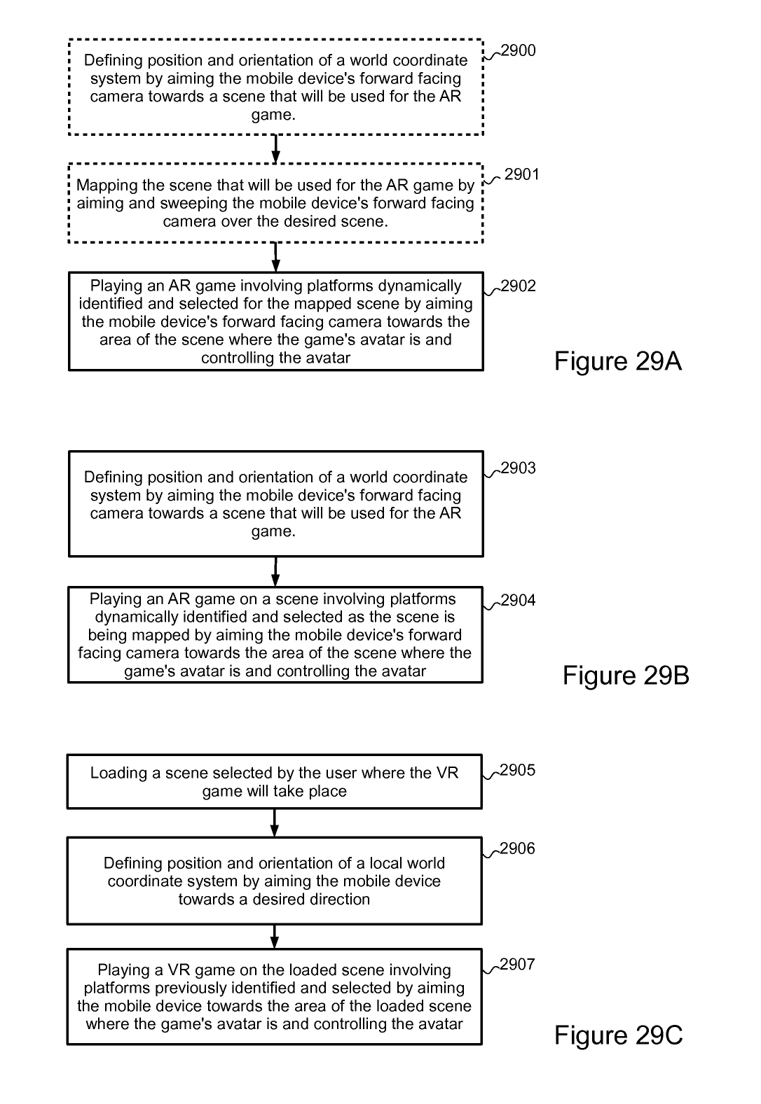

FIG. 29A shows a flowchart depicting a method for a user using an embodiment of the system to play an AR game. The first step 2900 in this method involves defining the position and orientation of a world coordinate system 202. This step can be performed by asking the user to aim the mobile device's forward facing camera 503 towards the scene to be used as playground for the AR game. When the user has indicated a direction, information related to this direction is used to define a world coordinate system 202. This step is implemented by described embodiments of the system following the steps in FIG. 8. Step 2900 is optional as a previously defined world coordinate system 202 can be used instead, see steps 2100 and 2101 in FIG. 21.

The following step 2901 involves mapping the scene that will be used for the AR game by aiming and sweeping the mobile device's forward facing camera over the desired scene. Typically, the sweeping motions used to map the scene will involve a combination of translations and rotations as described by FIG. 20A, FIG. 20B, FIG. 20C and FIG. 20D. This step is implemented by described embodiments of the system continuously estimating the pose 203 of the mobile device within the world coordinate system 202, as described in FIG. 10, and updating the Photomap data structure 602, as described in FIG. 13. Step 2901 is optional as a previously defined world coordinate system 202 and Photomap data structure 602, can be used instead, see steps 2100 and 2101 in FIG. 21.

The final step in this method, step 2902, involves playing an AR game using the mapped scene. Once the user has completed the mapping of the scene, platforms for the AR game are identified and selected. The identification and selection of platforms for the mapped scene is implemented by described embodiments of the system following the steps in FIG. 23. The AR game is played by aiming the mobile device's forward facing camera towards the area of the scene where the game's avatar is and controlling the avatar. The estimation of the pose 203 of the mobile device is implemented by embodiments of the system as described in the Game Pose Tracker block 1903. The combined operation of the Game Engine 1901, Game Logic 1905, and AR system 1900 enable the AR game playing.

FIG. 29B shows a flowchart depicting a method for a user using an embodiment of the system to play an AR game in continuous mode. The first step in this method 2903 involves defining the position and orientation of a world coordinate system 202. This step is the same as step 2900 in FIG. 29A. The second step in this method 2904 involves playing an AR game without having to map the scene first. The scene is mapped and platforms are dynamically identified and selected as the user plays the AR game. After the user has defined a world coordinate system by aiming the mobile device's forward facing camera 503 towards the scene to be used as playground for the AR game, platforms for the current view of the scene are identified and selected. Then, the game's avatar appears standing on one of the selected platforms. As the user moves the game's avatar within the current view of the scene, and the avatar gets nearer to the borders of the current view, the user aims the mobile device in the direction the avatar is heading, to centre the avatar in the current view. This action results in mapping a new region of the scene and identifying and selecting new platforms for that new region. Theoretically, the scene can be extended indefinitely by following this procedure. The estimation of the pose 203 of the mobile device and continuous mapping of the scene is implemented by embodiments of the system as described in the Game Pose Tracker block 1903. The continuous mode identification and selection of platforms on the current view of the scene is implemented by described embodiments of the system following steps in FIG. 24. The combined operation of the Game Engine 1901, Game Logic 1905, and AR system 1900 make the AR game playing possible.

FIG. 29C shows a flowchart depicting a method for a user using an embodiment of the system to play a VR game. The first step 2905 involves loading a scene selected by the user, together with previously identified and selected platforms and any other relevant game objects, from a computer readable media. The next step in this method 2906 involves defining the position and orientation of a world coordinate system 202. This step is the same as step 2900 in FIG. 29A. The last step in this method 2907 involves playing a VR game on the loaded scene including platforms that have previously been identified and selected. Embodiments of the system enable the user to visualise the area of the loaded scene where the game's avatar is, by aiming the mobile device towards that area. The user can then control the avatar to play the VR game. In this step, embodiments of the system will estimate the pose 203 of the mobile device within a local world coordinate system 202, but will display instead a view of the loaded scene corresponding to the local estimate of the pose 203 of the mobile device. The estimation of the pose 203 of the mobile device is implemented by embodiments of the system as described in the Game Pose Tracker block 1903. The visualization of the loaded scene is implemented by described embodiments of the system following steps in FIG. 28. The combined operation of the Game Engine 1901, Game Logic 1905, and VR system 2702 make the VR game playing possible.

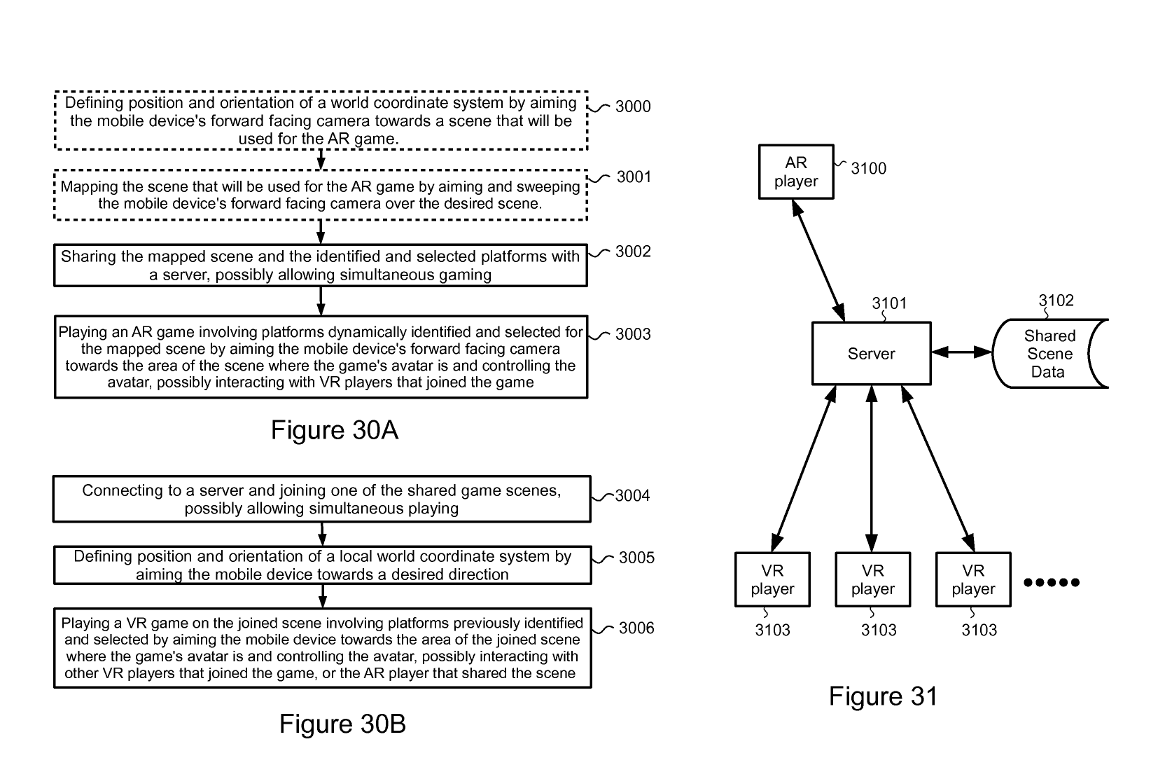

FIG. 30A shows a flowchart depicting a method for a user using an embodiment of the system to map a local scene, share the scene in a server, and play an AR game, possibly interacting with VR players that joined the game. The first two steps 3000 and 3001 in the method are the same as the first two steps 2900 and 2901 for AR playing. The next step 3002 involves sharing the mapped scene and platforms, which form part of the static data in the Shared Scene Data 3102, with a Server 3101. The user can allow simultaneous playing. If simultaneous playing is allowed, VR users can join the shared scene at the same time the AR user plays the game on that scene. During simultaneous playing embodiments of the system share real-time data about the game through the Server 3101. The last step of the method 3003 involves playing the AR game, in the same manner described in step 2902 of FIG. 29A. However, now, if the AR user allowed simultaneous playing, other VR players can join the game, and interact with the AR player's avatar.

FIG. 30B shows a flowchart depicting a method for a user using an embodiment of the system to connect to a server, join a game, and play a VR game, possibly interacting with other VR players that joined that game, or the AR player that shared the game. The first step in the method 3004, involves the user of an embodiment of the system connecting to a Server 3101, and joining one of the shared game scenes. The game scenes may allow simultaneous playing. In this case the user can choose to join the shared game scene and play simultaneously with other VR users. The following step in the method 3005 involves defining the position and orientation of a local world coordinate system 202. This step is equivalent to step 2906 in FIG. 29C. The last step in the method 3006 involves playing a VR game in the joined scene. This step is essentially the same as step 2907 in FIG. 29C but if simultaneous playing was allowed, other VR players, or the AR player that shared the scene, can appear in the scene and interact with the VR player's avatar.

### 13. Conclusion

The described embodiments of the invention can enable the users of mobile devices, agreeing with the described exemplary architectures, to use applications running on the mobile device by mapping the application's visual output to a larger virtual surface floating in a user defined world coordinate system. Embodiments of the invention estimate the pose of the mobile device within the defined world coordinate system and render a perspective view of the visual output mapped on the virtual surface onto the mobile device's display according to the estimated pose. This way of presenting the visual output of the applications running on the mobile device can be especially advantageous when these applications involve dense and large displays of information. The navigation and visualisation of these larger virtual surfaces can be performed by aiming and moving the mobile device towards the desired area of the virtual surface. This type of navigation can be performed quickly and intuitively with a single hand, and avoids or reduces the need for touchscreen one finger navigation gestures, and related accidental clicks. This type of navigation especially avoids two finger navigation gestures, corresponding to zoom in and zoom out, that typically require the use of two hands: one hand to hold the mobile device and another hand to perform the gesture, typically using the thumb and index fingers. The user can operate the applications running on the mobile device by using standard user input actions, for example clicking or dragging, on the contents of the rendered perspective view of the virtual surface, as shown on the mobile device's display.

Embodiments of the described invention can be used to palliate the problem scenario described at the beginning of section 1. As shown in FIG. 1, the user of the mobile device 100 with a display 101 showing a webpage that is very crowded with contents and difficult to read, can now activate an embodiment of the invention and browse and interact with the same webpage contents, now mapped on a large virtual surface. The user will still need to navigate the contents, but this can be achieved by holding, aiming and moving the mobile device towards the desired area of the virtual surface. The user can perform this navigation with a single hand and in a continuous manner, for example, while tracking the text that he is reading. The user can also interact with the contents of the webpage while navigating them. For example, if the mobile device has a touchscreen, the user can tap his thumb on a link on the webpage, as shown by the current perspective view of the virtual surface, while the user is tracking and reading the text on the webpage (by tracking meaning to slowly move the mobile device following the text that is being read).

Some applications running on mobile devices can benefit from the described interaction system more than others. Web browsers, remote desktop access, and mapping applications, are examples of applications that can naturally benefit from a larger display area and the described system and method of interaction. Applications that have been designed for larger displays and are required to be used on a mobile device with smaller display size can also directly benefit from the described interaction system. Applications that are designed for a small display sizes will not benefit so much from the described interaction system. However, new applications can be designed with the possibility in mind of being used on a large virtual surface. These applications can show two visual outputs: one when they are used with a small logical display, such as the mobile device's display, and another visual output for when they are used in a large logical display, such as a virtual surface. This can enable mobile device users to perform tasks that would normally only be performed on a desktop computer due to these tasks requiring larger display sizes than those which are normally available on mobile devices.

Advantageously, alternative embodiments of the system enable the users of mobile devices, to create a map of an arbitrary scene and use this map as a playground for an AR platform game. These embodiments of the system can dynamically identify potential platforms in an arbitrary scene and select them according to one or more game rules. In other alternative embodiments of the system, the mapped scene, together with selected platforms, can be stored and shared online for other users to play, on that scene, in a Virtual Reality (VR) mode. These embodiments can allow multiple remote players to simultaneously play on the same scene in VR mode, enabling cooperative or adversarial game dynamics.

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A system enabling a user to interact with one or more applications running in a mobile device, the system comprising:
A means of estimating the pose of the mobile device, the pose being defined on a coordinate system, the origin and orientation of the coordinate system being attached to a part of a scene;
A means of mapping the visual output of one or more applications running in the mobile device onto one or more virtual surfaces located within the coordinate system;
A means of rendering on a display associated with the mobile device a view of the visual output mapped onto one or more virtual surfaces according to the relative poses of the mobile device and the one or more virtual surfaces;
A means of accepting a user input related with the view rendered on the display associated with the mobile device and translating this input into a corresponding input to one or more applications running on the mobile device, thereby enabling the user of the system to interact with one or more applications running on the mobile device.

2. A system according to claim 1, wherein the estimation of the pose of the mobile device is achieved by tracking and mapping of the scene, thereby enabling to extend the usable part of the coordinate system beyond the part of the scene to which it was originally attached to.

3. A system according to claim 2, further comprising a means of reattaching the origin and orientation of the coordinate system to a different part of the scene.

4. A system according to claim 2, further comprising a means of recording the attachment between the coordinate system and the scene such that it may be recovered at a later time.

5. A system according to claim 1, wherein the system of interaction with one or more applications running on the mobile device can be interrupted and reinstated without interfering with the normal operation of the applications running on the mobile device.

6. A system according to claim 3, wherein the applications running on the mobile device include a web browser.

7. A system according to claim 2, wherein the applications running on the mobile device include an application whose visual output includes a container region that can be populated programatically.

8. A system according to claim 7, further comprising a means of recording the contents of a container region defined on one of the virtual surfaces such that they can be recovered at a later time.

9. A system according to claim 2, wherein contents within a bounded region can be exported to an area outside the bounded region and within the virtual surface.

10. A system according to claim 9, wherein the contents exported to the area outside the bounded region are updated when the content within the bounded region is updated.

11. A system according to claim 2, wherein the coordinate system can be shared with other mobile devices, thereby enabling estimating the pose of each mobile device within the same coordinate system.

12. A system according to claim 11, wherein the other mobile devices include HMDs.

13. A system according to claim 2, wherein the coordinate system can be shared with other mobile devices, thereby enabling estimating the pose of each mobile device within the same coordinate system.

14. A system according to claim 13, wherein the other mobile devices include HMDs.

15. A system enabling a mobile device to create video games based on scenes, the system comprising:
A means of estimating the pose of the mobile device, the pose being defined on a coordinate system, the origin and orientation of the coordinate system being attached to a part of a scene;
A means of creating a map of the scene;
A means of identifying features on the map of the scene and interpreting these features as game objects;
A means of rendering on a display associated with the mobile device a view of the scene overlaying the game objects and according to the estimated pose of the mobile device.

16. A system according claim 15, wherein the identified features are interpreted as platforms.

17. A system according to claim 16, wherein the features are identified after the map of the scene has been created and according to one or more game rules.

18. A system according to claim 16, wherein the features are identified while the map of the scene is being created and according to one or more game rules and a consistency constraint with previously identified features.

19. A system according to claim 15, wherein the created map of the scene and the identified features on that map can be recorded such that they may be recovered at a later time making unnecessary to create a map of the scene and identify features on that map of the scene.

20. A system according to claim 15, wherein the map of the scene and the identified features are unrelated to the scene where the pose of the mobile device is being estimated.
